(19) United States
(12) Patent Application Publication
(10) Pub. No.: US 2004/0111677 A1
(43) Pub. Date: Jun. 10, 2004

(54) Efficient means for creating MPEG-4 intermedia format from MPEG-4 textual representation

(75) Inventors: William L. Luken, Yorktown Heights, NY (US); Etienne Roy, Esbly (FR)

Correspondence Address: THE LAW OFFICE OF IDO TUCHMAN, 69-60 108ST., SUITE 503, FOREST HILLS, NY, 11375, US

(73) Assignee: International Business Machines Corporation

(21) Appl. No.: 10/309,537

(22) Filed: Dec. 4, 2002

(51) Int. Cl. G06F 17/24; G06F 17/21; G06F 17/00

(52) U.S. Cl. 715/523

(57) ABSTRACT

A method, system, and computer program product for converting an Extensible MPEG-4 Textual (XMT) document into a binary MPEG-4 (mp4) file. The XMT document may comprise of zero or more associated media data files. The invention includes generating an intermediate document representing the mp4 file and creating the mp4 file based on the intermediate document and the associated media data files. A first converter is configured to input the XMT document and to generate at least one intermediate document representing the structure of the mp4 file. A second converter is configured to input the intermediate document and any associated media files and to generate the mp4 file.

### FIELD OF THE INVENTION

The present invention relates generally to data representation of multimedia information, and more specifically to the transformation of one form of multimedia information representation known as “MPEG-4 Textual Representation” to another form of multimedia information representation known as “MPEG-4 Intermedia Format”.

### BACKGROUND

Computers are commonly used to present a variety of digital media, including images, audio samples (sounds), and video media, as well as text and geometric shapes. Each of these media types can be presented individually, or a number of such media elements can be presented together in what is known as a composite multimedia presentation.

The ability to create and distribute composite multimedia presentations is very important for the dissemination of information based on various media types. In addition, standardized means of representing composite multimedia presentations have been created to enable many authors to create presentations which can be reproduced on a variety of computer platforms, such as personal computers, set-top boxes, and other devices.

Two well-known standardized formats of composite multimedia presentation developed by the Motion Pictures Experts Group (MPEG) are an Extensible MPEG-4 Textual (XMT) format and a binary coded MPEG-4 (mp4) format. The XMT format is well suited for authoring composite multimedia presentations, while the mp4 format is well suited for compact storage and transmission of composite multimedia presentations. Thus, it is desirable to efficiently convert XMT-formatted presentation to an mp4-formatted presentation.

### SUMMARY OF THE INVENTION

As detailed below, the present invention is a method, system, and apparatus for converting an Extensible MPEG-4 Textual (XMT) format into a binary coded MPEG-4 (mp4) format. The invention utilizes an efficient facility consisting of a relatively small amount of software and which requires only modest resources to achieve composite multimedia presentation conversion from XMT format to mp4 format.

Thus, an aspect of the present invention involves a method for converting an Extensible MPEG-4 Textual (XMT) document into a binary MPEG-4 (mp4) file. The XMT document may comprise of zero or more associated media data files. The method includes generating an intermediate document representing the mp4 file and creating the mp4 file based on the intermediate document and the associated media data files.

Another aspect of the invention is a system for converting an Extensible MPEG-4 Textual (XMT) document with zero or more associated media files into a binary MPEG-4 (mp4) file. The system includes a first converter configured to input the XMT document and to generate at least one intermediate document representing the structure of the mp4 file. A second converter is configured to input the intermediate document and any associated media files and to generate the mp4 file.

Yet another aspect of the invention is a computer program product embodied in a tangible media for converting an Extensible MPEG-4 Textual (XMT) document with zero or more associated media files into a binary MPEG-4 (mp4) file. The computer program performs the operations of generating an intermediate document representing the mp4 file and creating the mp4 file based on the intermediate document and the associated media data files.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1A shows an exemplary XMT-A document utilized by one embodiment of the invention.

FIG. 1B shows an exemplary XMT-A Initial Object Descriptor.

FIG. 2A shows an exemplary XMT-A par element.

FIG. 2B shows exemplary XMT-A odsm command elements.

FIG. 3A shows exemplary XMT-A Insert commands.

FIG. 3B shows an exemplary XMT-A Delete command.

FIG. 3C shows exemplary XMT-A Replace commands.

FIG. 4 shows an exemplary XMT-A BIFS Node element.

FIG. 5A shows an exemplary XMT-A BIFS Node.

FIG. 5B shows an exemplary reused XMT-A BIFS Node.

FIG. 6A shows an exemplary XMT-A ObjectDescriptor.

FIG. 6B shows an exemplary XMT-A ES_Descriptor.

FIG. 6C shows an exemplary DecoderSpecificInfo for sdsm (BIFS).

FIG. 7A shows an exemplary mp4 binary file generated by one embodiment of the invention.

FIG. 7B shows an exemplary mdat atom.

FIG. 7C shows an exemplary chunk.

FIG. 7D shows an exemplary moov atom.

FIG. 8A shows an exemplary mp4 file iods atom.

FIG. 8B shows an exemplary Mp4fInitObjectDescr.

FIG. 8C shows an exemplary ES_ID_Inc.

FIG. 9A shows an exemplary trak atom.

FIG. 9B shows an exemplary sample tables atom.

FIG. 10A shows an exemplary binary ES descriptor.

FIG. 10B shows an exemplary decoder config descriptor.

FIG. 10C shows an exemplary decoder specific info descriptor.

FIG. 10D shows an exemplary binary SL config descriptor.

FIG. 11A shows an exemplary sdsm binary chunk.

FIG. 11B shows an exemplary sdsm command frame.

FIG. 12A shows an exemplary BIFS insertion command.

FIG. 12B shows an exemplary BIFS deletion command.

FIG. 12C shows an exemplary BIFS replacement command.

FIG. 12D shows an exemplary BIFS scene replacement command.

FIG. 13A shows an exemplary Node insertion command.

FIG. 13B shows an exemplary IndexedValue insertion command.

FIG. 13C shows an exemplary Route insertion command.

FIG. 14A shows an exemplary Node deletion command.

FIG. 14B shows an exemplary IndexedValue deletion command.

FIG. 14C shows an exemplary Route deletion command.

FIG. 15A shows an exemplary Node replacement command.

FIG. 15B shows an exemplary Field replacement command.

FIG. 15C shows an exemplary IndexedValue replacement command.

FIG. 15D shows an exemplary Route replacement command.

FIG. 16 shows an exemplary BIFS Scene.

FIG. 17A shows an exemplary SFNode (reused).

FIG. 17B shows an exemplary SFNode (mask Node).

FIG. 17C shows an exemplary SFNode (list Node).

FIG. 17D shows an exemplary MFField (list form).

FIG. 17E shows an exemplary MFField (vector form).

FIG. 18A shows exemplary Routes (list form).

FIG. 18B shows exemplary Routes (vector form).

FIG. 18C shows an exemplary Route.

FIG. 19A shows an exemplary odsm binary chunk.

FIG. 19B shows an exemplary odsm binary sample.

FIG. 20A shows an exemplary ObjectDescriptorUpdate command.

FIG. 20B shows an exemplary ObjectDescriptorRemove command.

FIG. 21A shows an exemplary binary object descriptor.

FIG. 21B shows an exemplary binary EsIdRef descriptor.

FIG. 22 shows an exemplary XMT-A to MPEG-4 intermedia file converter contemplated by the present invention.

FIG. 23A shows an exemplary mp4file document.

FIG. 23B shows an exemplary mp4fiods element.

FIG. 24A shows an exemplary mdat element.

FIG. 24B shows an exemplary sdsm element.

FIG. 24C shows an exemplary odsm element.

FIG. 24D shows an exemplary mediaFile element.

FIG. 25A shows an exemplary odsmChunk element.

FIG. 25B shows an exemplary odsmSample element.

FIG. 25C shows exemplary odsm-command elements.

FIG. 26A shows an exemplary trak element.

FIG. 26B shows an exemplary stbl element.

FIG. 27 shows an exemplary ES_Descr.

FIG. 28A shows an exemplary mp4bifs document.

FIG. 28B shows an exemplary mp4bifs commandFrame element.

FIG. 29A shows an exemplary mp4bifs bifsCommand element.

FIG. 29B shows an exemplary mp4bifs ReplaceScene element.

FIG. 30A shows an exemplary mp4bifs original Node element.

FIG. 30B shows an exemplary mp4bifs Conditional Node element.

FIG. 30C shows an exemplary mp4bifs Reused Node element.

FIG. 31A shows an exemplary process XMT-A document flowchart.

FIG. 31B shows an exemplary process XMT-A Header flowchart.

FIG. 32 shows an exemplary process XMT-A Descr element flowchart.

FIG. 33 shows an exemplary process XMT-A esDescr element flowchart.

FIG. 34 shows an exemplary process XMT-A ES_Descr flowchart.

FIG. 35 shows an exemplary create mdat element flowchart.

FIG. 36A shows an exemplary create trak element flowchart.

FIG. 36B shows an exemplary create stbl element flowchart.

FIG. 37 shows an exemplary create esds element flowchart.

FIG. 38 shows an exemplary process BIFS configuration flowchart.

FIG. 39A shows an exemplary object table.

FIG. 39B shows an exemplary BIFS NodeID table.

FIG. 39C shows an exemplary BIFS RouteID table.

FIG. 39D shows an exemplary ReplaceScene time table.

FIG. 39E shows an exemplary Sorted object table.

FIG. 40 shows an exemplary process XMT-A Body Element (Pass 1 or Pass 2) flowchart.

FIG. 41 shows an exemplary process XMT-A par element (Pass 1) flowchart.

FIG. 42 shows an exemplary process XMT-A command element (Pass 1) flowchart.

FIG. 43 shows an exemplary process XMT-A par element (Pass 2) flowchart.

FIG. 44 shows an exemplary process Insert command flowchart.

FIG. 45 shows an exemplary process Delete command flowchart.

FIG. 46 shows an exemplary process Replace command flowchart.

FIG. 47 shows an exemplary create ReplaceScene command flowchart.

FIG. 48 shows an exemplary process XMTA BIFS node flowchart.

FIG. 49 shows an exemplary process XML representation of the odsm flowchart.

FIG. 50 shows an exemplary mp4 atom structure creation flowchart.

FIG. 51 shows an exemplary mp4 Object structure creation flowchart.

FIG. 52 shows an exemplary process mdat elements flowchart.

FIG. 53 shows an exemplary process mediaFile elements flowchart.

FIG. 54 shows an exemplary construct sync sample table flowchart.

### TABLE OF HEADINGS

MPEG-4 Textual Representation . . . 1.0

MPEG-4 Intermedia Format Files . . . 2.0

Scene Description Stream (sdsm) . . . 3.0

Object Descriptor Stream (odsm) . . . 4.0

mp4-file Document . . . 5.0

mp4-bifs Document . . . 6.0

xmta to mp4 Converter . . . 7.0

Creation of Intermediate Documents Based on XMT-A Document . . . 7.1

Create XMT-A, mp4file, and mp4bifs Documents . . . 7.1.1

Create New “bifsConfig” Element for mp4bifs Document 7.1.2

Create New “moov” Element for mp4file Document . . . 7.1.3

Process XMT-A “Header” Element . . . 7.1.4

Process XMT-A Body Element (Pass 1) . . . 7.1.5

Process XMT-A par Element (Pass 1) . . . 7.1.5.1

Process XMT-A Command Element (Pass 1) . . . 7.1.5.2

“Process ODUpdate command-1” Procedure . . . 7.1.5.3

“Process ODRemove cmnd” Procedure . . . 7.1.5.4

Create Edit List for odsm . . . 7.1.6

Process XMT-A Body Element (Pass 2) . . . 7.1.7

Process XMT-A par Element (Pass 2) . . . 7.1.7.1

Process ODUpdate command-2 . . . 7.1.7.2

Process Insert Command . . . 7.1.7.3

“Create InsertRoute command” Procedure . . . 7.1.7.4

“Create InsertNode command” Procedure . . . 7.1.7.5

Process Delete Command . . . 7.1.7.6

Process Replace Command . . . 7.1.7.7

“Create ReplaceRoute command” Procedure . . . 7.1.7.8

“Create ReplaceScene command” Procedure . . . 7.1.7.9

“Process XMTA BIFS Node” Procedure . . . 7.1.7.10

Data format Conversions . . . 7.1.7.11

Insert Command Frames into mp4bifs Document . . . 7.1.8

Insert OD commands into mdat Element for odsm . . . 7.1.9

Update bifsConfig for mp4-bifs and mp4-file Documents 7.1.10

Process ES_Descriptor . . . 7.1.10.1

Create trak Element . . . 7.1.10.2

Creation of Preliminary Sample Table Elements . . . 7.1.10.3

Process BIFS Configuration . . . 7.1.10.4

Creation of mp4 Binary File Based on Intermediate XML Documents . . . 7.2

Establish Input Documents and Output Destination . . . 7.2.1

Process for Creation of mp4 Atom . . . 7.2.1.1

Process for Creation of mp4 Object Structure . . . 7.2.1.2

Create Working Arrays . . . 7.2.2

Process “mdat” Elements . . . 7.2.3

Insert Media File Data . . . 7.2.3.1

Insert Media Data Chunk . . . 7.2.3.2

Insert odsm Data . . . 7.2.3.3

ObjectDescrUpdate Elements . . . 7.2.3.4

ObjectDescrRemove Elements . . . 7.2.3.5

Insert sdsm Data . . . 7.2.3.6

Node Insertion BIFS Command . . . 7.2.3.7

Indexed Value Insertion BIFS Command . . . 7.2.3.8

Route Insertion BIFS Command . . . 7.2.3.9

Node Deletion Command . . . 7.2.3.10

Indexed Value Deletion BIFS Command . . . 7.2.3.11

Route Deletion BIFS Command . . . 7.2.3.12

Node Replacement BIFS Command . . . 7.2.3.13

Field Replacement BIFS Command . . . 7.2.3.14

Indexed Value Replacement BIFS Command . . . 7.2.3.15

Route Replacement BIFS Command . . . 7.2.3.16

Scene Replacement BIFS Command . . . 7.2.3.17

Route Structure . . . 7.2.3.18

SFNode Structure . . . 7.2.3.19

SFField Structure . . . 7.2.3.20

Process “moov” Element . . . 7.2.4

Process mp4fiods Element . . . 7.2.4.1

Process Each trak Element . . . 7.2.4.2

Process mdia Element . . . 7.2.4.3

Process hdlr Element . . . 7.2.4.4

Process minf Element . . . 7.2.4.5

Process stbl Element . . . 7.2.4.6

Process stsc Element . . . 7.2.4.7

Process stts Element . . . 7.2.4.8

Process stco Element . . . 7.2.4.9

Process stsz Element . . . 7.2.4.10

Indexed Value Deletion BIFS Command . . . 7.2.3.11

Route Deletion BIFS Command . . . 7.2.3.12

Process ES_Descr Element . . . 7.2.4.13

Field Replacement BIFS Command . . . 7.2.3.14

Indexed Value Replacement BIFS Command . . . 7.2.3.15

Process VisualConfig Element . . . 7.2.4.16

Process AudioConfig Element . . . 7.2.4.17

Process media header Element . . . 7.2.4.18

Process tref Element . . . 7.2.4.19

Process edts Element . . . 7.2.4.20

Process Optional User Data Elements . . . 7.2.5

Update odsm Buffer Size . . . 7.2.6

### DETAILED DESCRIPTION OF THE INVENTION

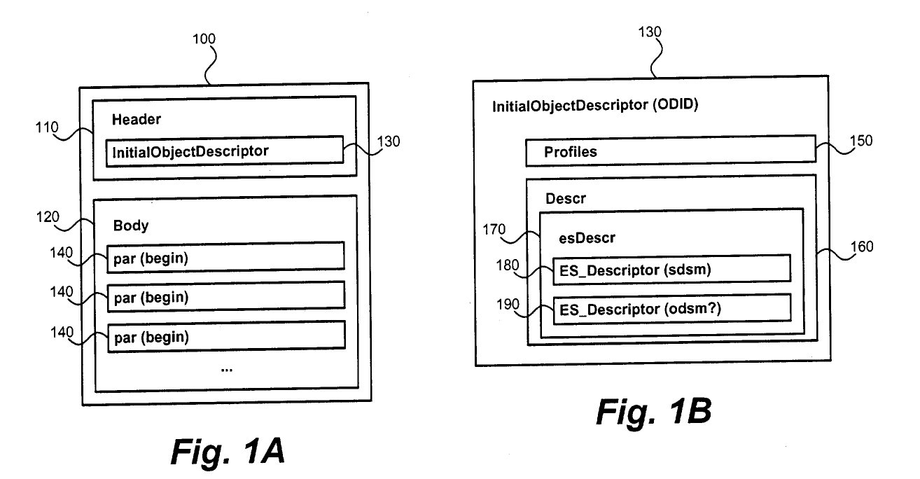

The present invention is a method, system, and computer program for converting an Extensible MPEG-4 Textual (XMT) format (also referred to herein as an XMT-A document and an MPEG-4 Textual Representation) into a binary coded MPEG-4 (mp4) format (also referred to as an MPEG-4 intermedia binary format). The invention utilizes a novel approach to achieve conversion from XMT-A to mp4 that requires a relatively small amount of software and only modest resources. The invention is described herein with reference to FIGS. 1-54.

### 1.0 MPEG-4 Textual Representation

The MPEG-4 Textual Representation consists of a “text file” representing the structure of a multimedia presentation. A multimedia presentation consists of a synchronized combination or sequence of sounds, still images, video clips, and other elements. A text file is an electronic data structure composed of a sequence of binary codes for letters, numbers, and punctuation. Text files can generally be interpreted using software commonly known as “text editors”. There are many examples of text editors, including software known as “NotePad.exe” for computers based on the Windows (r) operating system, and “vi” for computers using various operating systems known collectively as UNIX. Windows is a registered trademark of Microsoft Corporation, located in Redmond, Wash. The particular type of text files comprising the MPEG-4 Textual Representation is known as “XMT-A” files.

Within the scope of text files, an XMT-A file is an example of an Extensible Markup Language (XML) file. An XML file is a structured document base on the principles specified by the World Wide Web Consortium (see http://www.w3.org/TR/2000/REC-XML-20001006). An XMT-A file represents a particular embodiment of an XML file, as specified by the International Standards Organization and International Electrotechinal Commission (see ISO/IEC document 14496-1:2000 Amd.2, October 2000 available from http://mpeg.telecomitalialab.com/working_documents.htm and International Organization for Standardization (ISO), 1, rue de Varembé, Case postal 56, CH-1211 Geneva 20, Switzerland). A complete description of every part of the XMT-A specifications would be very voluminous. Thus, the following description of XMT-A files is limited to the portions of the specification needed to describe the present invention. Readers should consult the cited XMT specifications document for a complete description of the XMT-A file structure.

Like any XML file, an XMT-A file consists of a hierarchical set of “elements”. Each element may contain subordinate elements known as child elements. In addition, each element may possess a set of data values known as “attributes”. Each attribute has a name and a value. The particular attribute names and possible child elements possessed by any particular element depend on the element's type. The interpretation of each attribute value depends on the corresponding attribute name and of the element possessing the attribute.

As illustrated in FIG. 1A, an XMT-A file 100 consists of two main parts, a Header element 110 and a Body element 120. The Header element 110 contains a single child element defined as an InitialObjectDescriptor element 130. The Body element 120 contains one or more “par” elements 140 as child elements.

The InitialObjectDescriptor has one attribute, an ObjectDescriptorID (ODID) 130, and its value is a character string. As shown in FIG. 1B, this element has two children, a Profiles element 150 and a Descr element 160. A Profiles element 150 has no child elements. The Profiles element 150 possesses several attributes including “includeInclineProfileLevelFlag”, “sceneProfileLevelIndication”, “ODProfileLevelIndication”, “audioProfileLevelIndication”, “visualProfileLevelIndication”, and “graphicsProfileLevelIndication”.

A Descr element 160 may have several types of child elements. The only type essential to the present invention is a single “esDescr” element 170. An esDescr element 170 may possess one or more “ES_Descriptor” child elements 180, 190. An ES_Descriptor element specifies certain properties of an “elementary stream”,a concept defined in the MPEG-4 documentation. The structure of an ES_Descriptor element is indicated below.

The esDescr element 170 subordinate to an InitialObjectDescriptor element 130 may possess one or two ES_Descriptor elements 180, 190. In every case, there should be an ES_Descriptor 180 for the elementary stream defined as the “sdsm” or “scene description stream”. In addition, there may be a second ES_Descriptor 190 for an elementary stream defined as the “odsm” or “object descriptor stream”. The ES_Descriptor element 190 for the odsm is required only for XMT-A files that depend on audio data, visual data, or other types of media data not specified within the sdsm.

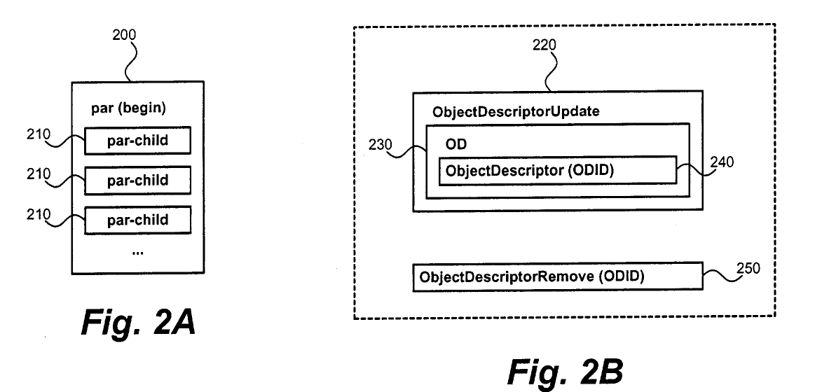

As shown in FIG. 2A, each par element 140, 200 contains one or more “par-child” elements 210. A “par-child” element may be another par element, an odsm command, or a bifs command. Each par element also contains an attribute with the name “begin”. The value of the begin attribute specifies the time when the odsm or bifs commands within the par element are to be performed. The time value determined by the begin attribute of a par element is calculated relative to the time value implied by any parent, and the Body element 120 implies a begin time of zero.

A par-child element 210 may contain instances of two types of odsm command elements, shown in FIG. 2B. These include ObjectDescriptorUpdate elements 220 and ObjectDescriptorRemove elements 250. An ObjectDescriptorUpdate element 220 contains a single OD child element 230, and the OD element 230 contains a single ObjectDescriptor child element 240. An ObjectDescriptor element 240 is described in more detail below. An ObjectDescriptorRemove element 250 has one attribute and no child elements. The attribute of an ObjectDescriptorRemove element 250 is named “ODID”.

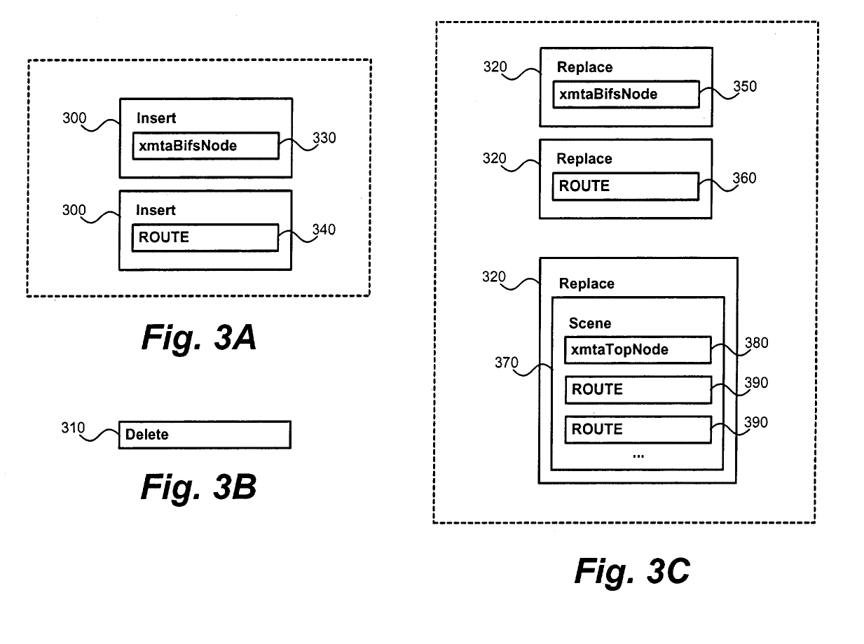

A par-child element 210 may contain instances of three types of bifs command elements, shown in FIG. 3. These include Insert elements 300, Delete elements 310, and Replace elements 320. As shown in FIG. 3A, an Insert element 300 may have either an “xmtaBifsNode” child element 330 or a “ROUTE” child element 340. The Delete element 310 has no children. The Replace element 320 may have an “xmtaBifsNode” 350 child element, a “ROUTE” child element 360, or a “Scene” child element 370. A Scene element has an “xmtaTopNode” child element 380. A Scene element may also have one or more ROUTE child elements 390.

A ROUTE element 340, 390 has no children. The attributes of a ROUTE element 340, 390 include “fromNode”, “fromField”, “toNode”, and “toField”.

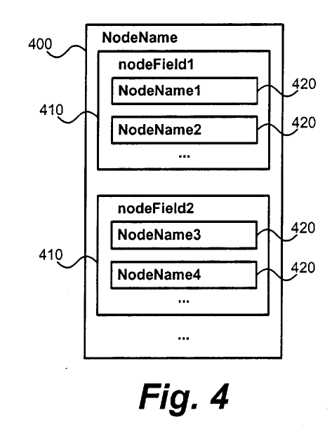

The term “xmtaBifsNode element” 330 represents any one of roughly 100 defined BIFS Node elements. Each of these has the general structure 400 shown in FIG. 4. Each xmtaBifsNode element 400 represents a BIFS Node, a binary data structure defined in the MPEG-4 Systems specifications ISO-IEC document ISO/IEC 14496-1:2001, August 2001, Chapter 9). Information regarding this document is available at http://mpeg.telecomitalialab.com/documents.htm and International Organization for Standardization (ISO), 1, rue de Varembé, Case postale 56, CH-1211 Geneva 20, Switzerland. The element tag for each xmtaBifsNode element 400 is based on the corresponding NodeName defined in the MPEG-4 Systems specifications. Some types of xmtaBifsNode elements may have subordinate (child) elements based on certain properties of the corresponding BIFS Node. These are called nodeField elements 410. Each nodefield element may have one or more subordinate elements consisting of further xmtaBifsNode elements 420. This arrangement may be repeated recursively to describe a hierarchical tree of BIFS nodes. There is no limit to the depth of this hierarchy.

Each BIFS Node has a number of properties called “fields”. Each of these field has a defined field name (string) and field data type (boolean, integer, float, etc.). One of the field data types is “Node”. All of the field data types other than Node are represented by like-named attributes of an xmtaBifsNode element 400. Each field with type “Node” is represented by a like-named child element 410 of an xmtaBifsNode element 400. Each child element 410 of an xmtaBifsNode element 400 may have one or more xmtaBifsNode elements 420 as child elements (grandchildren to the xmtaBifsNode parent element 400).

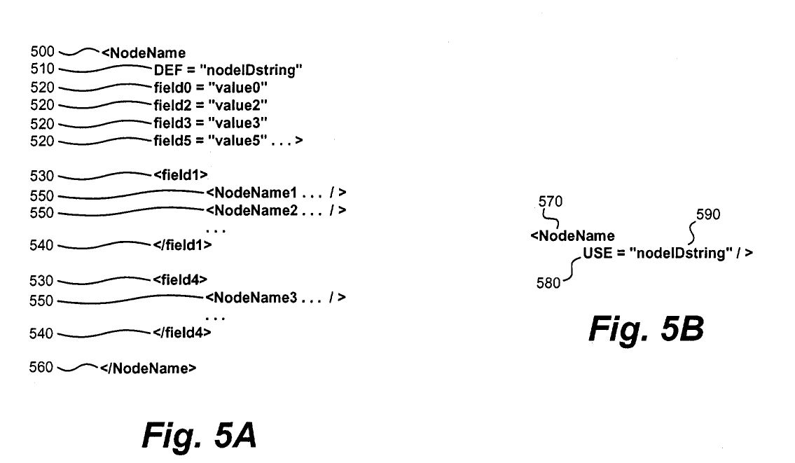

The XML representation of an XMT-A BIFS Node is illustrated in FIG. 5. Each XMT-A BIFS Node element is identified by a NodeName tag 500, 570 which uniquely identifies one of over 100 possible types of XMT-A BIFS nodes. Each node element may be an original node element 500 or a reused node element 570. In the case of an original node element 500, an optional attribute “DEF” 510 may be used to provide a unique alphanumeric description of a particular node. If this attribute is provided, the node is classified as “reusable”.

An original XMT-A BIFS node element also possesses a set of field attributes 520, with one field attribute for each property field defined for nodes of type NodeName and having a node data type other than “node” or “buffer”. These attributes are identified as “field0”, “field2”, “field3”, and “field5” in FIG. 5A. The actual names of each of these attributes are determined by the corresponding property field names defined in the MPEG-4 Systems specifications for nodes of type “NodeName”. The values assigned to each of these attributes must represent data values having a node data type (boolean, integer, float, etc.) defined in the MPEG-4 Systems specifications.

In addition, an original XMT-A BIFS node element 500 may have one or more field-value child elements 530, 540 with element tags corresponding to the field names for property fields having data type of “node” or “buffer”. Each such field-value element has a start-tag 530 and an end-tag 540. Examples of such field-value elements 530, 540 are represented by element tags <field1> . . . </field1> and <field4> . . . </field4> in FIG. 5A.

In the case of a property field with data type “node”,the field value element may contain one or more child elements corresponding to BIFS-Node elements 550. Examples of such BIFS-Node children are represented by element tags <NodeName1 . . . />, <NodeName2 . . . />, and <NodeName3 . . . />.

In the case of a property field with data type “buffer”,the field-value element may contain one or more child elements corresponding to BIFS command elements 300, 310, 320.

If an XMT-A BIFS Node element includes any field-value child elements, the Node element will be terminated by a </NodeName> end-tag 560, following standard XML principles.

The foregoing definition of an XMT-A BIFS node element is applied recursively to each of the subordinate BIFS node elements (<NodeName1>, etc.), allowing a hierarchical tree of nodes to be created. There is no limit to the depth of this tree of XMT-A BIFS node elements.

In the case of a reused node 570, the node element has only one attribute and no children. The sole attribute is a “USE” attribute 580 whose value 590 is a node ID string. The node ID string provided as the value for the USE attribute must match the node ID string specified as the DEF attribute 510 of an original node element 500 with the same NodeName.

The term “xmtaTopNode” represents one of a defined subset of xmtaBifsNode elements permitted to serve as child elements to the Scene element.

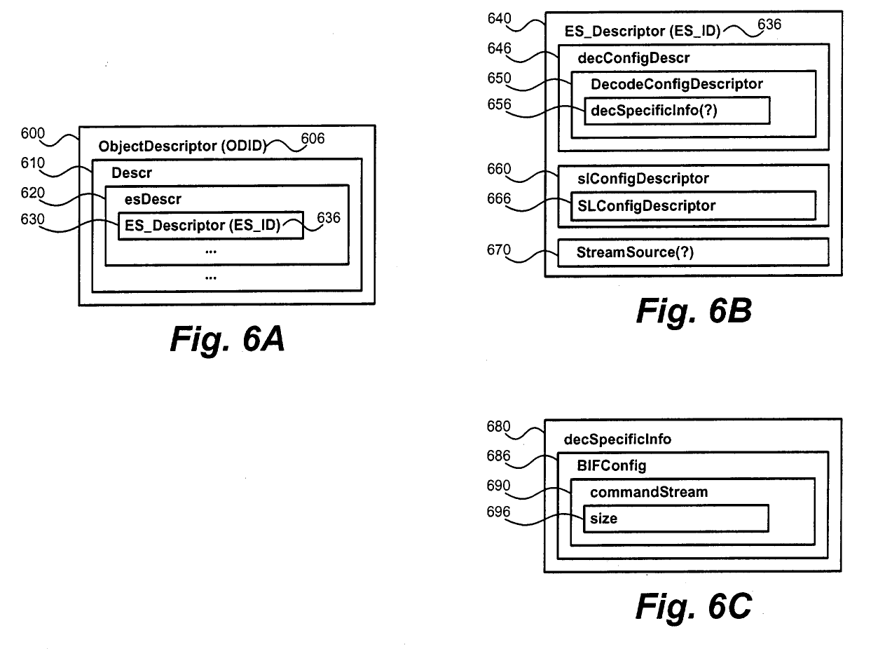

As shown in FIG. 6A, an ObjectDescriptor element 240, 600 (grandchild to an ObjectDescriptorUpdate element 220) is similar to the InitialObjectDescriptor element 130 described above. Unlike an InitialObjectDescriptor element 130, the ObjectDescriptor element 240, 600 lacks a Profiles child element 150. Like an InitialObjectDescriptor element 130, an ObjectDescriptor element 240, 600 has an “ObjectDescriptorID” (ODID) attribute 606. A typical ObjectDescriptor element 240, 600 has a single Descr child element 610, the Descr element 610 has a single esDescr child element 620, and the esDescr element 620 has a single ES_Descriptor child element 630. The Descr element 610, esDescr element 620, and ES_Descriptor element 630 are similar to the corresponding children 160, 170, 180, 190 of the InitialObjectDescriptor element 130.

An ES_Descriptor element 180, 190, 630 may be contained within either an ObjectDescriptor element 600 or an InitialObjectDescriptor element 130. In either case, an ES_Descriptor element 180, 190, 630 has the structure 640 shown in FIG. 6B. The value of the “ES_ID” attribute 636 of an ES_Descriptor element 640 is an alphanumeric string which is unique to each stream. An ES_Descriptor 640 element always has a decConfigDescr child element 646 and an slConfigDescr child element 660. If an ES_Descriptor element 630, 640 is subordinate to an ObjectDescriptor element 600, the ES_Descriptor element 630, 640 also has a StreamSource child element 670. If an ES_Descriptor element 180, 190, 640 is subordinate to an InitialObjectDescriptor element 130, the ES_Descriptor element 180, 190, 640 does not have a StreamSource child element 670.

A decConfigDescr element 646 has a DecoderConfigDescriptor child element 650. A DecoderConfigDescriptor element 650 has several attributes including “streamType” and “objectTypeIndication” which indicate whether the parent ES_Descriptor element 640 represents audio, visual, sdsm, odsm, or other type of media. A DecoderConfigDescription element 650 may also have a decSpecificInfo child element 656 depending the values of the streamType and objectTypeIndication.

In the case of an ES_Descriptor element 180 for an sdsm (scene description stream), the DecoderConfigDescriptor 650 element has a decSpecificInfo child element 656. As shown in FIG. 6C, the decSpecificInfo 680 element has a BIFSConfig child element 686. The BIFSConfig element 686 possesses several attributes which specify how the BIFS Nodes are to be encoded. The BIFSConfig element 686 also possesses a commandStream element 690 and the commandStream element 690 possesses a “size” element 696.

The slConfig element 660 has an SLConfigDescriptor child element 666. The SLConfigDescriptor element 666 has one attribute named “predefined” and no child elements. The “predefined” attribute always has the value “2”.

The StreamSource element 670 has one attribute, “url”, and no child elements. The value of the url attribute specifies either a file name or a Internet address (URL, Uniform Resource Locator) indicating the location of a media data file containing audio data, visual data, or other data which defines the actual sounds, images, etc. for a particular stream. The StreamSource element 670 is not present for the sdsm (scene description stream) or odsm (object descriptor stream) because these streams are both determined by the XMT-A file.

### 2.0 MPEG-4 Intermedia Format Files

An MPEG-4 Intermedia Format file is a form of electronic data with a structure and composition defined in Chapter 13 of the MPEG-4 Systems specifications document ISO-IEC document ISO/IEC 14496-1:2001, August 2001. This form of electronic data structure is an example of what is commonly known as a “binary file” because it is composed of a sequence of binary data values which are not limited to representations of letters, numbers, and punctuation. This allows for a more compact data structure than is afforded by typical text files such as XMT-A files. Stored forms of electronic data having the structure defined by the MPEG-4 Intermedia Format are called “mp4 binary files”. Unlike XMT-A files, mp4 binary files cannot be interpreted by most text editing software.

The MPEG-4 Intermedia Format has been derived from the QuickTime (r) file format defined by Apple Computers, Inc. in 1996 and available online at http://developer.apple.com/techpubs/quicktime/qtdevdocs/REF/refFileFormat96.htm and http://developer.apple.com/techpubs/quicktime/qtdevdocs/PDF/QTFileFormat.pdf. QuickTime is registered trademark of Apple Computer, Inc.

Because of its QuickTime (r) heritage, the MPEG-4 Intermedia Format retains a number of characteristics derived from QuickTime (r) specifications. These characteristics include the concept of an “atom” as a unit of data structure. Each atom has two parts, a header and a body. The header contains an atom size value which specified the number of bytes comprising the atom, including the header. The header also contains an atomId which specifies the type of atom. The body of an atom contains the data carried by the atom. This data may include subordinate atoms. In its basic form, an atom has an atom size value comprised of four bytes (unsigned integer) and an atomId also consisting of four bytes (characters). Extended forms of an atom having atom size values and atomId values with more than 4 bytes are also defined in the MPEG-4 specifications.

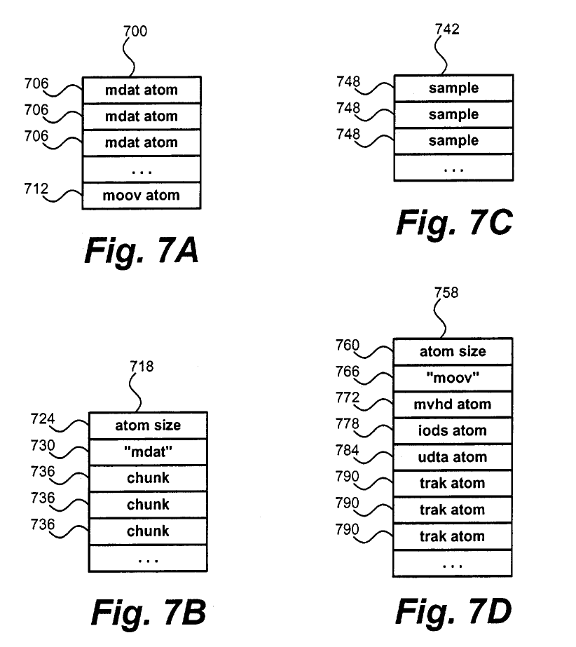

As shown in FIG. 7A, an mp4 binary file 700 is composed of one or more “mdat” atoms 706 and one “moov” atom 712. The moov atom 712 may precede or follow the mdat atom(s) 706. As shown in FIG. 7B, each mdat atom 718 consists of an atom size value 724 followed by the four-byte atomId “mdat” 730 and a sequence of data blocks called “chunks” 736. As shown in FIG. 7C, each chunk 742 is composed of a sequence of media data “samples” 748. Each sample 748 specifies a block of data associated with a particular point in time for a single media stream. All samples within a single chunk must represent the same media data stream. It is not necessarily possible to identify the individual samples 748 or chunks 736, 742 from inspection of an mdat atom 700. Each sample 748 and chunk 736, 742 may be identified using tables stored elsewhere within the mp4 binary file.

As shown in FIG. 7D, the moov atom 754 consists of an atom size value 760 followed by the four-byte atomId “moov” 766 and several subordinate atoms including an “mvhd” (moov header) atom 772, an “iods” (initial object descriptor) atom 778, and one or more “trak” atoms 790. The “moov” atom 712, 754 includes one “trak” atom 790 for each data stream, including the sdsm (scene description stream) and odsm (object descriptor stream), if present. The “moov” atom 712, 754 may also include an optional “udta” (user data) atom 784. A “udta” atom 784 may be used to imbed optional information such as a copyright message in an mp4 binary file.

The mvhd atom 772 consists of an atom size value followed by the four-byte atomId “mvhd” and a number of data values including time and date stamps, a time scale value, and a file duration value. The value of the atom size for the mvhd atom is always 108. The time and date stamps indicate when the file was created. The time scale value indicates the number of ticks per second used to represent time values for the file. The file duration value indicates the total time required to present the material in the file, in the time units specified by the time scale value.

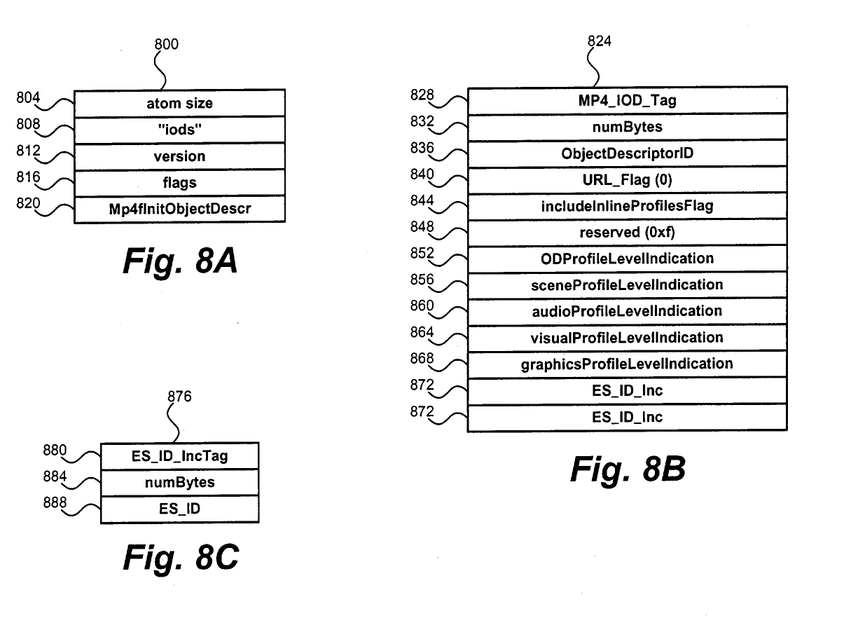

As shown in FIG. 8A, an iods atom 800 consists of an atom size value 804 followed by the four-byte atomId “iods” 808, an 8-bit version value 812, a 24-bit flags value 816, and an Mp4fInitobjDescr data structure 820. As shown in FIG. 8B, the Mp4fInitObjDescr data structure 824 consists of a one-byte MP4_IOD_TAG value 828, the number of bytes 832 in the subsequent data block, a 10-bit ObjectDescriptorID 836, two flag bits 840, 844, four reserved bits 848 and five profile level indication values 852, 856, 860, 864, 868. The profile level indication values are followed by one or two MPEG-4 ES_ID_Inc data structures 872. One ES_ID_Inc structure indicates the ES_ID value of the trak atom 790 corresponding to the sdsm (scene description stream). The second ES_ID_Inc structure, if present, indicates the ES_ID of the trak atom 790 corresponding to the odsm (object descriptor stream). The second ES_ID_Inc structure is present only when an odsm is present. As shown in FIG. 8C, each ES_ID_Inc data structure consists of a one-byte ES_ID_IncTag value 880, the number of bytes 884 in the subsequent data (always 4) and a 32-bit ES_ID value 888.

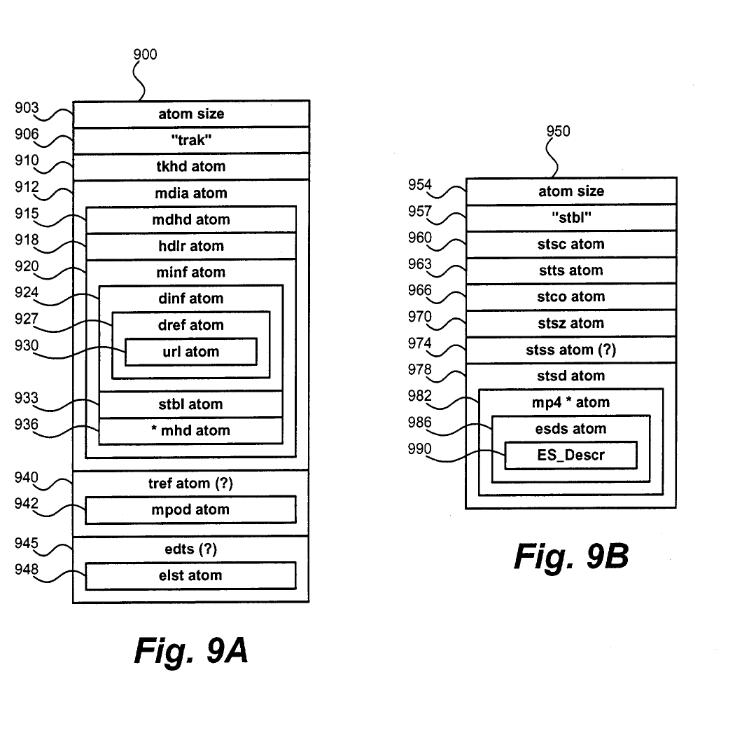

As shown in FIG. 9A, each trak atom 900 consists of an atom size value 903 followed by the four-byte atomId “trak” 906, a “tkhd” (track header) atom 910, and a “mdia” (media) atom 912. In the case of a trak atom representing the odsm (object descriptor stream), the trak atom also includes a “tref” (track reference) atom 940. In the case of a track with a delayed start, an “edts” (edit list) atom 945 is provided to indicate when to start the track. The mdia atom 912 consists of an “mdhd” (media header) atom 915, an “hdlr” (handler) atom 918, an “minf” (media information) atom 920, an “stbl” (sample tables) atom 933, and a media information header atom 936. The label “*mhd” represents any one of several media information header atom types including “nmhd” (for sdsm and odsm tracks), “smhd” (for audio tracks), “vmhd” (for visual tracks), etc.

The tkhd atom 910, mdhd atom 915, and hdlr atom 918 contain a number of data values including a trackId number, time and date stamps, media time scales and media duration values. Each track has its own time scale which can differ from the global time scale specified in the mvhd atom 772.

As shown in FIG. 9B, the sample tables atom 950 consists of an atom size value 954 followed by the four-byte atomId “stbl” 957 and a series of sample table atoms 960, 963, 966, 970, 974, 978. The various sample table atoms may be in any order. These include an “stsc” (sample-to-chunk table) atom 960, an “stts” (time-to-sample table) atom 963, an “stco” (chunk offset table) atom 966, an “stsz” (sample size table) atom 970, a possible stss (sync sample table) atom 974, and an “stsd” (sample description table) atom 978. Each of these sample table atoms contains data describing properties of the binary media data 736, 748 stored in the associated mdat atom 706, 718.

The sample-to-chunk table atom (stsc atom) 960 consists of an atom size value, a four-byte atomId (“stsc”), a 32-bit unsigned integer (numStscEntries), and a sequence of sample-to-chunk data records. The value of numStscEntries specifies the number of entries in the sequence of sample-to-chunk data records. Each sample-to-chunk data record consists of three 32-bit unsigned integers which specify a starting chunk number, a number of samples per chunk, and a sample description index. The sample description index is an index to an entry in the sample description table 978. The number of samples per chunk specifies the number of samples 748 in the chunk 736 specified by the starting chunk number, and all subsequent chunks preceding the starting chunk specified by the next entry.

The time-to-sample table atom (stts atom) 963 consists of an atom size value, a four-byte atomId (“stts”), a 32-bit unsigned integer (numSttsEntries), and a sequence of time-to-sample data records. The value of numSttsEntries specifies the of entries in the sequence of time-to-sample data records. Each time-to-sample data record consists of two 32-bit unsigned integers which specify a sample count and a sample duration in track time scale units. The sample count value specifies the number of successive samples 748 having the corresponding sample duration.

The chunk offset table atom (stco atom) 966 consists of an atom size value, a four-byte atomId (“stco”), a 32-bit unsigned integer (numStcoEntries), and a sequence of chunk offset values. The value of numStcoEntries specifies the number of entries in the sequence of chunk offset values. Each entry in this sequence consists of one 32-bit unsigned integer which specifies the number of bytes between the start of the mp4 file and the start of the corresponding chunk 736 within an mdat atom 718.

The sample size table atom (stsz atom) 970 consists of an atom size value, a four-byte atomId (“stsz”), and a 32-bit unsigned integer (iSampleSize) which specifies the size of all media data samples 748 associated with this trak atom 900. If the media data samples associated with this trak atom are not all equal in size, the value of iSampleSize is specified as zero, followed by a 32-bit unsigned integer (numStszEntries) and a sequence of sample size values. The value of numStszEntries specifies the number of entries in the sequence of sample size values. Each entry in this sequence consists of one 32-bit unsigned integer which specifies the number of bytes in the corresponding sample 748 within the media data 718 associated with this trak atom 900.

The sync sample table atom (stss atom) 974, if present, consists of an atom size value, a four-byte atomId (“stss”), a 32-bit unsigned integer (numStssEntries), and a sequence of sample index values. The value of numStssEntries specifies the number of entries in the sequence of sample index values. Each entry in this sequence consists of one 32-bit unsigned integer which specifies a sample index for a “random access sample”. A random access sample index identifies a media data sample 748 corresponding to a point in the media data associated with this trak atom 900 where a media player can start processing the media data without regard to any preceding samples. The sample index values in this table must be monotonically increasing.

The sample description table atom (stsd atom) 978, consists of an atom size value, a four-byte atomId (“stsd”), a 32-bit unsigned integer (numStsdEntries), and a sequence of sample description data records. The value of numStsdEntries specifies the number of entries in the sequence of sample description data records. Each sample description data record specifies the means used to encode the media data samples identified by the corresponding index in a sample-to-chunk data record. The sequence of sample description data records typically has a single entry (numStsdEntries=1) which specifies the type of media (audio, visual, sdsm, odsm), the compression algorithms used for audio and video samples, etc. Each sample description table entry is contained within an “mp4*” atom 982, where “mp4*” is a generic substitute for “mp4s” (for sdsm and odsm samples), “mp4a” (for audio samples), and “mp4v” (for visual samples). Each “mp4*” atom 982 contains an “esds” (elementary stream descriptor) atom 986, and each esds atom 986 contains an MPEG-4 elementary stream descriptor (Es_Descr) data structure 990.

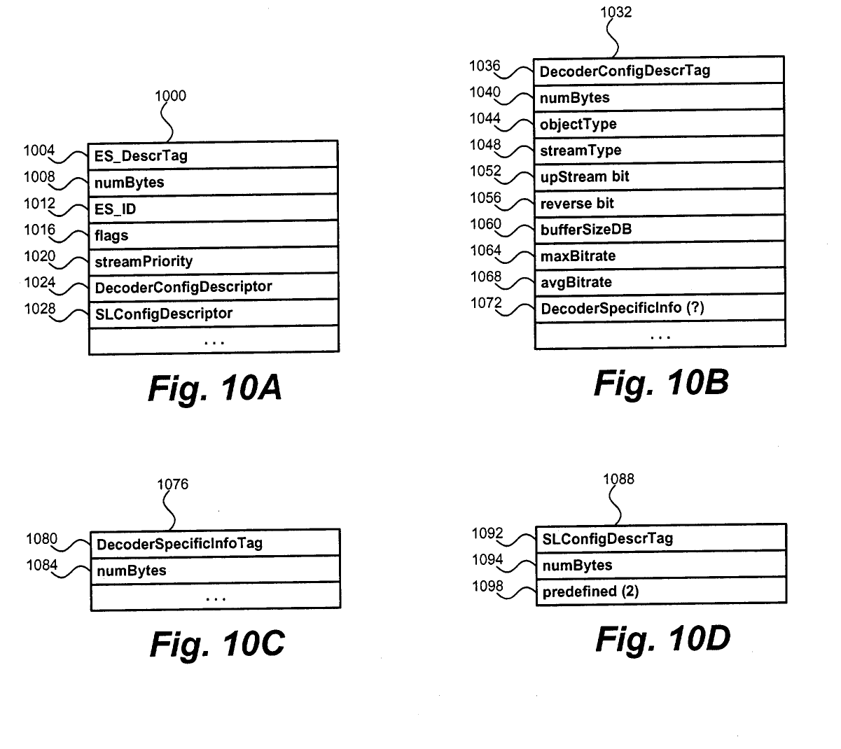

The structure of the MPEG-4 elementary stream descriptor 1000 is shown in FIG. 10A. This data structure consists of a one-byte tag (ES_DescrTag) 1004, followed by an indication 1008 of the number of bytes in the remainder of the data structure, a 16-bit ES_ID value (usually zero) 1012, three 1-bit flags (streamDependenceFlag, URL_Flag, and OCRstreamFlag) 1016, and a 5-bit stream priority value 1020. If any of the three flags 1016 is non-zero, then additional data values (not shown) may follow the stream priority value 1020. These optional data values are not required for this invention.

The stream priority value 1020 is followed by a decoder configuration descriptor data structure 1024 and a sync-layer configuration descriptor data structure 1028. The structure of the decoder configuration descriptor 1024, 1032 is shown in FIG. 10B. This data structure consists of a one-byte tag (DecoderConfigDescrTag) 1036, followed by an indication 1040 of the number of bytes in the remainder of the data structure, and a series of data values: objectType 1044, streamType 1048, upstream bit 1052, reserved bit 1056, bufferSizeDB 1060, maxBitrate 1064, and avgBitrate 1068. These values may be followed by a streamType and objectType dependent decoder specific information data structure 1072. A decoder specific information data structure 1072 is required for the sdsm, but not the odsm. Most audio and visual media data streams also have decoder specific information data structures within the decoder configuration descriptor 1032.

The structure of the decoder specific information data 1072, 1076 is shown in FIG. 10C. This data structure consists of a one-byte tag (DecoderSpecificInfoTag) 1080, followed by an indication 1084 of the number of bytes in the remainder of the data structure. The remaining bytes depend on the objectType and streamType. In the case of the sdsm (scene description stream or BIFS), the decoder specific information 1072, 1076 includes indications of the number of bits used to encode nodeID values, and the number of bits used to encode routeID values. Each of these values is represented by a 5-bit unsigned integer.

The structure of the sync layer configuration descriptor 1028, 1088 is shown in FIG. 10D. This data structure consists of a one-byte tag (SLConfigDescrTag) 1090, followed by an indication 1094 of the number of bytes in the remainder of the data structure (always 1), and a single data byte (value 2, “predefined”) 1098 which indicates that a predefined configuration is to be used for the sync layer.

### 3.0 Scene Description Stream (sdsm)

The means used to encode or decode particular types of audio and visual data streams are not determined by either the XMT-A specifications or the MPEG-4 Intermedia File specifications, so the details of how these streams are encoded will not be covered here. An XMT-A document contains detailed information regarding the contents of the stream description stream (sdsm) and object description stream (odsm). Consequently, each XMT-A document is intimately related to the sdsm and odsm streams contained within an MPEG-4 Intermedia File. This section describes the structure of the sdsm data, and the following section describes the structure of the odsm data.

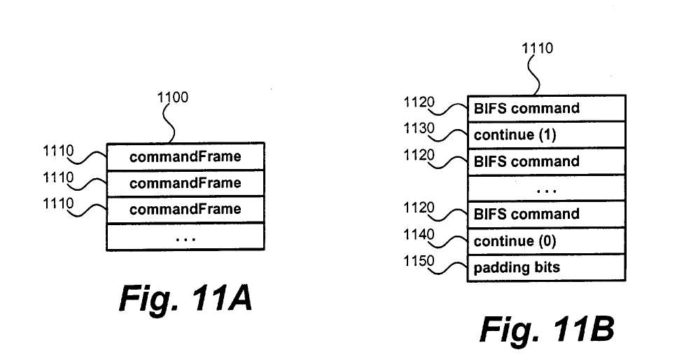

Like any other media data stream, the sdsm data is composed of one or more chunks, and each chunk is composed of one or more samples. As shown in FIG. 11A, each sample within an sdsm binary chunk 1100 is defined as a “command frame” 1110. Each command frame 1110 is byte-aligned. As shown in FIG. 11B, each command frame 1110 consists of one or more “BIFS commands” 1120. “BIFS” stands for “BInary Format for Streams”. Each BIFS command 1120 is followed by a continue bit 1130, 1140. If the value of the continue bit is (1) 1130, another BIFS command follows. Otherwise 1140, continue bit is followed by a sufficient number of null padding bits 1150 to complete the last byte. Individual BIFS commands 1120, except for the first BIFS command in a command frame, are not generally byte-aligned.

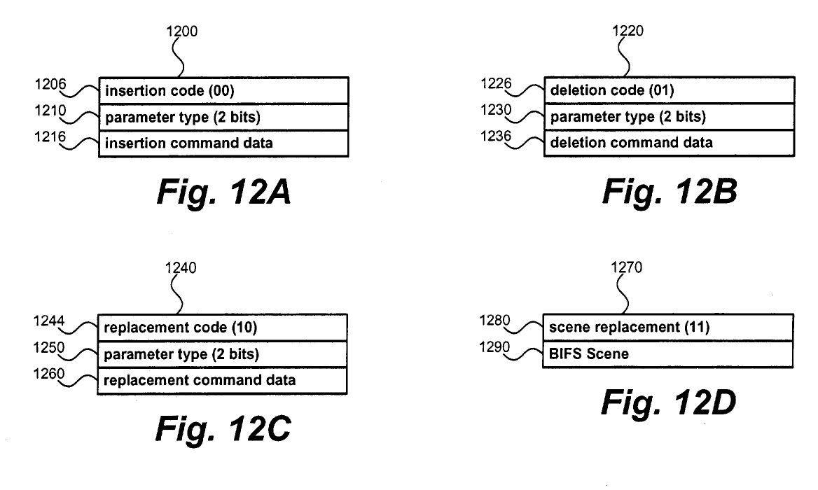

As shown in FIG. 12, there are four types of BIFS commands: “insertion”, “deletion”, “replacement”, and “scene replacement”. A BIFS insertion command 1200 consists of the two-bit insertion code (value=“00”) 1206 followed by a two-bit parameter type code 1210 and insertion command data 1216. A BIFS deletion command 1220 consists of the two-bit deletion code (value=“01”) 1226 followed by a two-bit parameter type code 1230 and deletion command data 1236. A BIFS replacement command 1240 consists of the two-bit replacement code (value=“10”) 1244 followed by a two-bit parameter type code 1250 and replacement command data 1260. A BIFS scene replacement command 1270 consists of the two-bit scene replacement code (value=“11”) 1280 followed by a BIFS Scene data structure 1290.

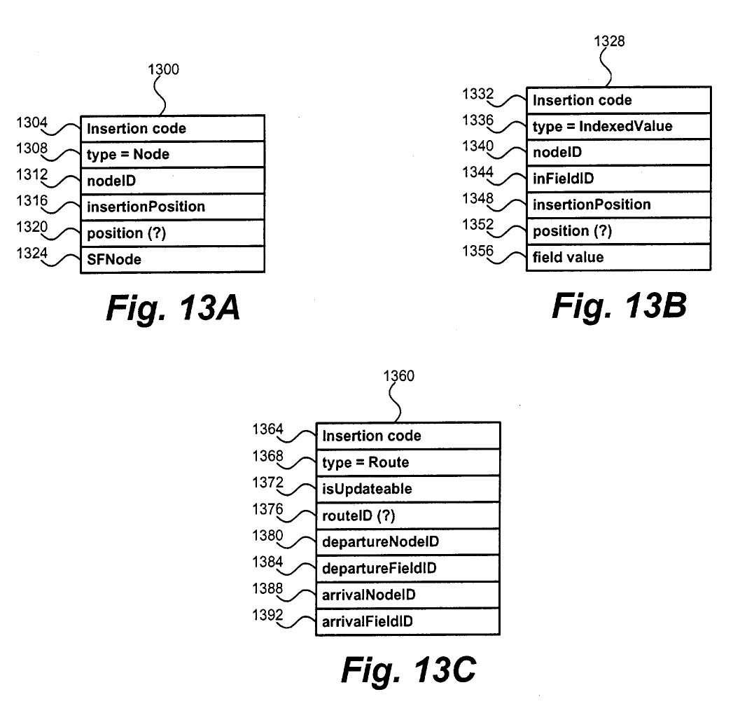

As shown in FIG. 13, there are three types of BIFS insertion commands, (a) the Node Insertion command, (b) the Indexed Value Insertion command, and (c) the Route Insertion command. The type of insertion command is determined by the parameter type value 1210. A Node Insertion command 1300 consists of the two-bit insertion code (value=“00”) 1304 followed by the two-bit parameter type code (value=“01”, type=Node) 1308, a nodeID value 1312, a two-bit insertion position code 1316, and an SFNode data structure 1324. If the value of the insertion position code 1316 is zero, an 8-bit position value 1320 follows the insertion position code 1316. The nodeID value 1312 specifies one of a set of updateable nodes defined elsewhere in the BIFS commands. The number of bits used to encode this and other nodeID values is specified in the decoder specific information 1072 for the sdsm stream. The structure of the SFNode data structure 1324 is explained below.

An Indexed Value Insertion command 1328 consists of the two-bit insertion code (value=“00”) 1332 followed by the two-bit parameter type code (value=“10”, type=IndexedValue) 1336, a nodeID value 1340, an inFieldID value 1344, a two-bit insertion position code 1348, and a field value data structure 1356. If the value of the insertion position code 1348 is zero, an 8-bit position value 1352 follows the insertion position code 1348. The nodeID value 1340 specifies one of a set of updateable nodes defined elsewhere in the BIFS commands. The number of bits used to encode the nodeID value 1340 is specified in the decoder specific information 1072 for the sdsm stream. The inFieldID value 1344 identifies one of the data fields for the BIFS node specified by the value of nodeID 1340. The number of bits used to encode the inFieldID value 1344 depends on tables contained in the MPEG-4 Systems Specifications.

The contents of a field value data structure depend on the field data type (boolean, integer, float, string, node, etc.) for a specified data field for a specified BIFS node. This can be as simple as one bit or as complex as an SFNode data structure. The field data type for each data field of each BIFS node is specified in tables contained in the MPEG-4 Systems Specifications.

A Route Insertion command 1360 consists of the two-bit insertion code (value=“00”) 1364 followed by the two-bit parameter type code (value=“11”, type=Route) 1368, an “isUpdateable” bit 1372, a departureNodeID value 1380, a departureFieldID value 1384, an arrivalNodeID value 1388, and an arrivalFieldID value 1392. If the value of the “isUpdateable” bit is (1), a routeID value 1376 follows the “isUpdateable” bit 1372. The number of bits used to encode the departureNodeID value 1380 and the arrivalNodeID value 1388 is specified in the decoder specific information 1072 for the sdsm stream. The number of bits used to encode the departureFieldID value 1384 and the number of bits used to encode the arrivalFieldID value 1392 depend on tables contained in the MPEG-4 Systems Specifications.

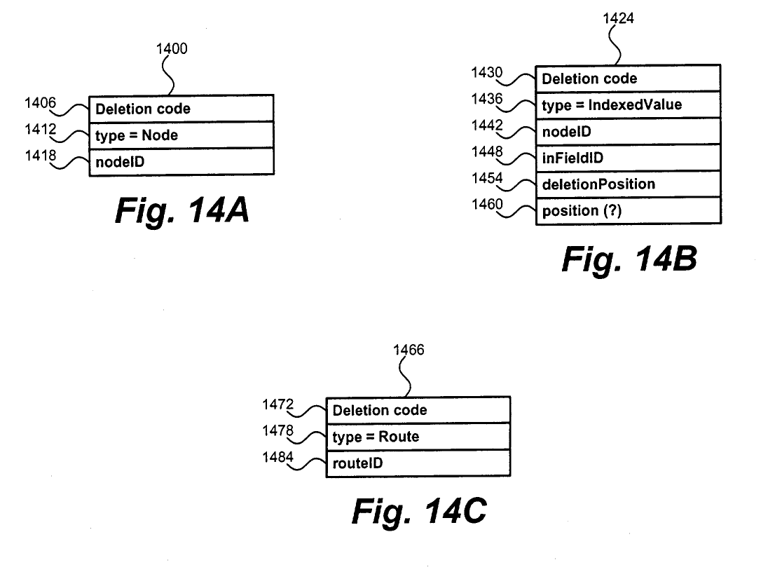

As shown in FIG. 14, there are three types of BIFS deletion commands: (a) the Node Deletion command, (b) the Indexed Value Deletion command, and (c) the Route Deletion command. The type of deletion command is determined by the parameter type value 1230. A Node Deletion command 1400 consists of the two-bit deletion code (value=“00”) 1406 followed by the two-bit parameter type code (value=“00”, type=Node) 1412 and a nodeID value 1418. The nodeID value 1418 specifies one of a set of updateable nodes defined elsewhere in the BIFS commands. The number of bits used to encode the nodeID value 1418 is specified in the decoder specific information 1072 for the sdsm stream.

An Indexed Value Deletion command 1424 consists of the two-bit deletion code (value=“01”) 1430 followed by the two-bit parameter type code (value=“10”, type=Indexed Value) 1436, a nodeID value 1442, an inFieldID value 1448, and a two-bit deletion position value 1454. The nodeID value 1418 specifies one of a set of updateable nodes defined elsewhere in the BIFS commands. The number of bits used to encode the nodeID value 1418 is specified in the decoder specific information 1072 for the sdsm stream.

A Route Deletion command 1466 consists of the two-bit deletion code (value=“10”) 1472 followed by the two-bit parameter type code (value=“11”, type=Route) 1478 and a routeID value 1484. The routeID value 1484 specifies one of a set of updateable routes defined elsewhere in the BIFS commands. The number of bits used to encode the routeID value 1484 is specified in the decoder specific information 1072 for the sdsm stream.

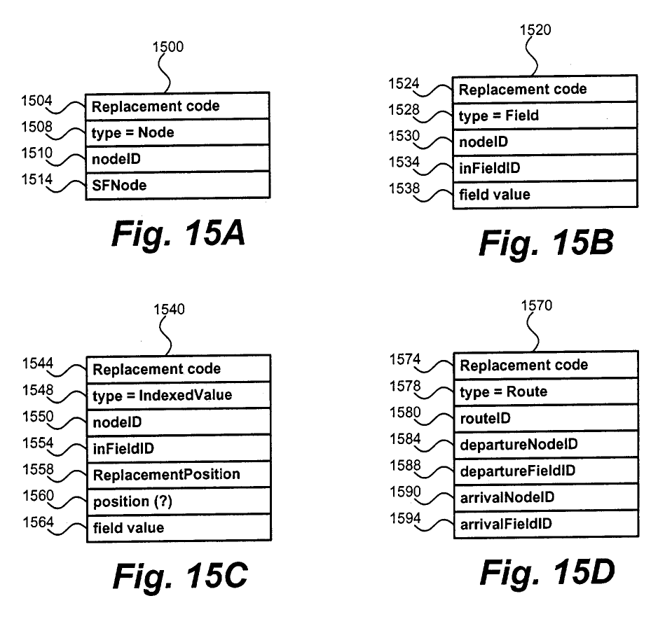

As shown in FIG. 15, there are four types of replacement commands, (a) the Node Replacement command, (b) the Field Replacement command, (c) the Indexed Value Replacement command, and (d) the Route Replacement command. The type of insertion command is determined by the parameter type value 1210. A Node Replacement command 1500 consists of the two-bit replacement code (value=“10”) 1504 followed by the two-bit parameter type code (value=“01”, type=Node) 1508, a nodeID value 1510, and an SFNode data structure 1514. The nodeID value 1510 specifies one of a set of updateable nodes defined elsewhere in the BIFS commands. The number of bits used to encode the nodeID value 1510 is specified in the decoder specific information 1072 for the sdsm stream. The structure of the SFNode data structure 1514 is explained below

A Field Replacement command 1520 consists of the two-bit replacement code (value=“10”) 1524 followed by the two-bit parameter type code (value=“01”, type=Field) 1528, a nodeID value 1530, an inFieldID value 1534, and a field value data structure 1538. The nodeID value 1530 specifies one of a set of updateable nodes defined elsewhere in the BIFS commands. The number of bits used to encode the nodeID value 1530 is specified in the decoder specific information 1072 for the sdsm stream. The inFieldID value 1534 identifies one of the data fields for the BIFS node specified by the value of nodeID 1530. The number of bits used to encode the inFieldID value 1534 depends on tables contained in the MPEG-4 Systems Specifications.

An Indexed Value Replacement command 1540 consists of the two-bit replacement code (value=“10”) 1544 followed by the two-bit parameter type code (value=“10”, type=IndexedValue) 1548, a nodeID value 1550, an inFieldID value 1554, a two-bit replacement position code 1558, and a field value data structure 1564. If the value of the replacement position code 1558 is zero, an 8-bit position value 1560 follows the replacement position code 1558. The nodeID value 1550 specifies one of a set of updateable nodes defined elsewhere in the BIFS commands. The number of bits used to encode the nodeID value 1550 is specified in the decoder specific information 1072 for the sdsm stream. The inFieldID value 1554 identifies one of the data fields for the BIFS node specified by the value of nodeID 1550. The number of bits used to encode the inFieldID value 1554 depends on tables contained in the MPEG-4 Systems Specifications.

An Route Replacement command 1570 consists of the two-bit replacement code (value=“10”) 1574 followed by the two-bit parameter type code (value=“11”, type=Route) 1578, a routeID value 1580, a departureNodeID value 1584, a departureFieldID value 1588, an arrivalNodeID value 1590, and an arrivalFieldID value 1594. The routeID value 1580 specifies one of a set of updateable routes defined elsewhere in the BIFS commands. The number of bits used to encode the routeID value 1580 is specified in the decoder specific information 1072 for the sdsm stream. The number of bits used to encode the departureNodeID value 1584 and the arrivalNodeID value 1590 is specified in the decoder specific information 1072 for the sdsm stream. The number of bits used to encode the departureFieldID value 1588 and the number of bits used to encode the arrivalFieldID value 1594 depend on tables contained in the MPEG-4 Systems Specifications.

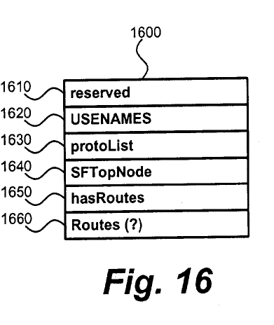

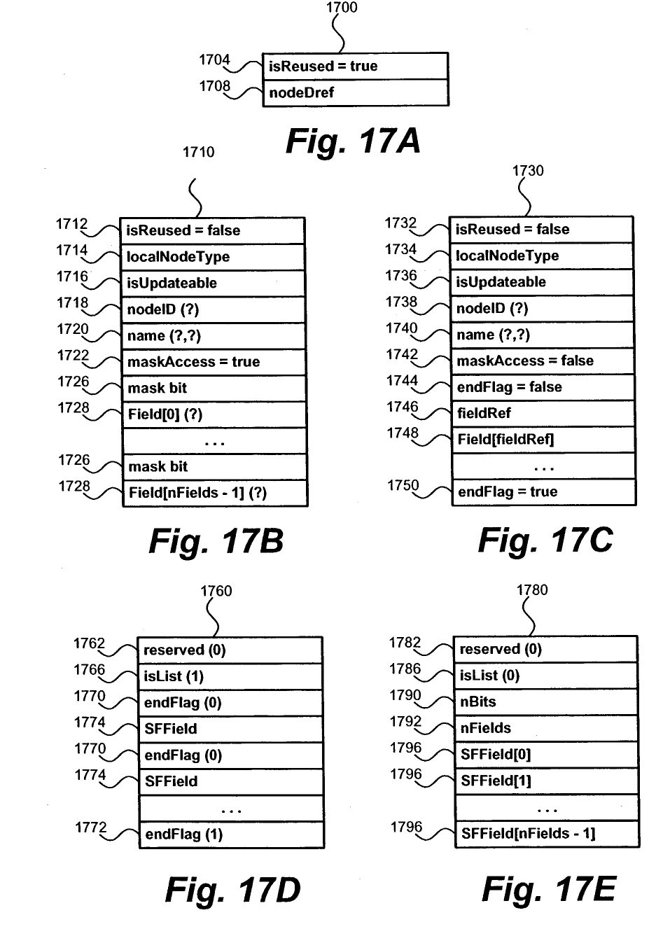

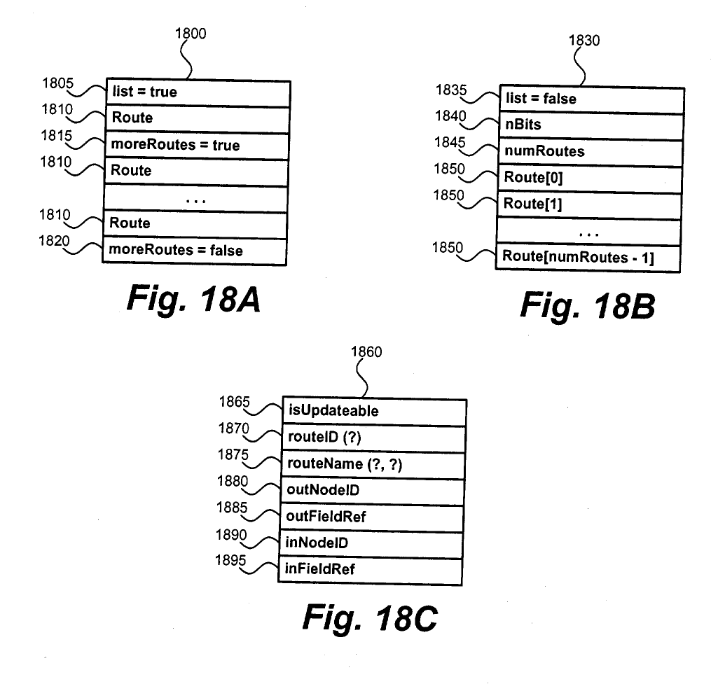

As shown in FIG. 12D, a ReplaceScene BIFS command 1270 consists of a two-bit scene replacement code (value=“11”) 1280 followed by a BIFS Scene data structure 1290. As shown in FIG. 16, a BIFS Scene data structure 1600 consists of a 6-bit reserved field 1610, two one-bit flags (USENAMES 1620 and protoList 1630), an SFTopNode data structure 1640, and a one-bit flag (hasRoutes) 1650. If the protoList flag 1630 is true (1), then additional data defined in the MPEG-4 Systems specifications follows the protoList flag. The SFTopNode data structure 1640 is a special case of an SFNode data structure which is shown in FIG. 17. If the hasRoutes flag 1650 is true (1), then a Routes data structure 1660 follows the hasRoutes flag. The structure of a Routes data structure is shown in FIG. 18.

As shown in FIGS. 17A, 17B, and 17C, an SFNode data structure may have one of three forms: (a) reused, (b) mask Node, and (c) list Node. All three forms start with a one-bit flag (isReused). In the case of a reused SFNode 1700, the value of the isReused flag is “1” (true) 1704, and the remainder of the SFNode data structure consists of a nodeIDref value 1708. The value of nodeIDref 1708 must match the nodeID value for an updateable SFNode defined elsewhere in the sdsm data.

If the isReusedFlag is false (0) 1712, 1732, an SFNode type may have one of the two forms shown in FIGS. 17B and 17C depending on the value of the maskAccess flag bit 1722, 1742. In either case, the data for the SFNode includes a local node type value (localNodeType) 1714, 1734, a one-bit flag (isUpdateable) 1716, 1736, and a second one-bit flag (maskAccess) 1722, 1742. The number of bits used to encode the local node type 1714, 1734 depend on tables specified in the MPEG-4 Systems specifications. If the isUpdateable flag 1716, 1736 is true (1), a nodeID value 1718, 1738 follows the isUpdateable flag. If the isUpdateable flag 1716, 1736 is true (1) and the USENAMES flag 1620 in the associated BIFSScene data structure 1600 is also true (1), then a null terminated string (“name”) 1720, 1740 follows the nodeID value 1718, 1738.

If the maskAccess bit is true (1) 1722, the SFNode has the “mask Node” structure 1710. In this case, as shown in FIG. 17B, the maskAccess bit 1722 is followed by an ordered sequence of mask bits 1726, one for each of the nFields property field defined in the MPEG-4 specifications for BIFS nodes with a node type given by the value of localNodeType 1714. In each case where one of these mask bits is true (1), the mask bit is followed by a binary field value 1728 encoded according to a field data type (integer, boolean, string, node, etc.) determined by the localNodeType 1734, the field number (position within the sequence of mask bits), and tables defined in the MPEG-4 specifications

If the maskAccess bit is false (0) 1742, the SFNode has the “list Node” structure 1730. In this case, as shown in FIG. 17C, the MaskAccess bit 1742 is followed by one or more field reference records. Each field reference record starts with a one-bit end flag 1744, 1750. If the end flag is false (0) 1744, the end flag 1744 is followed by a field reference index number (fieldRef) 1746 for a property field defined for the local node type 1734, and the fieldRef value 1746 is followed by a binary field value 1748 encoded according to a field data type (integer, boolean, string, node, etc.) determined by the local node type 1734 and the property field indicated by the fieldRef value 1746. The number of bits used to encode the fieldRef value 1746 is determined by tables defined in the MPEG-4 Systems specifications. If the end flag is true (1) 1750, the list of field values terminates.

Each property field value included within an SFNode structure may consist of a single data value (SFField data structure) or multiple data values (MFField data structure). Each MFField data structure contains zero or more SFField components. As shown in FIG. 17D and FIG. 17E, there are two forms of MFField structures, the list form 1760 and the vector form 1780, based on the value of the isList bit 1766, 1786. Both forms start with a one-bit reserved bit 1762, 1782 followed by the isList bit 1766, 1786.

If the isList bit has the value (1) 1766, the MFField data structure has the list form 1760. In this case, the isList bit 1766 is followed by a sequence of one-bit endFlag values 1770, 1772. If the value of the endFlag bit is “0” 1770, the endFlag bit is followed by an SFField data structure 1774. If the value of the endFlag bit is “1” 1772, the MFField data structure ends.

If the isList bit has the value (0) 1786, the MFField data structure has the vector form 1780. In this case, the isList bit 1786 is followed by a 5-bit field (nBits) 1790 which specifies the number of bits in the following field count value (nFields) 1792. This is followed by a sequence of nFields SFField structures 1796.

The structure of each SFField value depends on the particular field data type associated with the corresponding property field, as indicated by tables specified in the MPEG-4 Systems specifications. A boolean field, for example, consists of a single bit. Other cases including integers, floats, strings, SFNode, are defined and described in the MPEG-4 Systems specifications.

The last component of a BIFS Scene data structure 1600 is an optional Routes data structure 1660. As shown in FIGS. 18A and 18B, there are two forms of the Routes data structure, the list form 1800 and the vector form 1830. Both forms of the Routes data structure start with a one-bit list flag 1805, 1835. If the value of the list flag is true (1) 1805, the Routes data structure has the list form 1800. In this case, the list bit 1805 is followed by one or more Route data structures 1810, and each Route data structure 1810 is followed a one-bit moreRoutes flag 1810, 1820. If the value of the moreRoutes flag is true (1) 1810, another Route data structure 1810 follows. If the value of the moreRoutes flag is false (0) 1820, the Routes data structure 1800 ends.

If the value of the list flag in a Routes data structure is false (0) 1835, the Routes data structure has the vector form 1830. In this case, the list bit 1835 is followed by a five-bit nBits field 1840. The unsigned integer value contained in the nBits field specifies the number of bits used to encode the following numRoutes value 1845. The unsigned integer encoded in the numRoutes value 1845 specified the number of Route data structures 1850 which follow the numRoutes value 1845.

As shown in FIG. 18C, a Route data structure 1860 consists of a one-bit flag (isUpdateable) 1865, an outNodeID value 1880, an outFieldRef value 1885, an inNodeID value 1890, and an inFieldRef value 1895. If the value of the isUpdateable flag 1865 is true (1), then the isUpdateable flag 1865 is followed by a routeID value 1870. If the value of the isUpdateable flag 1865 is true (1), and the value of the USENAMES flag 1620 in the corresponding BIFS Scene data structure 1600 is also true (1), the routeID value 1870 is followed by a null-terminated string (routeName) 1875. The numbers of bits used to encode the outNodeID value, inNodeID value, and the routeID value are specified in the decoder specific information 1072 for the sdsm stream. The numbers of bits used to encode the outFieldRef and inFieldRef are determined by tables defined in the MPEG-4 Systems specifications.

### 4.0 Object Descriptor Stream (odsm)

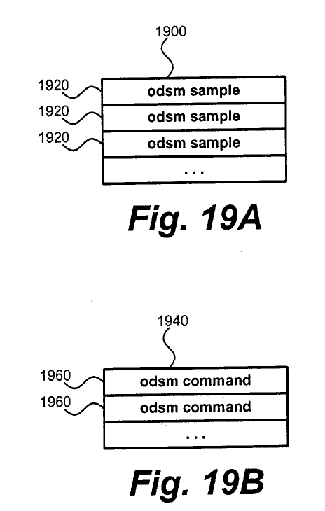

Like any other MPEG-4 elementary stream, the odsm (object descriptor stream) is contained in a sequence of one or more chunks 736. As shown in FIG. 19, each odsm chunk 1900 is composed of a sequence of odsm samples 1920, and each odsm sample 1940, is composed on a sequence of odsm commands 1960. The number of odsm samples 1920 in each odsm chunk 1900 are determined by the contents of the sample-to-chunk table atom (stsc) 960 in the trak atom 790, 900 for the object descriptor stream. The number of odsm commands 1960 in each odsm sample 1940 are determined by the sample size table atom (stsz) 970 in the trak atom 790, 900 for the object descriptor stream.

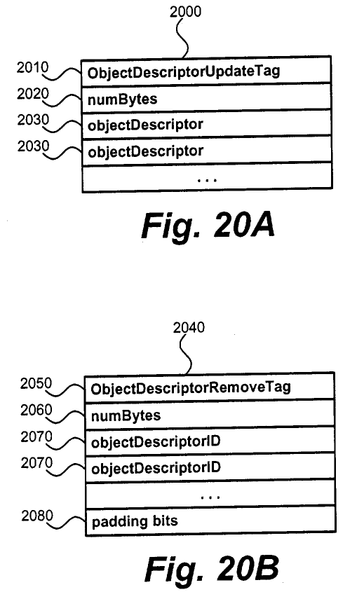

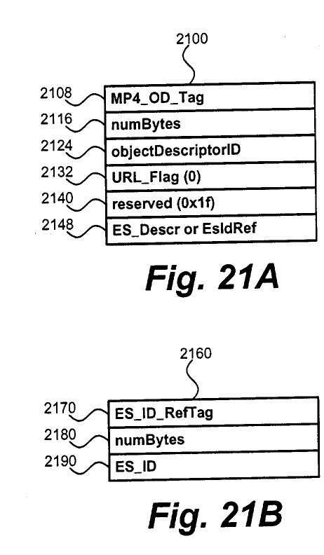

There are two possible odsm commands, the ObjectDescriptorUpdate command, and the ObjectDescriptorRemove command. As shown in FIG. 20A, the ObjectDescriptorUpdate command 2000 consists of a one-byte ObjectDescriptorUpdateTag 2010, an indication of the number of bytes in the remainder of the command (numBytes) 2020, and a sequence of ObjectDescriptors 2030. The structure of an ObjectDescriptor is summarized in FIG. 21. As shown in FIG. 20B, the ObjectDescriptorRemove command 2040 consists of a one-byte ObjectDescriptorRemoveTag 2050, an indication of the number of bytes in the remainder of the command (numBytes) 2060, a sequence of objectDescriptorId values 2070, and 2 to 6 padding bits 2080.

Each numBytes value 2020, 2060 specifies the number of bytes in the remainder of an odsm command. If the value of numBytes is less than 128, this value is encoded in a single byte. Otherwise, the value of numBytes is encoded in a sequence of size bytes. The high order bit in each size byte indicates whether another size byte is to follow. If this high order bit is a “1”, then another size byte follows. The remaining seven bits in each size byte specify seven bits of the resulting unsigned integer value of numBytes.

Each objectDescriptorId value 2070 is encoded in 10 bits and the sequence of 10-bit objectDesciptorId values found in an ObjectDescriptorRemove command 2040 is packed into a sequence of bytes. If the number of objectDescriptorId values is not a multiple of 4, two, four or six null bits 2080 follow the last objectDescriptorId value to fill the last byte in this command.

As shown in FIG. 21A, an ObjectDescriptor 2100 within an ObjectDescriptorUpdate command 2000 consists of a one-byte MP4_OD_Tag 2108 followed by a numBytes value 2116, a ten-bit ObjectDescriptorID value 2124, a one-bit URL_Flag value 2132, a five-bit reserved field (Ox1f) 2140, and either an ES_Descr data structure or an EsIdRef data structure 2148. In this form of the ObjectDescriptor, the value of the URL_Flag 2132 is always false (0). The numBytes value 2116 specifies the number of bytes comprising the remainder of the object descriptor, and this is encoded in the same manner specified for the numBytes value 2020, 2060 found in an ObjectDescriptorUpdate command 2000 or an ObjectDescriptorRemove command 2040.

The structure of an ES_Descr data structure 1000 is shown in FIG. 10A. As shown in FIG. 21B, an EsIdRef data structure 2160 consists of a one-byte ES_ID_RefTag 2170, a numBytes value 2180, and a 16-bit elementary stream ID (ES_ID) value 2190. In this case, the value of numBytes is always “2”, and this value is specified as an 8-bit integer.

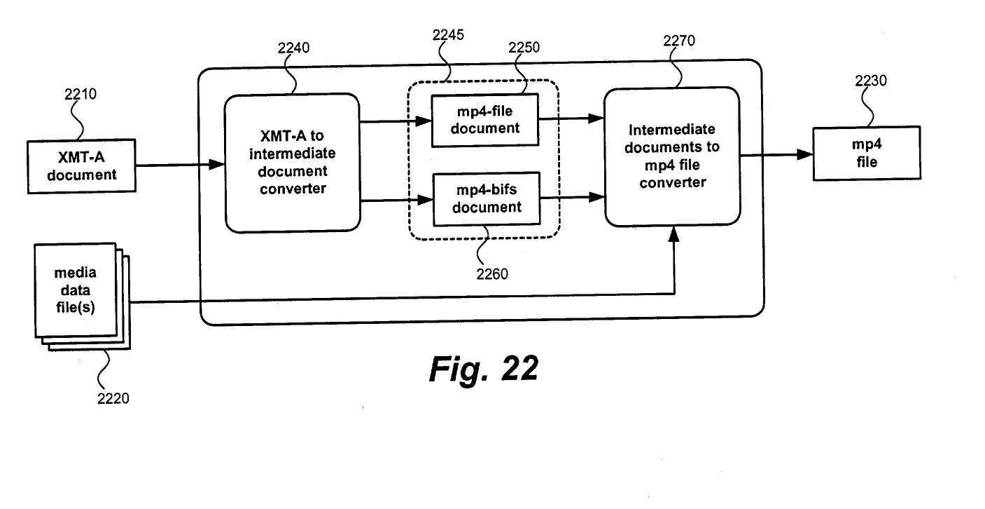

The operation of the present invention is shown generally in FIG. 22. The invention 2200 creates an MPEG-4 Intermedia file 2230 based on the contents of an XMT-A document 2210 and associated media data files 2220. The output MPEG-4 Intermedia file 2230 may also be referred to as an “mp4 binary file” or an “mp4 file”. The input XMT-A document 2210 may consist of a text file based on the XMT-A specifications found in ISO/IEC 14496-1:2000 Amd.2, or a set of data structures representative of such a file. The associated media data files 2220 represent audio, video, and image data identified by StreamSource references 696 contained in the XMT-A document 2210. The number of media data files 2220 may be zero or more.

The logical operations performed by the invention 2200 may be implemented (1) as a sequence of computer implemented steps running on a computer system and/or (2) as interconnected machine modules within the computing system. The implementation is a matter of choice dependent on the performance requirements of the system applying the invention. Accordingly, the logical operations making up the embodiments of the present invention described herein are referred to alternatively as operations, steps, or modules.

Furthermore, the operations performed by the present invention can be a computer readable program embodied as computer readable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As shown in FIG. 22, the process of creating the mp4 file 2230 is accomplished in two steps. In the first step, an XMT-A to intermediate documents converter 2240 interprets an input XMT-A document 2210 and creates one or more intermediate documents 2245 representing the MPEG-4 Intermedia file 2230. In one embodiment of the invention, a pair of intermediate documents 2250 and 2260 are created by the intermediate documents converter 2240. The intermediate documents consist of an mp4-file document 2250 and an mp4-bifs document 2260. In the second step, an intermediate documents to mp4 file converter 2270 generates the output mp4 file 2230 based on the mp4-file document 2260, the mp4-bifs document 2260 and the media data files 2220 (if any) associated with the XMT-A document 2210.

One reason for dividing this process 2200 into these two steps is that, while the output mp4 file 2230 represents the same information represented by the input XMT-A document 2210 and media data files 2220, the organization and structure of the output mp4 file 2230 differs greatly from the organization and structure of the input XMT-A document. For example, the structure of an mp4 file is closely related to the structure of a Quicktime (r) media data file, but the structure of an XMT-A file has none of the characteristics of a Quicktime (r) media data file. An XMT-A document contains descriptions of a scene description stream (sdsm) and an object descriptor stream (odsm), but these can be mixed together in any order. An mp4 file also contains descriptions of the sdsm and odsm, but each of these is represented as a separate stream of temporally ordered samples.

Because the structure and organization of an mp4 file 2230 differs so much from the structure and organization of an XMT-A document 2210, it is advantageous to divide the process of creating an mp4 file 2230 based on an XMT-A document 2210 into at least two steps: (a) reorganization, and (b) binary encoding. In the first step, the information contained in the XMT-A document 2210 is reorganized into a form which reflects the structure and organization of an mp4 file. In the second step, an output mp4 file 2230 is created by traversing the resulting reorganized information in the order required for the output mp4 file 2230 while performing a binary encoding of this information. In this way, the first step can be performed without regard to the requirements for the binary encoding of an mp4 file, and the second step can be performed without regard to the structure of an XMT-A document.

In order to accomplish the objective of dividing the process of creating an mp4 file 2230 based on an XMT-A document 2210 into these two steps, it is necessary to define new structured documents representing (a) the structure and organization of the mp4 file, (b) the structure and organization of the stream description stream (sdsm) as represented in the mp4 file, and (c) the structure and organization of the object descriptor stream (odsm) as represented in the mp4 file 2230. This may be accomplished be defining three new types of structured documents, one representing the mp4 file, one representing the sdsm, and one representing the odsm. Of these, the structured documents required to represent the mp4 file and the sdsm are relatively complex, but the structured document required to represent the odsm is very simple. Consequently, it is convenient to incorporate the description of the odsm into the structured document employed to represent the mp4 file. Consequently, in one embodiment of this invention, two new structured documents are introduced, one for the mp4 file and odsm, and one for the sdsm. These two structured documents are identified as the mp4-file document 2250 and the mp4-bifs document 2260. These structured documents are referred to collectively as the intermediate documents.

It should be noticed that the use of two types of structured documents has been chosen as a matter of convenience. The same objectives could have been achieved by defining three types of structured documents (mp4-file only, odsm only, and sdsm only), or all three types of information could be consolidated into a single composite structured document.

In one embodiment of the present invention, the particular types of structured documents created to represent the reorganized information are based on the “XML” (eXtensible Markup Language) technology. This is advantageous because:

(a) the definition of an XMT-A document is based on XML technology,

(b) XML technology provides a standardized means of representing structured documents, and

(c) standardized software tools exist for working with structured documents based on XML technology.

Thus, in one embodiment of the invention, the process of reorganizing the information contained in the XMT-A file is reduced to an XML-to-XML transformation. In addition, the existence of standardized software for working with XML files makes it possible to manage the input XMT-A documents as well as the intermediate documents without the need to develop new specialized software to perform the same functions.

Although this embodiment is based on the use of XML technology to represent the intermediate documents, it is possible to create alternative embodiments of this invention that employ other types of structured documents.

The following material describes (1) the structure of an mp4-file document 2250, (2) the structure of an mp4-bifs document 2260, (3) the operation of the XMT-A to intermediate documents converter 2240, and (4) the operation of the intermediate documents to mp4 file converter 2270.

### 5.0 mp4-file Document

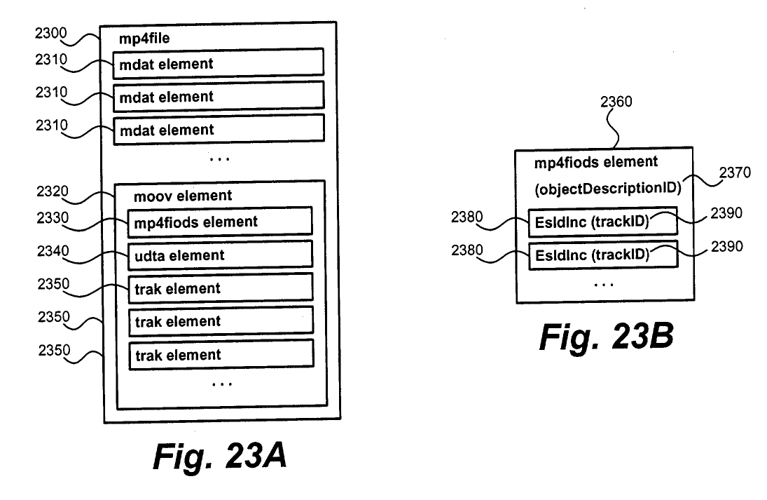

As shown in FIG. 23A, the structure of an mp4-file document 2300 is very similar to the structure of an mp4 binary file 700. An mp4file document 2300 contains a set of one or more media data (mdat) elements 2310 and a single moov element 2320. The moov element 2320 includes an mp4fiods (mp4 file initial object descriptor) element 2330 and one or more trak elements 2350. A moov element 2320 may also include an optional user data (udta) element 2340. The udta element 2340 may be used to include information such as a copyright notice. The properties of the mvhd atom 772 are represented by attributes of the moov element 2320.

As shown in FIG. 23B, an mp4fiods element 2360 possesses an objectDescriptorID attribute 2370. An mp4fiods element 2360 also possesses several other attributes not shown in FIG. 23B. These additional attributes include the boolean attribute “includeInlineProfilesFlag”, and integer attributes “sceneProfileLevelIndication”, “ODProfileLevelIndication”, “audioProfileLevelIndication”, “visualProfileLevelIndication”, and “graphicsProfileLevelIndication”. An mp4fiods element 2360 also includes one or more EsIdInc elements 2380. Each EsIdInc element 2380 possesses a trackID attribute 2390 which matches the trackId attribute of the related trak element 2340.

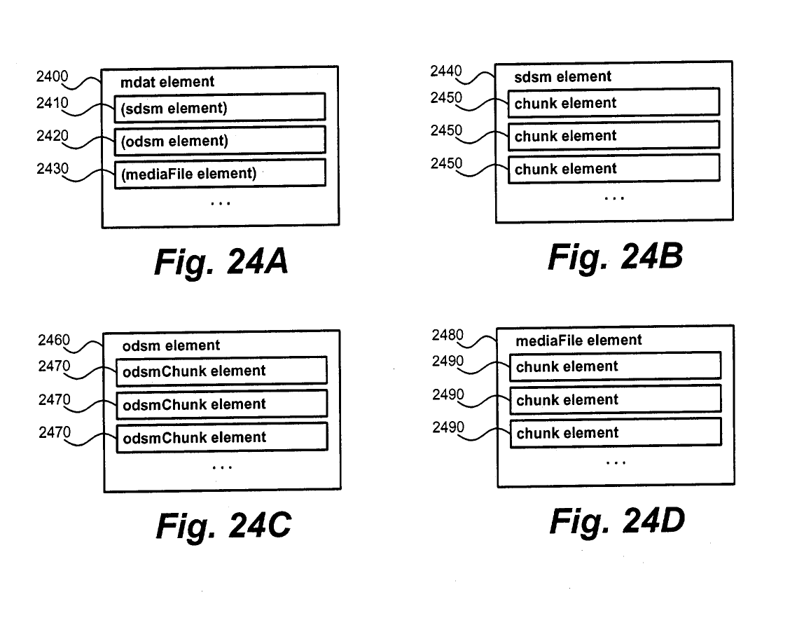

As shown in FIG. 24A, each mdat element 240 may contain one or more of the following elements: sdsm elements 2410, odsm elements 2420, and mediaFile elements 2430. Each of these elements possesses a unique “trackID” attribute which matches the trackID attribute of the related trak element 2340. Each mediaFile element 2430 has a “name” attribute which specifies the file name for an external binary file which contains the associated media data (audio data, visual data, etc.). Each sdsm element 2410 has an “xmlFile” attribute specifying the name of an XML file representing the associated mp4-bifs document 2260. In one embodiment, creation of XML files representing an mp4-file document and/or an mp4-bifs document may be useful for diagnostic purposes, but such files are not required for the operation of the invention.

As shown in FIGS. 24B and 24D, each sdsm element 2440 and each mediaFile element 280 contains one or more chunk elements 2450, 2490. Each chunk element 2450, 2490 possesses a “size” attribute indicating the number of bytes in the associated block of binary data, if known. Each chunk element 2450, 2490 also possesses an “offset” attribute indicating the number of bytes between the start of the binary sdsm data or media data file and the start of the data for the current chunk within the binary sdsm data or media data file, if known. Additional information describing the scene description stream (sdsm) is contained within the mp4-bifs document.

As shown in FIG. 24C, each odsm element 2460 contains one or more odsmChunk 2470 elements. Each odsmChunk element 2470 possesses a “size” attribute indicating the number of bytes in the associated portion of the object descriptor stream, if known. Each odsmChunk element 2470 also possesses an “offset” attribute indicating the number of bytes between the start of the binary data for the associated object descriptor stream and the start of the data for the current chunk within that stream, if known.

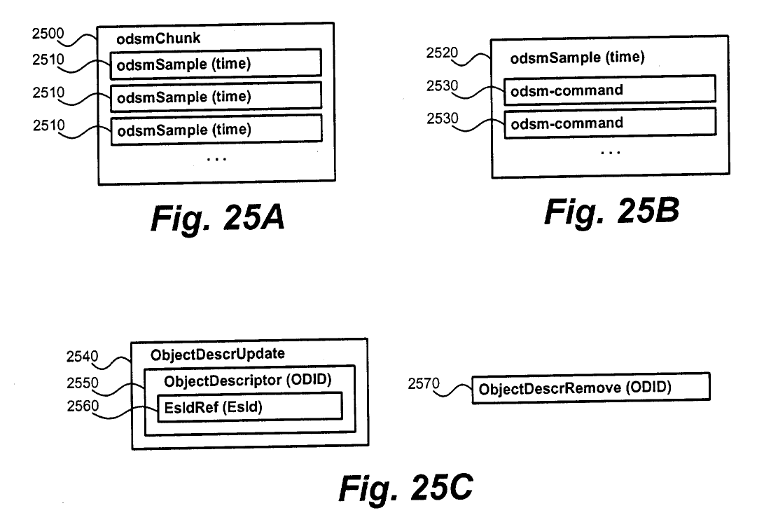

As shown in FIG. 25A, each odsmChunk element 2500 contains one or more odsmSample elements 2510. As shown in FIG. 25B, each odsmSample element 2520 contains one or more odsm-command elements 2530. As shown in FIG. 25C, each odsm-command element may be an ObjectDescrUpdate element 2540 or an ObjectDescrRemove element 2570. Each ObjectDescrUpdate element 2540 contains an ObjectDescriptor element 2550, and the ObjectDescriptor element 2550 contained within an ObjectDescrUpdate element 2540 contains an EsIdRef element 2560.

Each odsmSample element 2510, 2520 possesses a “time” attribute which specifies the time in seconds when the commands contained within the odsmSample element 2510, 2520 are to be executed. Each ObjectDescriptor element 2550 and each ObjectDescrRemove element 2570 possesses an “ODID” attribute which specifies a numerical object descriptor ID. Each EsIdRef element 2560 possesses an “EsId” attribute which specifies a numerical elementary stream ID.

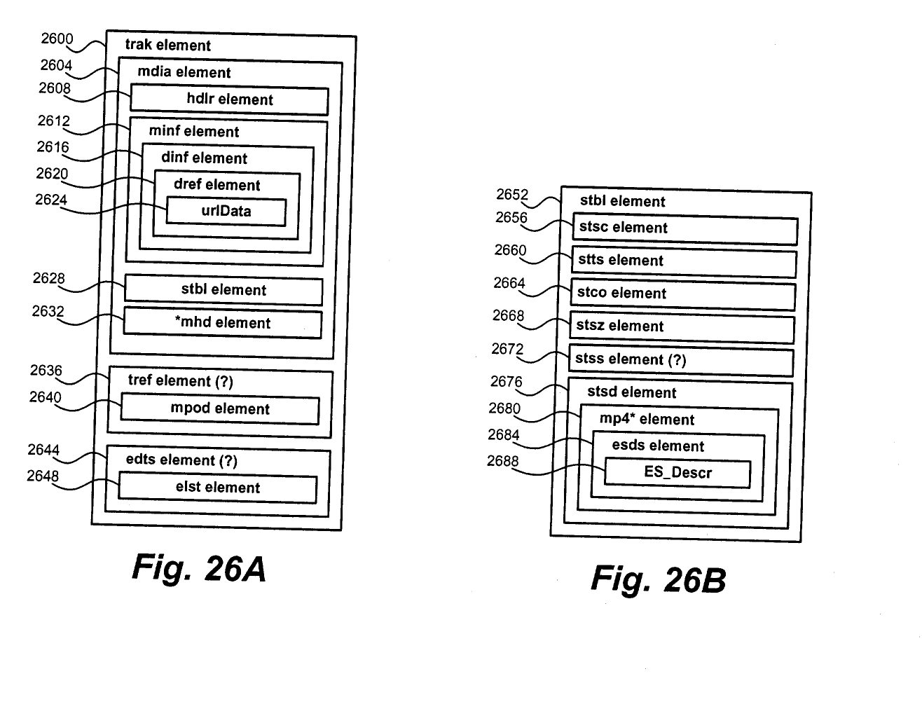

The structure of a trak element 2350, 2600, as shown in FIG. 26A, is very similar to that of a trak atom 790, 900 within an mp4 file 700. Each trak element 2600 contains an mdia element 2604. A trak element 2600 may also contain a tref (track reference) element 2636 and/or an edts (edit list) element 2644. There is no tkhd element analogous to the tkhd atom 910 in an mp4 file. Instead, the properties contained within a tkhd atom 910 are represented as the attributes of a trak element 2600.

An mdia element 2604 contains an hdlr element 2608 and an minf element 2612. The properties of an mdhd atom 915 are represented as the attributes of a mdia element 2604. The minf element 2612 contains a dinf element 2616, an stbl element 2628, and a media header element 2632. The media header element (“*mhd”) 2632 may have one of several forms depending on the type of data in the associated data stream. The media header element 2632 within a trak element associated with the sdsm or odsm is represented by an “nmhd” element. The media header element 2632 within a trak element associated with an audio stream is represented by an “smhd” element, and the media header element 2632 within a trak element associated with a visual stream is represented by a “vmhd” element.

As shown in FIG. 26B, an stbl (sample tables) element 2628, 2652 contains an stsc (sample-to-chunk table) element 2656, an stts (time-to-sample table) element 2660, an stco (chunk offset table) element 2664, an stsz (sample size table) element 2668, and an stsd (sample description table) element 2676. An stbl element 2664 may also include an stss (sync sample table) element 2672 depending on the stream or media type. An stsd element 2676 may contain one of several types of subordinate elements represented as “mp4* element” 2680 in FIG. 26B. In the case of an stsd element 2676 contained within a trak element 2600 associated with an sdsm or odsm stream, the stsd element 2680 contains an “mp4s” element. In the case of an stsd element 2680 contained within a trak element 2600 associated with an audio stream, the stsd element 2680 contains an “mp4a” element. In the case of an stsd element 2680 contained within a trak element 2600 associated with a visual stream, the stsd element 2680 contains an “mp4v” element. In each case, the “mp4*” element 2680 contains an esds element 2684, and the esds element 2684 contains an ES_Descr element 2688.

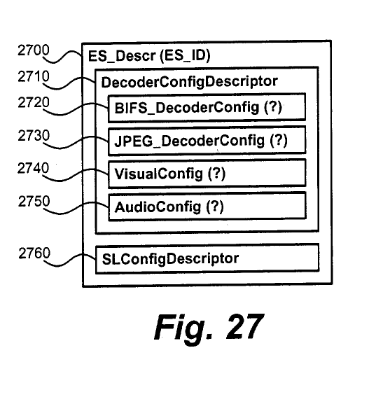

As shown in FIG. 27, an ES_Descr element 2700 contains a DecoderConfigDescriptor element 2710 and an SLConfigDescriptor element 2760. The DecoderConfigDescriptor element 2710 may contain one of several types of decoder specific information elements including a BIFS_DecoderConfig element 2720, JPEG_DecoderConfig 2730, VisualConfig 2740, or AudioConfig 2750. Each of the various types of decoder specific information elements represents a form of the DecoderSpecificInfo data structure 1072 contained within a binary DecoderConfigDescriptor structure 1032. The properties of the binary ES_Descr structure 1000, DecoderConfigDescriptor structure 1032, SLConfigDescriptor structure 1088, and DecoderSpecificInfo structure 1076, are represented by attributes of the corresponding elements 2700, 2710, 2760, 2720, 2730, 2740, 2750 of the mp4-file document 2300.

### 6.0 mp4-bifs Document

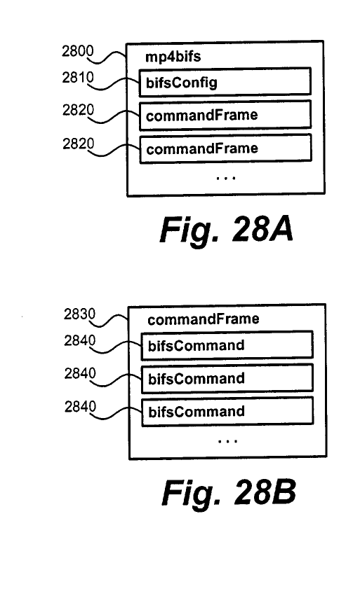

As shown in FIG. 28A, an mp4-bifs document 2800 contains a single bifsConfig element 2810 followed by a sequence of one or more commandFrame elements 2820. As shown in FIG. 28B, each commandFrame element 2830 contains one of more mp4bifs bifsCommand elements 2840. Each commandFrame element 2820, 2830 possesses an attribute “time” which specifies the time in seconds when the commands contained within the commandFrame element are to be executed.

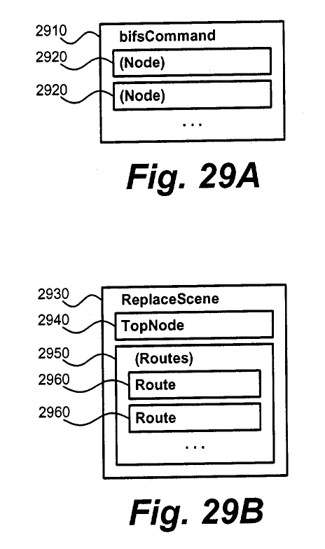

Each mp4bifs bifsCommand element 2840 represents one of eleven possible MPEG-4 BIFS commands: InsertNode, InsertIndexedValue, InsertRoute, DeleteNode, DeleteIndexedValue, DeleteRoute, ReplaceNode, ReplaceField, ReplaceIndexedValue, ReplaceRoute, and ReplaceScene. As shown in FIG. 29A, an mp4bifs bifsCommand element 2910 may contain one or more mp4bifs Node elements 2920. Of the eleven types of bifsCommand elements, InsertNode, InsertIndexedValue, ReplaceNode, ReplaceField, ReplaceIndexedValue, and ReplaceScene may include subordinate mp4bifs Node elements 2920.

As shown in FIG. 29B, a ReplaceScene bifsCommand element 2930 may include only a single subordinate mp4bifs Node element and this must be a “TopNode” element 2940. A TopNode element 2940 corresponds to a member of a particular subset of MPEG-4 BIFS nodes. This subset is defined in the MPEG-4 Systems specifications. In addition, a ReplaceScene bifsCommand element 2930 may also include a subordinate “Routes” element 2950, and the “Routes” element 2950 may contain one or more subordinate “Route” elements 2960. An mp4bifs Route element 2960 has the attributes “routeId”, “arrivalNodeId”, “arrivalField”, “departureNodeId”, and “departureField”.

In addition to possible subordinate mp4bifs Node elements, each type of mp4bifs bifsCommand element possesses the following attribute values:

1. InsertNode: “parentId”, “insertionPosition”, and “position”

2. InsertIndexedValue: “nodeId”, “inFieldName”, “insertionPosition”, “position”, and “value”

3. InsertRoute: “RouteId”, “departureNode”, “departureField”, “arrivalNode”, and “arrivalField”

4. DeleteNode: “nodeId”

5. DeleteIndexedValue: “nodeId”, “inFieldName”, “deletionPosition”, and “position”

6. DeleteRoute: “routeId”

7. ReplaceNode: “parentId”

8. ReplaceField: “nodeId”, “inFieldName”, and “value”

9. ReplaceIndexedValue: “nodeId”, “inFieldName”, “insertionPosition”, “position”, and “value”

10. ReplaceRoute: “routeId”, “departureNode”, “departureField”, “arrivalNode”, and “arrivalField”

11. ReplaceScene: “USENAMES” (a boolean value)

For the bifsCommand elements InsertIndexedValue, ReplaceField, and ReplaceIndexedValue, if the property field specified by the “inFieldName” attribute has a node data type of “Node” (per MPEG-4 specifications), then this element will contain one or more subordinate mp4bifs Node elements 2920 and the “value” attribute will contain a list of the node names associated with each of the subordinate Node elements.

An mp4bifs Node element 2920 represents one of the many types of MPEG-4 BIFS node data structures. Over 100 different types of BIFS nodes are defined in the MPEG-4 systems specifications. Each type of MPEG-4 BIFS node has a particular NodeName and a set of property fields.

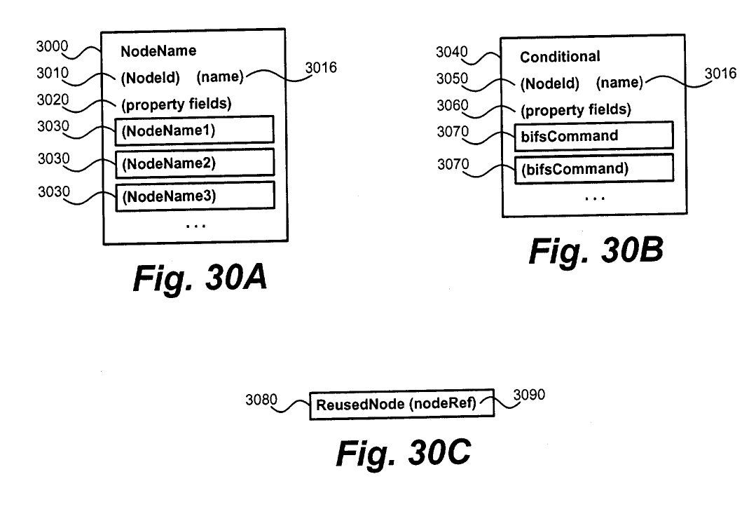

There are two basic types of mp4bifs Node elements: original Node elements and reused Node elements. As shown in FIG. 30A, an mp4bifs original Node element 3000 is identified by a “NodeName” corresponding to the NodeName property of one of the BIFS nodes defined in the MPEG-4 Systems Specifications.

An mp4bifs original Node element 3000 may have an optional NodeId attribute 3010. If a value is specified for the NodeId attribute 3010, the Node element 3000 is classified as a “reusable Node”. The value of the NodeId attribute 3010, if specified, is an integer in the range of 1 to the number of reusable Nodes defined in the current scene. If a value has been specified for the NodeId attribute 3010, and the value of the “USENAMES” attribute of the associated ReplaceScene command is “true”,then the Node element will also have a “name” attribute 3016.

In addition to the NodeId 3010 and name 3016 attributes, each original Node element has a number of property field attributes 3020. Each property field attribute 3020 corresponds to one of the property fields defined in the MPEG-4 Systems Specifications for the node type identified by the NodeName for a particular Node element. Each property field has a defined field data type, such as boolean, integer, float, etc. The set of possible field data types includes “SFNode” and “MFNode”. If the NodeName for a particular original Node element corresponds to an MPEG-4 BIFS node with a property field or fields with field data type “SFNode” and “MFNode”,then the Node element may possess one or more subordinate Node elements 3030. If so, the value of the corresponding property field attribute consists of the NodeName strings for each subordinate Node element associated with the property field.

If, for example, a particular mp4bifs Node element with NodeName “Group” possesses a subordinate mp4bifs Node elements with NodeNames of “Transform2D”, “Valuator”, and “TimeSensor” associated with the “children” attribute, then the value of the “children” attribute would be “Transform2D Valuator TimeSensor”.

In the special case of a Conditional BIFS node, one of the property fields has the property field name “buffer”,the field data type for the “buffer” property field is “command buffer”, and the value of the “buffer” property field consists of one or more BIFS commands. In this case, the NodeName of the corresponding mp4bifs Node element 3040 is “Conditional”. The values of the NodeId attribute 3050 and name attribute 3056 for a Conditional Node element 3040 may be specified as for any other mp4bifs original Node element 3000. Instead of subordinate Node elements 3030, the Conditional Node element possesses one or more subordinate bifsCommand elements 3070, and the value of the “buffer” attribute consists of an ordered list of the command names of the subordinate bifsCommand elements 3070.

If, for example, a particular Conditional Node element possesses a subordinate InsertRoute bifsCommand element followed by a subordinate DeleteNode bifsCommand elements, then the value of the “buffer” attribute would be “InsertRoute DeleteNode”.

The ability of an original Node element to possess subordinate Node elements or bifsCommand elements may be repeated recursively to a hierarchical collection of BIFS command and Node elements.

As shown in FIG. 30C, a reused Node element 3080 has a NodeName of “ReusedNode”. A ReusedNode element 3080 has no subordinate elements. A ReusedNode element 3080 has a single attribute named “nodeRef” 3090. The value of the nodeRef attribute 3090 must match the value of the NodeId attribute 3010, 3050 for one of the reusable original Node elements 3000, 3040.

### 7.0 xmta to mp4 Converter

As mentioned above, one embodiment of the present invention creates an MPEG-4 Intermedia binary file (“mp4 file”) 2230 based on an XMT-A document 2210 and a set of zero or more binary media data files 2220.

This process consists of two major steps:

a. A first step 2240 in which a pair of intermediate documents 2250, 2260 are created based on an XMT-A document 2210, and

b. A second step 2270 in which an MPEG-4 Intermedia binary file 2230 is created based on the intermediate documents 2250, 2260 and any binary media data files 2220 specified in the XMT-A document 2210.

The media data files 2220 are used only in the second step. The first step 2240 may use the names of media data files, but the media data files themselves are not used in the first step 2240.

These major steps are shown in FIG. 22 and are described in detail below.

### 7.1 Creation of Intermediate Documents Based on XMT-A Document

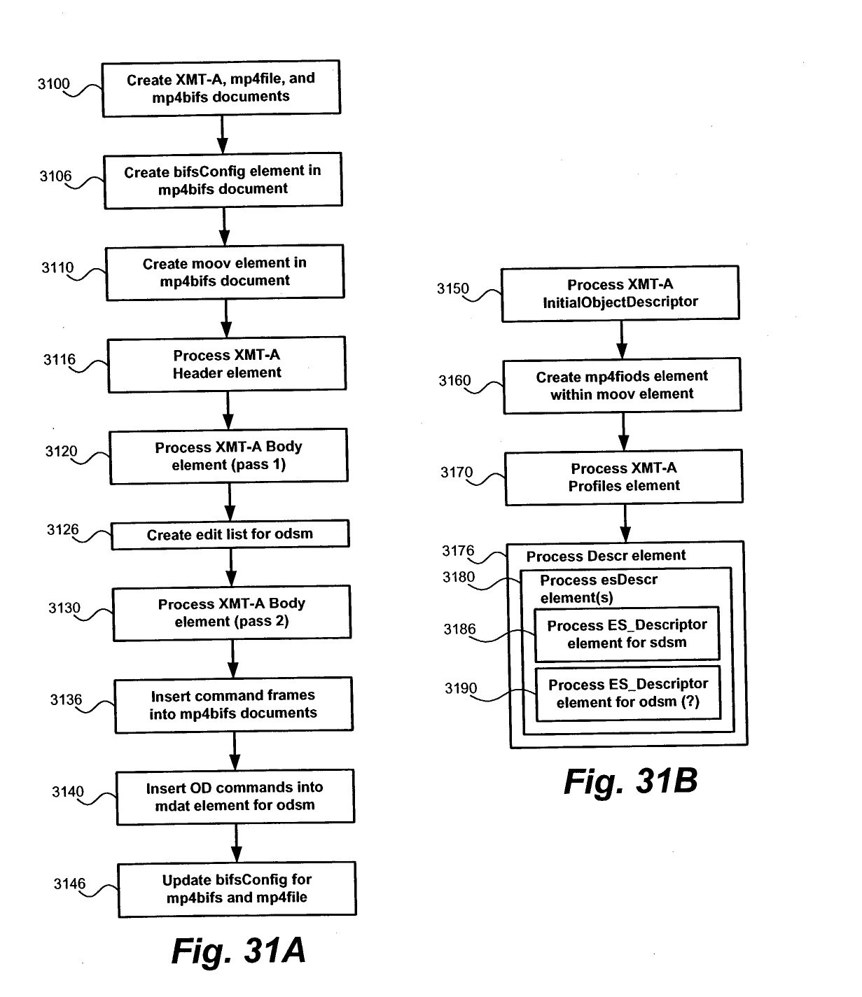

The process 2240 of creating the intermediate documents 2250, 2260 is summarized in FIG. 31A. It is contemplated that the process 2240 can be implemented in hardware, software, or a combination of the two to meet the needs of a particular application. Hardware implementations tend to operate faster while software implementations are often less expensive to produce. The logical operations performed by the process 2240 may be implemented (1) as a sequence of computer implemented steps running on a computer system and/or (2) as interconnected machine modules within the computing system. The implementation is a matter of choice dependent on the performance requirements of the system applying the invention. Accordingly, the logical operations making up the embodiments of the present invention described herein are referred to alternatively as operations, steps, or modules.

### 7.1.1 Create XMT-A, mp4file, and mp4bifs Documents

The process 2240 begins at operation 3100. The XMT-A document 100 may be created by reading and interpreting an XML file representing this document. Standard XML means may be used to read such a file and produce an XMT-A document representing all of the information contained in the XML file. This is a standard XML operation and is not special to this invention. Alternatively, an XMT-A document previously derived from other means, such as an XMTA-based MPEG-4 authoring tool, may be provided as an argument to software or other means implementing the following steps.

An empty mp4file document 2300 and an empty mp4bifs document 2800 are created using standard XML means. Each of these documents contains a top level element with no children and no attributes other than possible default attributes. A value may be assigned to the string quantity “sdsmFileName”. This value is only used when the intermediate documents are to be saved to external text files. A suitable value may be derived from the name of the input XMT-A document, if any. Otherwise, the value “mp4bifs.xml” may be assigned to the quantity “sdsmFileName”. After operation 3100 is completed, control flow passes to operation 3106.

### 7.1.2 Create New “bifsConfig” Element for mp4bifs Document

At operation 3106, a new “bifsConfig” element is created for the mp4bifs document. Standard XML means are used to create an empty “bifsConfig” element 2810 and insert it into the top level element for the mp4bifs document 2800. Standard XML means are used to assign values to the following attributes of this “bifsConfig” element. A value of “0” is assigned to the “nodeIdBits” attribute. A value of “0” is assigned to the “routeIdBits” attribute. A value of “0” is assigned to the “protoIdBits” attribute. A value of “true” is assigned to the “commandStream” attribute. A value of “true” is assigned to the “pixelMetric” attribute. A value of “0” is assigned to the “pixelHeight” attribute. A value of “0” is assigned to the “pixelWidth” attribute. A value of “false” is assigned to the “useBifsV2Config” attribute. A value of “false” is assigned to the “use3DMeshCoding” attribute. A value of “false” is assigned to the “usePredictiveMFField” attribute. These are merely temporary values which will be replaced later by values derived from the XMT-A document. After operation 3106 is completed, control flow passes to operation 3110.

### 7.1.3 Create New “moov” Element for mp4file Document

At operation 3110, a new “moov” element is created for the mp4file document. Standard XML means are used to create an empty “moov” element 2320 and insert it into the top level element for the mp4file document 2300. The value “1” is assigned to the quantity “nextTrackID” and the quantity “nextEsId”. Standard XML means are used to assign values to the following attributes of this “moov” element:

a. “creationTime” and “modificationTime”: The values of these attributes should specify the number of seconds elapsed since Jan. 1, 1904, represented as an unsigned integer. Preferably, these values should be determined by the current clock time. If the current clock time is not available, these can be set to any arbitrary values. The actual values specified here are merely informative and have no effect on the processing of the resulting MPEG-4 binary file.

b. “timeScale”: This attribute specifies the number of clock ticks per second to be used to measure time within the MPEG-4 binary file. A value of 1000 implies times will be specified in milliseconds.

c. “duration”: The value zero is assigned to this attribute. This value will be updated later.

d. “nextTrackID”: The value of the quantity “nextTrackID” is assigned to this attribute. The value of this attribute will be updated later as each new “trak” element is added to the document and the value of the quantity “nextTrackID” is increased.

At this point it is possible to add an optional “udta” (user data) element 2340. This can be used to insert a copyright message into the MPEG-4 binary file created in the subsequent major step 2270. Other information, such as author identification, etc. could also be specified at this time. After operation 3110 is completed, control flow passes operation 3116.

### 7.1.4 Process XMT-A “Header” Element

At operation 3116, the XMT-A Header is processed. This step creates an “mp4fiods” element 2330, 2360 within the “moov” element 2320. An “mdat” element 2310 and a “trak” element 2350 will be created for the scene description stream (sdsm). If any objects are present, another “mdat” element 2310 and another “trak” element 2350 will be created for the object descriptor stream (odsm).

Standard XML means may be used to obtain the “Header” element 110 in the XMT-A document 100. The steps indicated in FIG. 31B are then used to process the XMT-A “Header” element. The XMT-A “Header” processing sub-operations begin with InitialObjectDescriptor processing operation 3150.

At operation 3150, standard XML means may then be used to obtain the XMT-A “InitialObjectDescriptor” element 130 subordinate to the XMT-A “Header” element 110. The “InitialObjectDescriptor” element 130 may have an attribute named “objectDescriptorID” with a value having the form “IODID:nnn” where substring “nnn” represents a positive integer. Alternatively, this element may have an attribute named “binaryID” with value “nnn”. In either case, the value represented by “nnn” is assigned to a quantity “ODID”. If neither of these attributes is present, a value “1” is assigned to the quantity “ODID”. After operation 3150 is completed, control flow passes to operation 3160.

At operation 3160, a new “mp4fiods” element 2330, 2360 is created and inserted into the “moov” element 2320 in the mp4file document 2300. The value of the quantity “ODID” derived from the “InitialObjectDescriptor” element 130 in the XMT-A document 100 is then assigned to the “objectDescriptorID” attribute 2370 of the “mp4fiods” element 2330, 2360. After operation 3160 is completed, control flow passes to operation 3170.

At operation 3170, standard XML means are used to obtain the “Profiles” element 150 subordinate to the “InitialObjectDescriptor” element 130. Values for the “includeInlineProfiles”, “sceneProfileLevelIndication”, “ODProfileLevelIndication”, “audioProfileLevelIndication”, “visualProfileLevelIndication”, and “graphicsProfileLevelIndication” attributes of the mp4fiods element 2360 are then set based on the values of like-named attributes of the “Profiles” element 150.

The value of the “includeInlineProfiles” attribute of the “mp4fiods” element 2360 must be “true” or “false”. If the value for the “includeInlineProfiles” attribute in the “Profiles” element 150 is “true” or “false”,the same value is assigned to the “includeInlineProfiles” attribute of the “mp4fiods” element 2360. Otherwise, the value “false” is assigned to the “includeInlineProfiles” attribute of the “mp4fiods” element 2360.

The values of the five profile and level indication attributes of the “mp4fiods” element 2360 must represent numerical values from −255 to +255. The corresponding attributes of the “Profiles” element 150 may have equivalent values, or they may have values specified by alphanumeric strings. If any of the profile and level indication attributes of the “Profiles” element 150 has the string value “none”, then the like-named attribute of the “mp4fiods” element 2360 is assigned the numerical value “−1” or “255”. If any of the profile and level indication attributes of the “Profiles” element 150 has the string value “unspecified”,then the like-named attribute of the “mp4fiods” element 2360 is assigned the numerical value “−2” or “254”. Other alphanumeric values for these attributes of the “Profiles” element 150 are defined and related to numerical values in tables contained in the MPEG-4 Systems Specifications. If the value of any profile and level indication attribute of the Profiles element 150 matches one of the alphanumeric profile and level strings defined in the MPEG-4 Systems Specifications, the corresponding numerical value specified in these tables is assigned to the corresponding attribute of the “mp4fiods” element 2360. If the value of any profile and level indication attribute of the Profiles element 150 consists of an alphanumeric string not matching any entry in the tables of profile and level values contained in the MPEG-4 Systems Specifications, the corresponding attribute of the “mp4fiods” element 2360 is assigned the value “−2” or “254”. After operation 3170 is completed, control flow passes to operation 3176.

At operation 3176, standard XML means are used to obtain the “Descr” element 160 subordinate to the “InitialObjectDescriptor” element 130. The procedure “Process Descr element” 3176 is performed to identify the esDescr element 170 subordinate to this Descr element 160. The procedure “Process esDescr element” 3180 is performed to identify each ES_Descriptor element 180, 190 subordinate to the esDescr element. The procedure “Process ES_Descriptor” 3186, 3190 is performed for each ES_Descriptor element subordinate to the esdescr element 170.

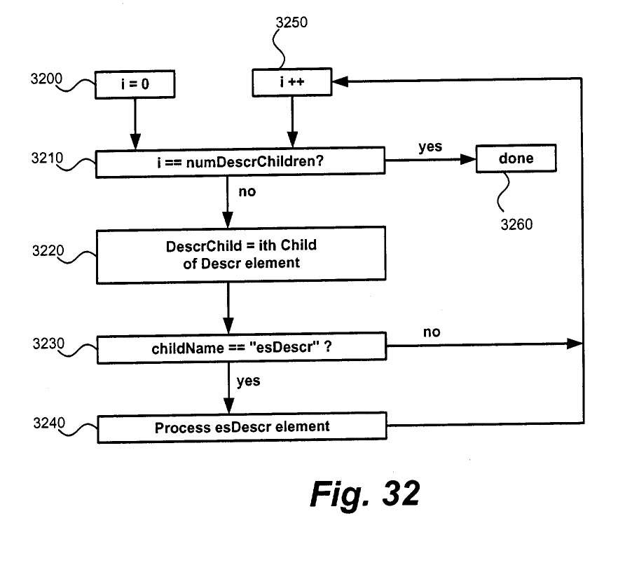

As shown in FIG. 32, the procedure “Process Descr element” 3176 starts by assigning the value “0” to an index “i” 3200. The value of the index “i” in this procedure is compared to the value of a quantity “numDescrChildren” 3210. The value of the quantity numDescrChildren indicates the number of subordinate elements possessed by the Descr element 160. If the value of the index “i” is equal to the value of numDescrChildren, the procedure “Process Descr element” 3176 is completed 3260, the procedure “Process XMT-A Header” 3116 is completed, and the procedure “Process XMT-A document” proceeds to pass 1 XMT-A Body processing operation 3120, described below.

If the value of the index “i” is not equal to the value of numDescrChildren, standard XML means are used to obtain the ith element subordinate to the Descr element 160 and the resulting subordinate element is identified as “DescrChild” 3220. If the element name of DescrChild is “esDescr”,the procedure “Process esDescr element” 3240 is performed. The value of the index “i” is subsequently incremented by 1 3250 and the comparison of the value of “i” to the value of numDescrChildren 3210 is repeated. Each Descr element is expected to yield a single subordinate esDescr element.

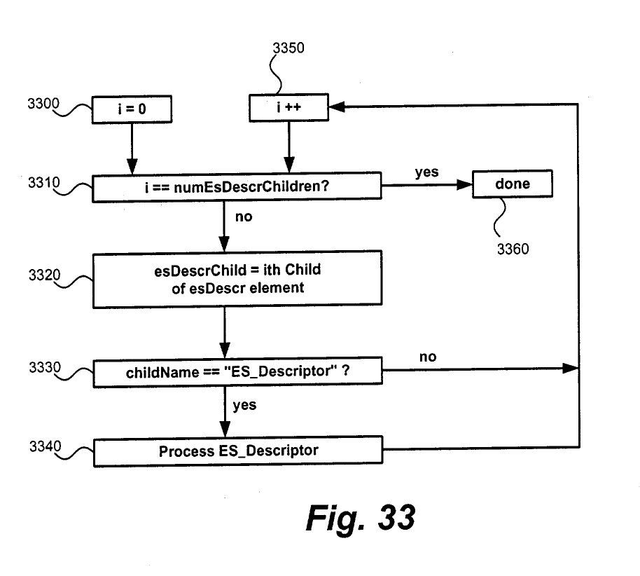

As shown in FIG. 33, the procedure “Process esDescr element” 3180 starts by assigning the value “0” to an index “i” 3300. This index “i” is distinct from the analogous quantity defined within the procedure “Process Descr element” 3180. The value of the index “i” in this procedure is compared to the value of a quantity “numEsDescrChildren” 3310. The value of the quantity numEsDescrChildren indicates the number of subordinate elements possessed by the esDescr element 170. If the value of the index “i” is equal to the value of numEsDescrChildren, the procedure “Process esDescr element” 3180 is completed 3360 and the procedure “Process Descr element” 3176 continues by incrementing the value the index “i” 3250 in that procedure.

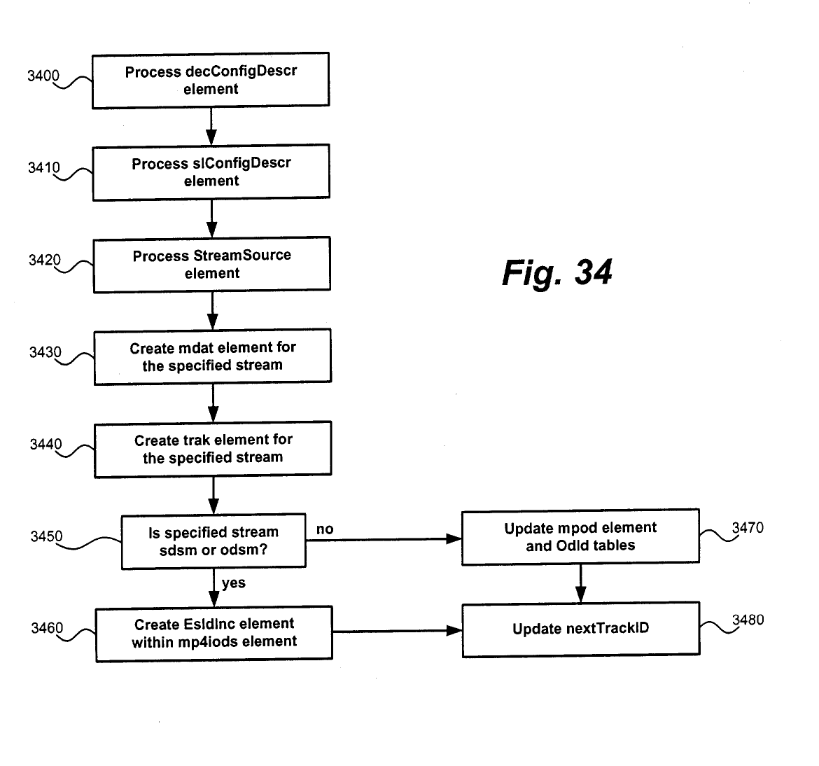

If the value of the index “i” is not equal to the value of numDescrChildren, standard XML means are used to obtain the ith element subordinate to the esDescr element 170 and the resulting subordinate element is identified as “esDescrChild” 3320. If the element name of esDescrChild is “ES_Descriptor”,the procedure “Process ES_Descriptor” 3340 is performed. The procedure “Process ES_Descriptor” is shown in FIG. 34, and the operation of this procedure is described below under “Process ES_Descriptor”.

The value of the index “i” is subsequently incremented by 1 3350 and the comparison of the value of “i” to the value of numEsDescrChildren 3310 is repeated.

Each esDescr element 170 subordinate to a Descr element 160 subordinate to an InitialObjectorDescriptor 130 is expected to yield one or two ES_Descriptor elements 180, 190, one for the scene description stream (sdsm) 180 and possibly one for the object descriptor stream (odsm) 190. An ES_Descriptor element 190 for the odsm is expected whenever the XMT-A document 100 includes audio, visual, or other objects. Each ES_Descriptor element 180, 190 is processed using the procedure “Process ES_Descriptor”. This procedure is described below.

### 7.1.5 Process XMT-A Body Element (Pass 1)

At operation 3120, a set of tables is built enumerating all media objects, reusable BIFS nodes, and reusable Routes defined in the Body element 120 of an XMT-A document 100. These tables are used to determine the number of media objects, the number of BIFS nodes, and the number of Routes. These tables are also used to determine certain properties of the media objects and to resolve references to media objects, BIFS nodes, and Routes.

Each media object is defined by an ObjectDescriptor element 240. Each ObjectDescriptor element 240 is contained within an ObjectDescriptorUpdate command element 220, and this command element is contained within a “par” element 140, 200 within the Body element 120 of an XMT-A document 100. The properties of a media object include an ObjectDescriptorID (ODID) 240, the object start time, the object end time, and the object duration. The ObjectDescriptorID is an alphanumeric string specified as the “ObjectDescriptorID” attribute of an “ObjectDescriptor” element 240.

The object start time is determined by the “begin” attribute(s) of the enclosing “par” element(s) 200.

The object end time is determined the “begin” attribute(s) of the “par” element(s) 200 enclosing an ObjectDescriptorRemove command element 250. The value of the ObjectDescriptorID (ODID) attribute specified in an ObjectDescriptorRemove command element 250 must match the value of the ObjectDescriptorID attribute specified in a corresponding ObjectDescriptor element 240. The object duration is the difference between the object end time and the object start time.

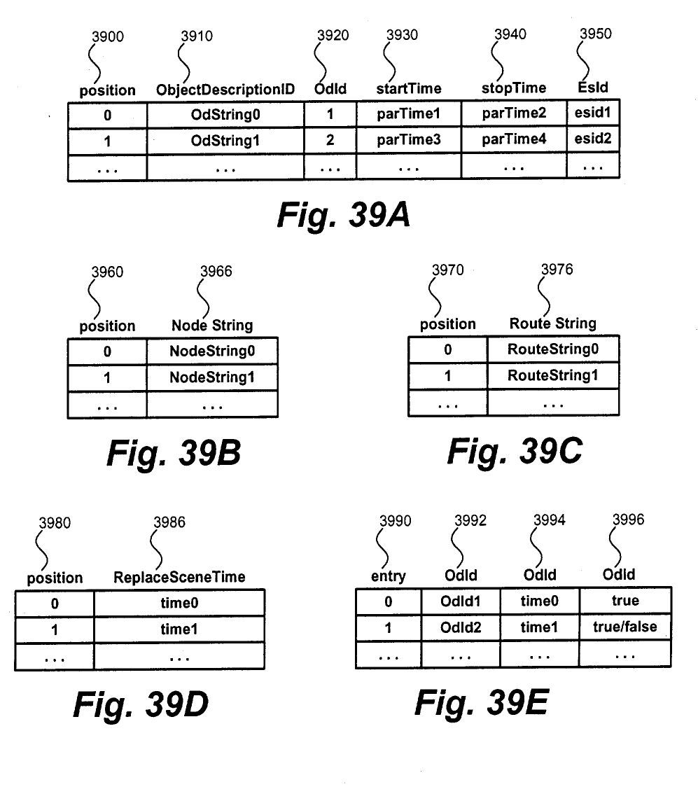

The values of the ObjectDescriptorID strings and the associated start and stop times are stored in the Object table shown in FIG. 39A. This table has five columns, ObjectDescriptorID 3910, OdId 3920, startTime 3930, stopTime 3940, and EsId 3950. Individual entries in each column are indicated by the “position” value 3900 which identifies each row in this table.

A reusable BIFS node is defined by an XMT-A BIFS node element which specifies a value for the “DEF” attribute. The value of this attribute is an alphanumeric string. The values of the reusable BIFS node DEF strings are stored in a table shown in FIG. 39B. This table has one column, NodeString 3966. Individual entries in this column are indicated by the “position” value 3960 which identifies each row in this table.

A reusable Route is defined by an XMT-A Route element which specifies a value for the “DEF” attribute. The value of this attribute is an alphanumeric string. The values of the reusable Route DEF strings are stored in a table shown in FIG. 39C. This table has one column, RouteString 3976. Individual entries in this column are indicated by the “position” value 3970 which identifies each row in this table.

A fourth table records the time values for ReplaceScene commands. This table has one column, ReplaceSceneTime 3986. Individual entries in this column are indicated by the “position” value 3980 which identifies each row in this table.

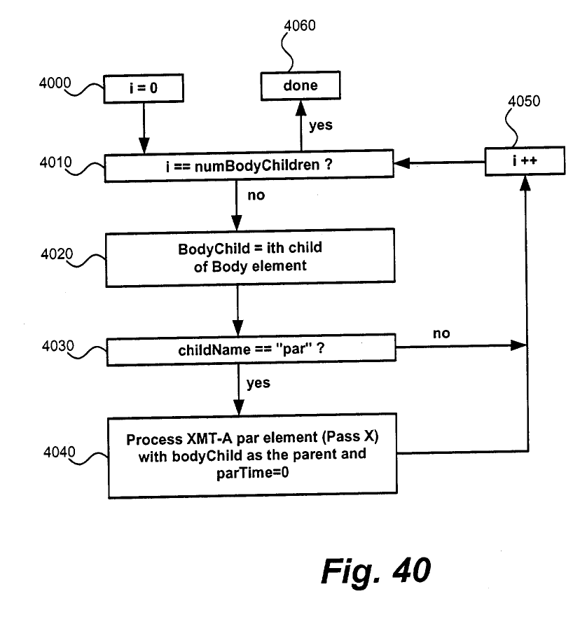

These tables are constructed by traversing the subordinate elements within the XMT-A “Body” element as shown in FIG. 40. This procedure starts at operation 4000 by assigning the value “0” to an index “i”. After the operation 4000 is completed, control passes to operation 4010.

At operation 4010, the value of the index “i” is compared to the value of a quantity “numBodyChildren”. The value of the quantity numBodyChildren indicates the number of subordinate elements possessed by the XMT-A Body element 120.

After operation 4010 is completed, and if the value of the index “i” is equal to the value of numBodyChildren, then this procedure is completed 4060 and processing continues with create edit list for odsm.

If the value of the index “i” is not equal to the value of numBodyChildren, then control passes to operation 4020 where standard XML means are used to obtain the ith element subordinate to the Body element 120 and the resulting subordinate element is identified as “bodyChild”. The element name of the element bodyChild is identified by the string quantity “childName”.

After operation 4020 is completed, control passes to operation 4030 where the value of the string quantity childName is compared to the string “par”. If the value of childName is “par”,then at processing operation 4040 the value “0” is assigned to the quantity “parTime” and the procedure “Process XMT-A par element (Pass 1)” 4040 is performed using the current bodyChild element as the parent element. The procedure “Process XMT-A par element (Pass 1)” is described below.

After operation 4040 is completed, control passes to operation 4050 where the value of the index “i” is subsequently incremented by 1 and the comparison of the value of “i” to the value of numBodyChildren 4010 is repeated.

### 7.1.5.1 Process XMT-A par Element (Pass 1)

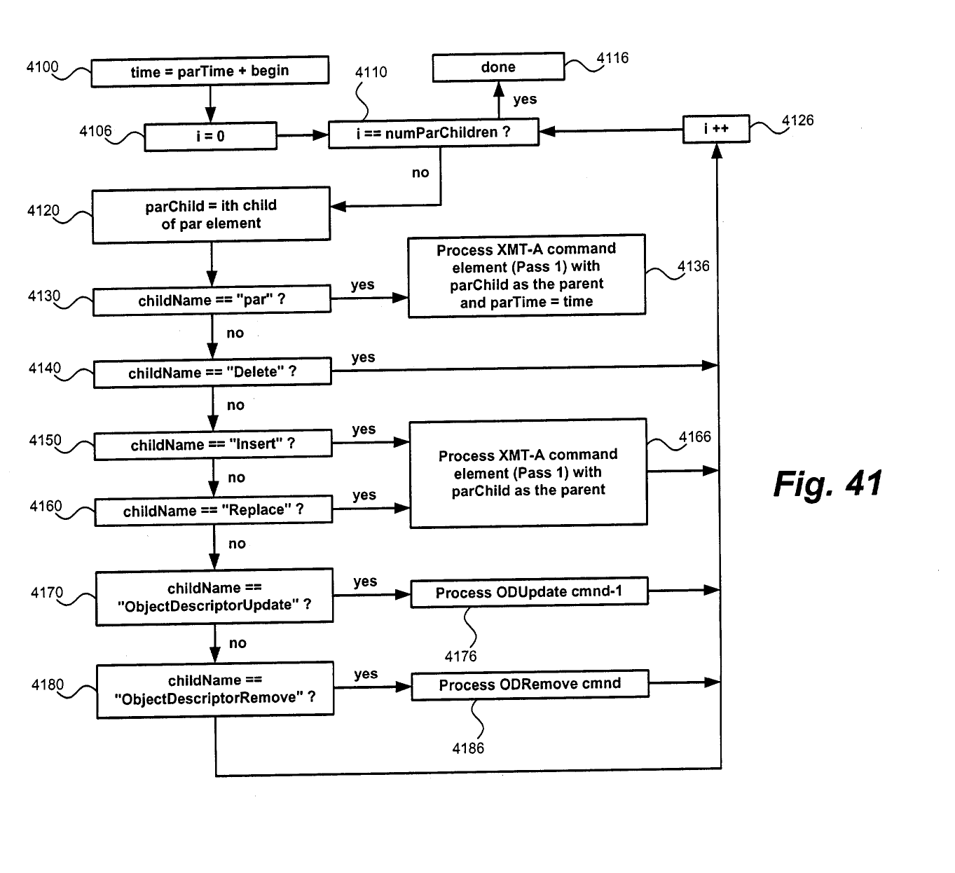

An XMT-A “par” element 140, 200 may be subordinate to an XMT-A Body element 120 or another XMT-A “par” element 200. Each XMT-A “par” element 200 is processed as shown in FIG. 41.

At operation 4100, the value of the “begin” attribute for the current “par” element 200 is added to the current value of the quantity “parTime” 4040, 4136 and the result is assigned to the quantity “time”.

At operation 4106, the value “0” is assigned to an index “i”. This index is distinct from similar index values used in other procedures.

At operation 4110, the value of the index “i” is compared to the value of a quantity “numParChildren”. The value of the quantity numParChildren indicates the number of subordinate elements possessed by the current “parent” element.

At operation 4116, if the value of the index “i” is equal to the value of numParChildren, this procedure is completed and processing continues with operation 4050 if this “parent” element is the subordinate to a Body element 120 or operation 4126 if the “parent” element is subordinate to another “par” element 200.

At operation 4120, if the value of the index “i” is not equal to the value of numParChildren, standard XML means are used to obtain the ith element subordinate to the current parent element and the resulting subordinate element is identified as the “parChild” element. The element name of the parChild element is identified by the string quantity “childName”.

At operation 4130, the value of the string quantity childName is compared to the string “par”.

At operation 4136, if the value of childName is “par”,the value of the quantity “time” is assigned to the quantity “parTime” and the procedure “Process XMT-A par element (Pass 1)” is performed recursively using the current parChild element as the “parent” element. After completion of this procedure, processing continues with step 4126 which is described below.

At operation 4140, the value of the string quantity childName is compared to the string “Delete”. If the value of childName is “Delete”,nothing is done and processing continues with operation 4126.

At operation 4150, the value of the string quantity childName is compared to the string “Insert”.

At operation 4160, the value of the string quantity childName is compared to the string “Replace”.

At operation 4166, if the value of childName is “Insert”, or “Replace”,the procedure “Process XMT-A command element (Pass 1)” is performed using the current parChild element as the “parent” element. This procedure is described below. After this procedure is completed, processing continues with operation 4126.

At operation 4170, the value of the string quantity childName is compared to the string “ObjectDescriptorUpdate”.

At operation 4176, if the value of childName is “ObjectDescriptorUpdate”,the procedure “Process ODUpdate cmnd-1” is performed using the current parChild element as the “parent” element. This procedure is described below. After this procedure is completed, processing continues with operation 4126.

At operation 4180, the value of the string quantity childName is compared to the string “ObjectDescriptorRemove”.

At operation 4186, if the value of childName is “ObjectDescriptorRemove”, the procedure “Process ODRemove cmnd” is performed using the current parChild element as the “parent” element. This procedure is described below.

At operation 4126, the value of the index “i” is subsequently incremented by “1” and the comparison of the value of “i” to the value of numParChildren at operation 4110 is repeated.

### 7.1.5.2 Process XMT-A Command Element (Pass 1)

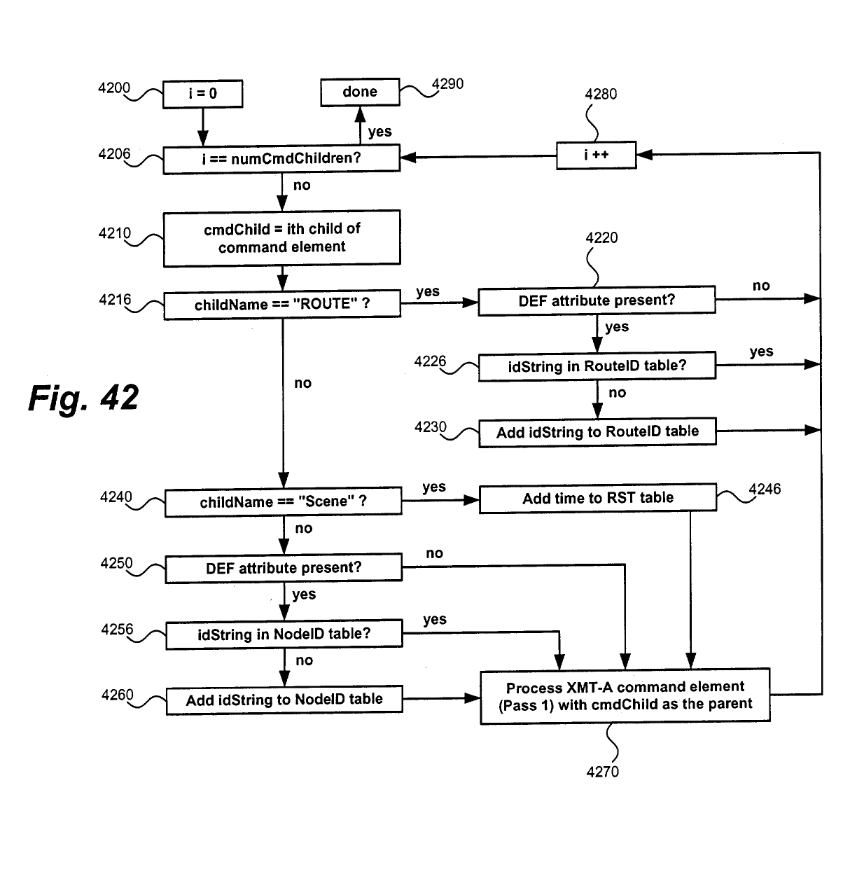

The procedure “Process XMT-A command element (Pass 1)” may be performed either as part 4166 of the procedure “Process XMT-A par element (Pass 1)” or recursively as part 4270 of the procedure “Process BIFS command element (Pass 1)”. As shown in FIG. 42, this procedure starts at operation 4200 by assigning the value “0” to an index “i” (distinct from similar index values employed in other procedures).

At operation 4206, the value of the index “i” is compared to the value of a quantity “numCmdChildren”. The value of the quantity numCmdChildren indicates the number of subordinate elements possessed by the current “parent” element 200.

At operation 4290, if the value of the index “i” is equal to the value of numCmdChildren, this procedure is completed and processing continues with operation 4050 if the “parent” element is subordinate to a Body element 120) or operation 4126 if the “parent” element is subordinate to another “par” element 200.

At operation 4210, if the value of the index “i” is not equal to the value of numCmdChildren, standard XML means are used to obtain the ith element subordinate to the current parent element and the resulting subordinate element is identified as the “cmdChild” element. The element name of the cmdChild element is identified by the string quantity “childName”.

At operation 4216, the value of the string quantity childName is compared to the string “ROUTE”

At operation 4220, if the value of childName is “ROUTE”,standard XML means are used to obtain the value of the “DEF” attribute of the cmdChild element. If no “DEF” attribute is present, nothing is done and processing continues with operation 4280.

At operation 4226, if a value has been specified for the “DEF” attribute of the cmdChild element, the value of the “DEF” attribute is assigned to the string quantity “idString”. The value of idString is then compared to each of the current entries of the RouteID table 3976. If the value of idString matches any current entry in this table, processing continues with operation 4280.

At operation 4230, if the value of idString does not match any current entry in the RouteID table 3976, a new entry is created in this table and the current value of idString is assigned to the new entry. Processing then continues with operation 4280.

At operation 4240, the value of the string quantity childName is compared to the string “Scene”

At operation 4246, if the value of childName is “Scene”,a new entry is created in the ReplaceScene time table 3986 and the current value of the quantity “time” is assigned to the new entry. Processing then continues with operation 4280.

At operation 4250, standard XML means are used to obtain the value of the “DEF” attribute of the cmdChild element. If no “DEF” attribute is present, processing continues with operation 4270.

At operation 4256, if a value has been specified for the “DEF” attribute of the cmdChild element, the value of the “DEF” attribute is assigned to the string quantity “idString”. The value of idString is then compared to each of the current entries of the NodeID table 3966. If the value of idString matches any current entry in this table, processing continues with operation 4270.

At operation 4260, if the value of idString does not match any current entry in the NodeID table 3966, a new entry is created in this table and the current value of idString is assigned to the new entry.

At operation 4270, the current procedure (Process BIFS command element (Pass 1)) is then performed recursively using the current cmdChild element as the parent element.

At operation 4280, the value of the index “i” is subsequently incremented by “1” and the comparison of the value of “i” to the value of numCmdChildren at operation 4206 is repeated.

### 7.1.5.3 “Process ODUpdate Command-1” Procedure

Standard XML means are used to obtain the “OD” element 230 subordinate to the (parent) ObjectDescriptorUpdate command element 220. Standard XML means are then used to obtain the ObjectDescriptor element 240 subordinate to the “OD” element 230. The value of the “objectDescriptorID” attribute (abbreviated as “ODID” in FIG. 2B) of the ObjectDescriptor element 240 is compared to the entries in the ObjectDescriptorID column 3910 in the object table (FIG. 39A). If a match is found, the current value of the quantity “time” is assigned to the corresponding entry in the startTime column 3930.

If the value of the “objectDescriptorID” attribute does not match any current entry in the ObjectDescriptorID column 3910 of the object table, a new entry is added to the object table, the value of the “objectDescriptorID” attribute is assigned to the new entry in the ObjectDescriptorID column 3910, the current value of the quantity “time” is placed in the corresponding entry in the startTime column 3930, and the value “−1.0” is placed in the corresponding entry in the stopTime column 3940. The number of entries in the object table is assigned to the corresponding entry in the OdId column 3920. A value will be assigned to the corresponding entry in the EsId column 3950 as part of the procedure “Process XMT-A Body element (pass 2)”.

### 7.1.5.4 “Process ODRemove cmnd” Procedure

The value of the “objectDescriptorID” attribute (abbreviated as “ODID” in FIG. 2B) of the (parent) ObjectDescriptorRemove command element 250 is compared to the entries in the ObjectDescriptorID column in the object table 3910. If a match is found, the current value of the quantity “time” is assigned to the corresponding entry in the stopTime column 3940.

If the value of the “objectDescriptorID” attribute does not match any current entry in the ObjectDescriptorID column 3910 of the object table, a new entry is added to the object table, the value of the “objectDescriptorID” attribute is assigned to the new entry in the ObjectDescriptorID column 3910, the current value of the quantity “time” is placed in the corresponding entry in the stopTime column 3940, and the value “−1.0” is placed in the corresponding entry in the startTime column 3930. The number of entries in the object table is assigned to the corresponding entry in the OdId column 3920. A value will be assigned to the corresponding entry in the EsId column 3950 as part of the procedure “Process XMT-A Body element (pass 2)”.

### 7.1.6 Create Edit List for odsm

Following the first pass over the XMT-A Body element, the values of the startTime entries 3930 in the object table (FIG. 39A) are compared to find the minimum startTime entry (startTimeMin). The corresponding values of the stopTime entries 3940 are compared to determine the maximum stopTime entry (stopTimeMax). The difference between the value of stopTimeMax and the value of startTimeMin is assigned to the quantity “duration”.

If the minimum startTime value is greater than zero, an edit list (“edts”) element 2644 is inserted into the trak element 2600 associated with the odsm (object descriptor stream). This is accomplished as follows:

1. Standard XML means are used to obtain the moov element 2320 in the mp4-file document 2300.

2. Standard XML means are used to obtain each trak element 2350 in the moov element 2320.

3, The value of the trackID attribute of each track element 2350 is compared to the value of the quantity trackIdForOdsm. This value was assigned when the trak element 2350 for the odsm was created.

4. If the value of the trackID attribute of a particular track element 2600 matches the value of trackIdForOdsm, the following steps are performed.

5. Standard XML means are used to create a new edts element 2644 and insert it into the selected trak element 2600.

6. Standard XML means are used to create a new elst element (2648) and insert it into the new edts element 2644.

7. Standard XML means are used to create a new segment element and insert it into the new elst element 2648.

The value “−1” is assigned to the “startTime” attribute of this “segment” element. The value “1.0” is assigned to the “rate” attribute of this “segment” element. The product of the “timeScale” attribute in the “moov” element 2320 and the value of startTimeMin is assigned to the “duration” attribute of this new “segment” element.

8. Standard XML means are used to create a second new segment element and insert it into the new elst element 2648.

The value “0” is assigned to the “startTime” attribute of the second “segment” element. The value “1.0” is assigned to the “rate” attribute of the second “segment” element. The product of the value of the quantity “duration” and the value of the “timeScale” attribute in the “moov” element 2320 is assigned to the “duration” attribute of the second “segment” element.

### 7.1.7 Process XMT-A Body Element (Pass 2)

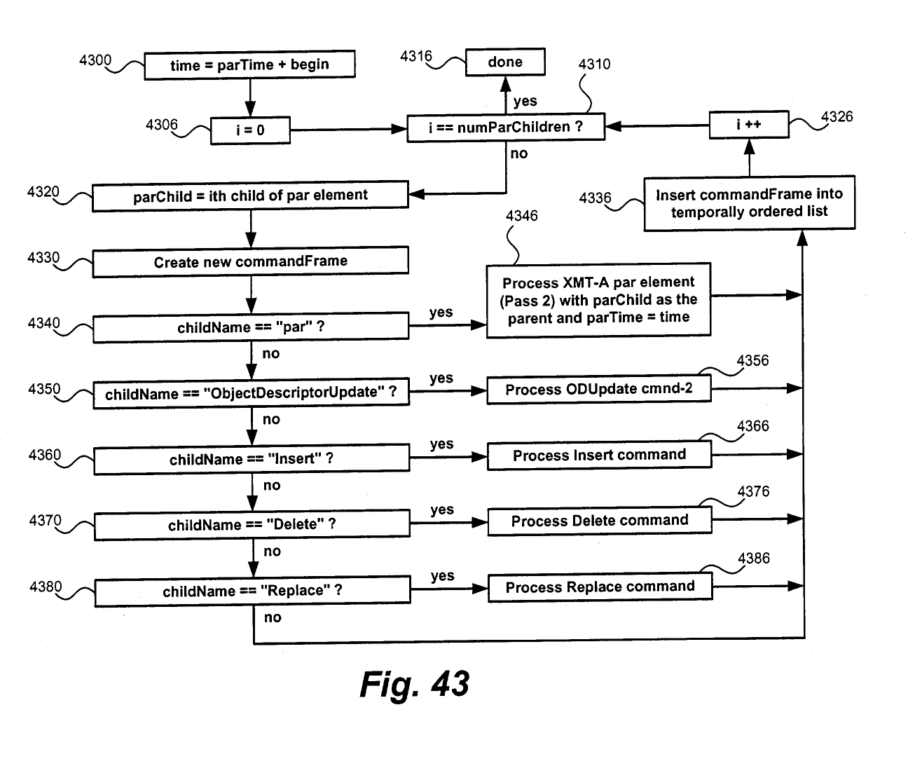

In this step, the subordinate elements of the XMT-A “Body” element are traversed again as shown in FIG. 40. Each subordinate “par” element found in this traversal is processed 4040 using the procedure “Process XMT-A par element (Pass 2)” shown in FIG. 43. After completion of this procedure, processing continues with Step 8, “Insert command frames into mp4bifs document”.

### 7.1.7.1 Process XMT-A Par Element (Pass 2)

At operation 4300, the value of the “begin” attribute for the current “parent” element 200 is added to the current value of the quantity “parTime” 4040, 4346 and the result is assigned to the quantity “time”.

At operation 4306, the value “0” is assigned to an index “i”. This index is distinct from similar index values used in other procedures.

At operation 4310, the value of the index “i” is compared to the value of a quantity “numParChildren”. The value of the quantity numParChildren indicates the number of subordinate elements possessed by the current “parent” element.

At operation 4316, if the value of the index “i” is equal to the value of numParChildren, this procedure is completed and processing continues with 4050 if this “parent” element is the subordinate to a Body element 120 or 4336 if the “parent” element is subordinate to another “par” element 200.

At operation 4320, if the value of the index “i” is not equal to the value of numParChildren, standard XML means are used to obtain the ith element subordinate to the current parent element and the resulting subordinate element is identified as the “parChild” element. The element name of the parChild element is identified by the string quantity “childName”.

At operation 4330, standard XML means are used to create a new commandFrame element 2820, 2830.

At operation 4340, the value of the string quantity childName is compared to the string “par”.

At operation 4346, if the value of childName is “par”,the value of the quantity “time” is assigned to the quantity “parTime” and the procedure “Process XMT-A par element (Pass 2)” is performed recursively using the current parChild element as the “parent” element. After completion of this procedure, processing continues with step 4336 which is described below.

At operation 4350, the value of the string quantity childName is compared to the string “ObjectDescriptorUpdate”.

At operation 4356, if the value of childName is “ObjectDescriptorUpdate”,the procedure “Process ODUpdate command-2” is performed using the current parChild element as the “parent” element. This procedure is described below. After this procedure is completed, processing continues with 4126.

At operation 4360, the value of the string quantity childName is compared to the string “Insert”.

At operation 4366, if the value of childName is “Insert”,the procedure “Process Insert command” is performed using the current parChild element as the “parent” element. This procedure is described below. After completion of this procedure, processing continues with step 4336 which is described below.

At operation 4370, the value of the string quantity childName is compared to the string “Delete”.

At operation 4376, if the value of childName is “Delete”,the procedure “Process Delete command” is performed using the current parChild element as the “parent” element. This procedure is described below. After completion of this procedure, processing continues with step 4336 which is described below.

At operation 4380, the value of the string quantity childName is compared to the string “Replace”.

At operation 4386, if the value of childName is “Replace”,the procedure “Process Replace command” is performed using the current parChild element as the “parent” element. This procedure is described below.

At operation 4336, the current commandFrame element 2830 created at 4330 is inserted into a temporally ordered list of commandFrame elements. This is accomplished by inserting each new commandFrame element into this list at a point prior to the first member of this list having a time attribute with a value greater than the value of the time attribute for the new commandFrame element, or at the end of this list if no current member of this list has a time attribute with a value greater than the value of the time attribute for the new commandFrame element. It is also possible to perform operation 4336 immediately after operation 4330 instead of immediately prior to operation 4326 (as shown in FIG. 43). In either case, operations 4330 and 4336 may create empty commandFrame elements which contain no commands, and multiple commandFrame elements having the same time attribute as other commandFrame elements. Empty commandFrame elements are eliminated and multiple command frame having the same time attribute are combined in operation 3136.

At operation 4326, the value of the index “i” is subsequently incremented by “1” and the comparison of the value of “i” to the value of numParChildren 4310 is repeated.

### 7.1.7.2 Process ODUpdate Command-2

Standard XML means are used to obtain the “OD” element 230 subordinate to the (parent) ObjectDescriptorUpdate command element 220. Standard XML means are then used to obtain the ObjectDescriptor element 240 subordinate to the “OD” element 230. Standard XML means are then used to obtain the “Descr” element 610 subordinate to the “ObjectDescriptor” element 600. The “Descr” element 610 is processed as shown in FIG. 32 to obtain the subordinate “esDescr” element 620. This “esDescr” element 620 is processed as shown in FIG. 33 to obtain the subordinate “ES_Descriptor” element 630. The procedure “Process ES_Descriptor” described below is then performed for each “ES_Descriptor” element 630 obtained in this manner.

### 7.1.7.3 Process Insert Command

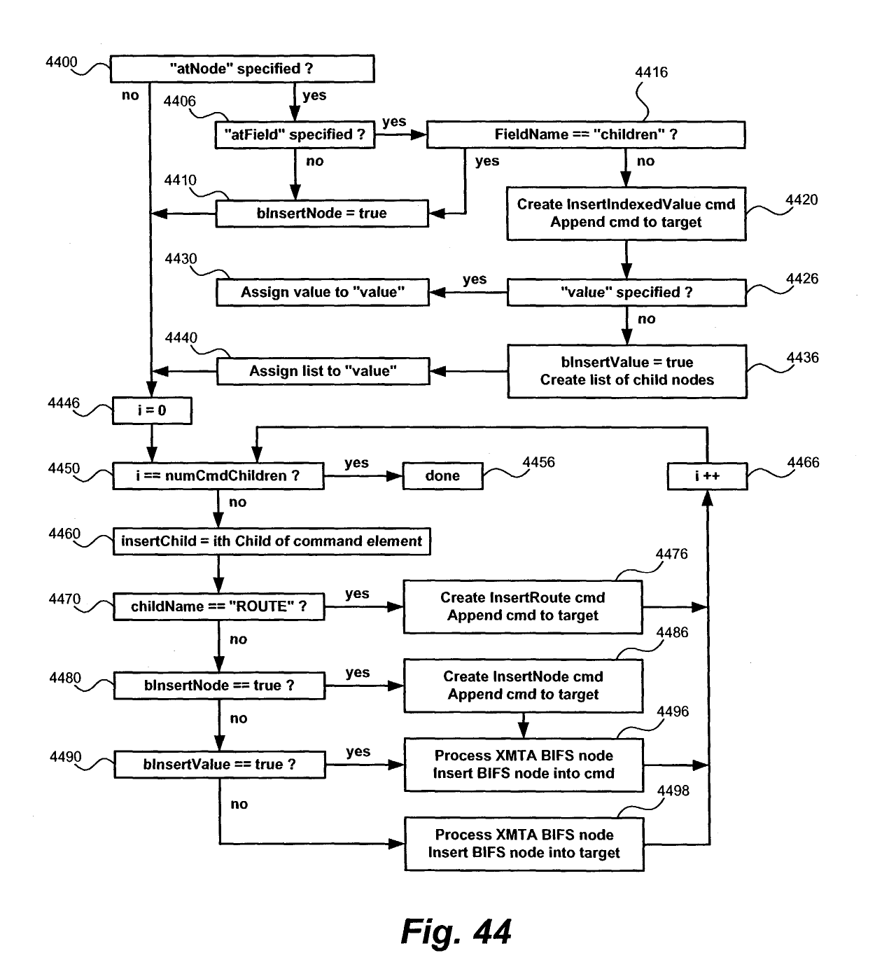

The steps employed to process an “Insert” command element are shown in FIG. 44. The parent element in this procedure is an XMT-A Insert command element 300. This command element may be subordinate to an XMT-A “par” element 200, or the “buffer” attribute element 410 of a Conditional node element 400. If the Insert command element is subordinate to an XMT-A “par” element 200, the mp4bifs “target” element is a commandFrame element 2820, 2830 created in 4330. If the Insert command element is subordinate to a “buffer” attribute element 410 of a Conditional node element 400, then the mp4-bifs “target” element is an mp4-bifs Conditional node element.

Initially, the value “false” is assigned to two boolean values, bInsertNode and bInsertValue.

At operation 4400, the value of the “atNode” attribute of the parent element is assigned to the quantity “NodeId”. If a value has not been specified for the “atNode” attribute, the procedure continues with operation 4446.

At operation 4406, if a value has been specified for the “atNode” attribute, the value of the “atField” attribute of the parent element is assigned to the quantity “FieldName”.

At operation 4416, if a value has been specified for the “atField” attribute, the value of the quantity “FieldName” is compared to the string “children”.

At operation 4410, if a value has not been specified for the “atField” attribute, or the value of the quantity “FieldName” is “children”,the value “true” is assigned to the boolean quantity “bInsertNode”, and the procedure continues with operation 4446.

At operation 4420, if a value has been specified for the “atField” attribute, and the value of the quantity “FieldName” is not “children”,standard XML means are used to create a new mp4-bifs InsertIndexedValue command element (“newCommand”). Standard XML means are then used to append the newCommand element to the current mp4-bifs target element.

At operation 4426, the value of the “value” attribute of the parent element is assigned to the quantity “value”.

At operation 4430, if a value has been specified for the “value” attribute of the XMT-A BIFS command element, a value is assigned to the “value” attribute of the new mp4bifs newCommand element. In most cases, the value assigned to the “value” attribute of the new mp4bifs newCommand element is equal to the value of the “value” attribute of the XMT-A BIFS command element. In certain cases identified below (Data format conversions), the value assigned to the “value” attribute of the new mp4bifs newCommand element is derived from the value of the “value” attribute of the XMT-A BIFS command element

In this case, this procedure is complete and processing continues with operation 4336 or processing of an XMT-A Conditional node element 4890.

At operation 4436, if a value has not been specified for the “value” attribute, the value “true” is assigned to the boolean quantity “bInsertValue”. A string quantity “childNames” consisting of a list of the element names for all elements immediately subordinate to the current parent element is created.

At operation 4440, the value of the string quantity “childNames” is assigned to the “value” attribute of the new mp4-bifs element “newCommand”.

At operation 4446, the value “0” is assigned to the index “i” which is distinct from other index values defined elsewhere.

At operation 4450, the value of the index “i” is compared to the value of the quantity “numCmdChildren”. The value of the quantity numCmdChildren indicates the number of subordinate elements possessed by the current “parent” element.

At operation 4456, if the value of the index “i” is equal to the value of numCmdChildren, this procedure is completed and processing continues with operation 4336 or processing of an XMT-A Conditional node element 4890.

At operation 4460, if the value of the index “i” is not equal to the value of numCmdChildren, standard XML means are used to obtain the ith element subordinate to the current parent element and the resulting subordinate element is identified as the “insertChild” element. The element name of the insertChild element is identified by the string quantity “childName”.

At operation 4470, the value of the string quantity childName is compared to the string “ROUTE”.

At operation 4476, if the value of the string quantity childName is “ROUTE”,the procedure “Create InsertRoute command” is performed. Standard XML means are then used to append the resulting newCommand element to the current mp4-bifs target element. This procedure then continues with operation 4466.

At operation 4480, if the value of the string quantity childName is not “ROUTE”,the value of the boolean quantity bInsertNode is compared to the value “true”.

At operation 4486, if the value of the boolean quantity bInsertNode is “true”,the procedure “Create InsertNode command” is performed. Standard XML means are then used to append the resulting newCommand element to the current mp4-bifs target element. Processing continues with operation 4496.

At operation 4490, if the value of the boolean quantity bInsertNode is not “true”,the value of the boolean quantity bInsertValue is compared to the value “true”.

At operation 4496, if the value of the boolean quantity bInsertValue is “true”, or the value of the boolean quantity bInsertNode is “true”,the procedure “Process XMT-A BIFS node” is performed using the current insertChild element as the parent element. Standard XML means are then used to append the resulting mp4-bifs node element to the newCommand element. Processing continues with operation 4466.

At operation 4498, if the value of the boolean quantity bInsertValue is not “true”,the XMT-A document is not valid, and an error is reported. The procedure “Process XMT-A BIFS node” is performed using the current insertChild element as the parent element. Standard XML means are then used to append the resulting mp4-bifs node element to the current mp4-bifs target element. Processing continues with operation 4466.

At operation 4466, the value of the index “i” is incremented by “1” and the comparison to numCmdChildren 4450 is repeated.

### 7.1.7.4 “Create InsertRoute Command” Procedure

Standard XML means are used to create a new mp4-bifs InsertRoute command element (“newCommand”).

The value of the “fromNode” attribute of the XMT-A parent element is compared to the entries 3966 in the BIFS NodeId table (FIG. 39B). The value of the “position” 3960 of the matching entry is assigned to the integer quantity fromNodeId and the result is incremented by “1”. The result is then assigned to the “departureNode” attribute of the newCommand element.

The value of the “fromField” attribute of the XMT-A parent element is assigned to the “departureFieldName” attribute of the newCommand element.

The value of the “toNode” attribute of the XMT-A parent element is compared to the entries 3966 in the BIFS NodeId table (FIG. 39B). The value of the “position” 3960 of the matching entry is assigned to the integer quantity fromNodeId and the result is incremented by “1”. The result is then assigned to the “arrivalNode” attribute of the newCommand element.

The value of the “toField” attribute of the XMT-A parent element is assigned to the “arrivalFieldName” attribute of the newCommand element.

If a value has been specified for the “DEF” attribute of the XMT-A parent element, the value of this attribute is compared to the entries 3976 in the BIFS RouteId table (FIG. 39C). The value of the “position” 3970 of the matching entry is assigned to the integer quantity routeId and the result is incremented by “1”. The result is then assigned to the “routeId” attribute of the newCommand element. If the value of the boolean quantity bUseNames is true, then the value of the “DEFS” attribute is assigned to the “name” attribute of the newCommand element. The value of bUseNames is established while processing a “Replace Scene” command.

### 7.1.7.5 “Create InsertNode Command” Procedure

Standard XML means are used to create a new mp4-bifs InsertNode command element (“newCommand”).

The value of the quantity “NodeId” is compared to the entries 3966 in the BIFS NodeId table (FIG. 39B). The value of the “position” 3960 of the matching entry is assigned to the integer quantity atNodeId and the result is incremented by “1”. The result is then assigned to the “parentId” attribute of the newCommand element.

If the value of the “position” attribute of the XMT-A parent element is “BEGIN”,the value “2” is assigned to the “insertionPosition” attribute of the newCommand element.

If the value of the “position” attribute of the XMT-A parent element is “END”,the value “3” is assigned to the “insertionPosition” attribute of the newCommand element.

If the value of the “position” attribute of the XMT-A parent element is not “BEGIN” and not “END”,the value “0” is assigned to the “insertionPosition” attribute of the newCommand element and the value of the “position” attribute of the XMT-A parent element is assigned to the “position” attribute of the newCommand element.

### 7.1.7.6 Process Delete Command

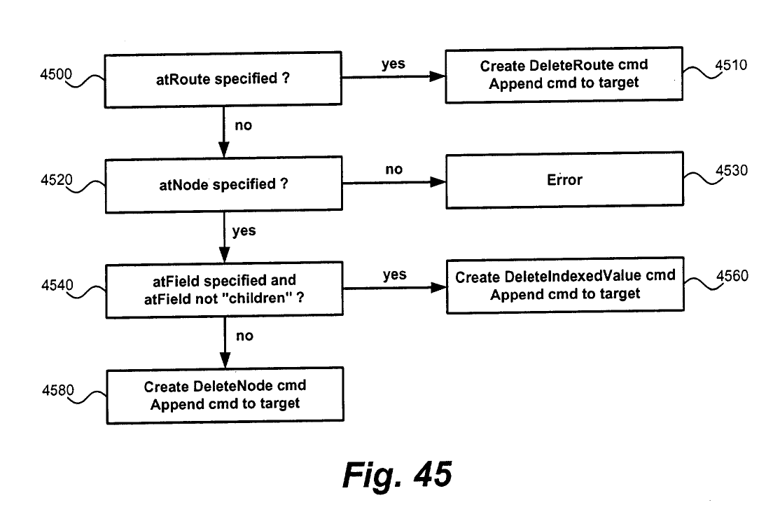

The steps employed to process a “Delete” command element are shown in FIG. 45. The parent element in this procedure is an XMT-A Delete command element 310. This command element may be subordinate to an XMT-A “par” element 200, or the “buffer” attribute element 410 of a Conditional node element 400. If the Delete command element is subordinate to an XMT-A “par” element 200, the mp4bifs “target” element is a commandFrame element 2820, 2830 created in 4330. If the Delete command element is subordinate to a “buffer” attribute element 410 of a Conditional node element 400, then the mp4-bifs “target” element is an mp4-bifs Conditional node element.

At operation 4500, the value of the “atRoute” attribute of the parent element is assigned to the quantity “RouteId”.

At operation 4510, if a value has been specified for the “atRoute” attribute, standard XML means are used to create a new mp4bifs DeleteRoute command element (“newCommand”), and the value of the quantity “RouteId” is assigned to the “routeId” attribute of the newCommand element. Standard XML means are then used to append the newCommand element to the current mp4-bifs target element.

At operation 4520, the value of the “atNode” attribute of the parent element is assigned to the quantity “NodeId”.

At operation 4530, if a value has not been specified for the “atNode” attribute, the XMT-A document is not valid.

At operation 4540, if a value has been specified for the “atNode” attribute, the value of the “atField” attribute of the parent element is assigned to the quantity “FieldName”. If a value has been specified for the “atField” attribute, the value of the quantity “FieldName” is compared to the string “children”.

At operation 4560, if a value has been specified for the “atField” attribute, and the value of the quantity “FieldName” is not “children”,standard XML means are used to create a new mp4-bifs DeleteIndexedValue command element (newCommand). The value of the quantity atField is assigned to the “inFieldName” attribute of the newCommand element.

If the value of the “position” attribute of the XMT-A parent element is “BEGIN”,the value “2” is assigned to the “deletionPosition” attribute of the newCommand element.

If the value of the “position” attribute of the XMT-A parent element is “END”,the value “3” is assigned to the “deletionPosition” attribute of the newCommand element.

If the value of the “position” attribute of the XMT-A parent element is not “BEGIN” and not “END”,the value “0” is assigned to the “deletionPosition” attribute of the newCommand element and the value of the “position” attribute of the XMT-A parent element is assigned to the “position” attribute of the newCommand element.

Standard XML means are then used to append the newCommand element to the current mp4-bifs target element.

At operation 4580, if a value has not been specified for the “atField” attribute, or the value of the quantity “FieldName” is “children”,standard XML means are used to create a new mp4-bifs DeleteNode command element (“newCommand”).

The value of the quantity “NodeId” is compared to the entries 3966 in the BIFS NodeId table (FIG. 39B). The value of the “position” 3960 of the matching entry is assigned to the integer quantity atNodeId and the result is incremented by “1”. The result is then assigned to the “nodeId” attribute of the newCommand element.

Standard XML means are then used to append the newCommand element to the current mp4-bifs target element.

### 7.1.7.7 Process Replace Command

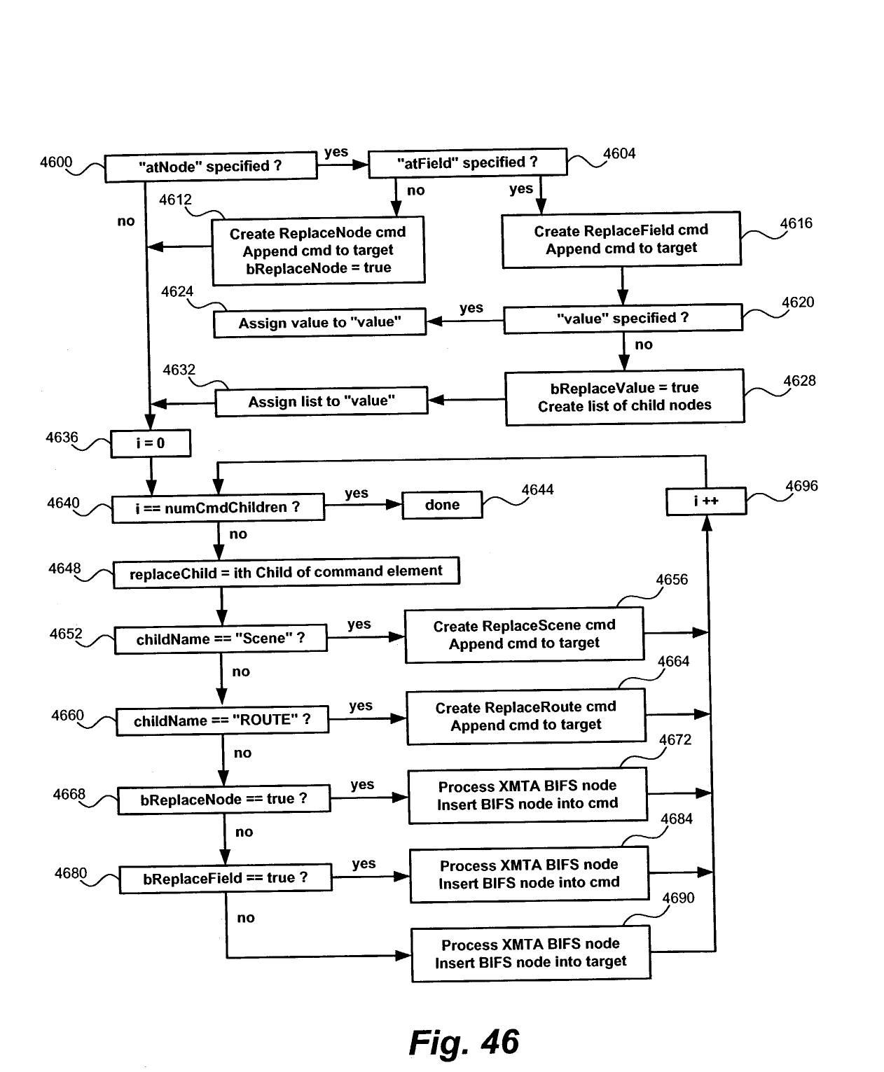

The steps employed to process an XMT-A “Replace” element are shown in FIG. 46. The parent element in this procedure is an XMT-A Replace command element 320. This command element may be subordinate to an XMT-A “par” element 200, or the “buffer” attribute element 410 of a Conditional node element 400. If the Replace command element is subordinate to an XMT-A “par” element 200, the mp4bifs “target” element is a commandFrame element 2820, 2830 created in 4330. If the Replace command element is subordinate to a “buffer” attribute element 410 of a Conditional node element 400, then the mp4-bifs “target” element is an mp4-bifs Conditional node element.

Initially, the value “false” is assigned to two boolean values, bReplaceNode and bReplaceValue.

At operation 4600, the value of the “atNode” attribute of the parent element is assigned to the quantity “NodeId”. If a value has not been specified for the “atNode” attribute, the procedure continues with operation 4636.

At operation 4604, if a value has been specified for the “atNode” attribute, the value of the “atField” attribute of the parent element is assigned to the quantity “FieldName”.

At operation 4612, if a value has not been specified for the “atField” attribute, standard XML means are used to create a new mp4bifs ReplaceNode command element (“newCommand”). The value of the quantity “NodeId” is compared to the entries 3966 in the BIFS NodeId table (FIG. 39B). The value of the “position” 3960 of the matching entry is assigned to the integer quantity atNodeId and the result is incremented by “1”. The result is then assigned to the “nodeId” attribute of the newCommand element.

Standard XML means are used to append the newCommand element to the mp4-bifs target element. The value “true” is assigned to the boolean quantity “bReplaceNode”, and the procedure continues with operation 4636.

At operation 4616, if a value has been specified for the “atField” attribute, standard XML means are used to create a new mp4bifs ReplaceField command element (“newCommand”). The value of the quantity “NodeId” is compared to the entries 3966 in the BIFS NodeId table (FIG. 39B). The value of the “position” 3960 of the matching entry is assigned to the integer quantity atNodeId and the result is incremented by “1”. The result is then assigned to the “nodeId” attribute of the newCommand element.

The value of the quantity “FieldName” is assigned to the “inFieldName” attribute of the newCommand element. Standard XML means are then used to append the newCommand element to the current mp4-bifs target element.

At operation 4620, the value of the “value” attribute of the parent element is assigned to the quantity “value”.

At operation 4624, if a value has been specified for the “value” attribute of the XMT-A BIFS command element, a value is assigned to the “value” attribute of the new mp4bifs newCommand element. In most cases, the value assigned to the “value” attribute of the new mp4bifs newCommand element is equal to the value of the “value” attribute of the XMT-A BIFS command element. In certain cases identified below (Data format conversions), the value assigned to the “value” attribute of the new mp4bifs newCommand element is derived from the value of the “value” attribute of the XMT-A BIFS command element. In this case, this procedure is complete and processing continues with operation 4336 or processing of an XMT-A Conditional node element 4890.

At operation 4628, if a value has not been specified for the “value” attribute, the value “true” is assigned to the boolean quantity “bReplaceField”. A string quantity “childNames” consisting of a list of the element names for all elements immediately subordinate to the current parent element is created.

At operation 4632, the value of the string quantity “childNames” is assigned to the “value” attribute of the new mp4-bifs element “newCommand”.

At operation 4636, the value “0” is assigned to the index “i” which is distinct from other index values defined elsewhere.

At operation 4640, the value of the index “i” is compared to the value of the quantity “numCmdChildren”. The value of the quantity numCmdChildren indicates the number of subordinate elements possessed by the current “parent” element.

At operation 4644, if the value of the index “i” is equal to the value of numCmdChildren, this procedure is completed and processing continues with operation 4336 or processing of an XMT-A Conditional node element operation 4890.

At operation 4648, if the value of the index “i” is not equal to the value of numCmdChildren, standard XML means are used to obtain the ith element subordinate to the current parent element and the resulting subordinate element is identified as the “replaceChild” element. The element name of the replaceChild element is identified by the string quantity “childName”.

At operation 4652, the value of the string quantity childName is compared to the string “Scene”. If, in operation 4656, the value of the string quantity childName is “Scene”,the procedure “Create ReplaceScene command” is performed. Standard XML means are then used to append the resulting newCommand element to the current mp4-bifs target element. This procedure then continues to operation 4696.

At operation 4660, if the value of the string quantity childName is not “Scene”,the value of the string quantity childName is compared to the string “ROUTE”. If, in operation 4664, the value of the string quantity childName is “ROUTE”,the procedure “Create ReplaceRoute command” is performed. Standard XML means are then used to append the resulting newCommand element to the current mp4-bifs target element. This procedure then continues with operation 4696.

At operation 4668, if the value of the string quantity childName is not “ROUTE”,the value of the boolean quantity bReplaceNode is compared to the value “true”.

At operation 4672, if the value of the boolean quantity bReplaceNode is “true”,the procedure “Process XMT-A BIFS Node” is performed using the current replaceChild element as the parent element. Standard XML means are then used to append the resulting mp4-bifs node element to the current mp4-bifs target element. Processing continues with operation 4496.

At operation 4680, if the value of the boolean quantity bReplaceNode is not “true”,the value of the boolean quantity bReplaceField is compared to the value “true”.

At operation 4684, if the value of the boolean quantity bReplaceField is “true”,the procedure “Process XMT-A BIFS node” is performed using the current replaceChild element as the parent element. Standard XML means are then used to append the resulting mp4-bifs node element to the newCommand element. Processing continues with operation 4496.

At operation 4690, if the value of the boolean quantity bReplaceNode is not “true”,the XMT-A document is not valid. The procedure “Process XMT-A BIFS node” is performed using the current replaceChild element as the parent element. Standard XML means are then used to append the resulting mp4-bifs node element to the current mp4-bifs target element. Processing continues with operation 4496.

At operation 4696, the value of the index “i” is incremented by “1” and the comparison to numCmdChildren at operation 4640 is repeated.

### 7.1.7.8 “Create ReplaceRoute Command” Procedure

Standard XML means are used to create a new mp4-bifs ReplaceRoute element (“newCommand”).

The value of the “fromNode” attribute of the XMT-A parent element is compared to the entries 3966 in the BIFS NodeId table (see FIG. 39B). The value of the “position” 3960 of the matching entry is assigned to the integer quantity “fromNodeId” and the result is incremented by “1”. The result is then assigned to the “departureNode” attribute of the newCommand element.

The value of the “fromField” attribute of the XMT-A parent element is assigned to the “departureFieldName” attribute of the newCommand element.

The value of the “toNode” attribute of the XMT-A parent element is compared to the entries 3966 in the BIFS NodeId table (see FIG. 39B). The value of the “position” 3960 of the matching entry is assigned to the integer quantity fromNodeId and the result is incremented by “1”. The result is then assigned to the “arrivalNode” attribute of the newCommand element.

The value of the “toField” attribute of the XMT-A parent element is assigned to the “arrivalFieldName” attribute of the newCommand element.

The value of the “atRoute” attribute of the XMT-A parent element is compared to the entries 3976 in the BIFS RouteId table (see FIG. 39C). The value of the “position” 3970 of the matching entry is assigned to the integer quantity routeId and the result is incremented by “1”. The result is then assigned to the “routeId” attribute of the newCommand element. If a value has not been specified for the atRoute attribute of the XMT-A parent element, the XMT-A document is invalid.

### 7.1.7.9 “Create ReplaceScene Command” Procedure

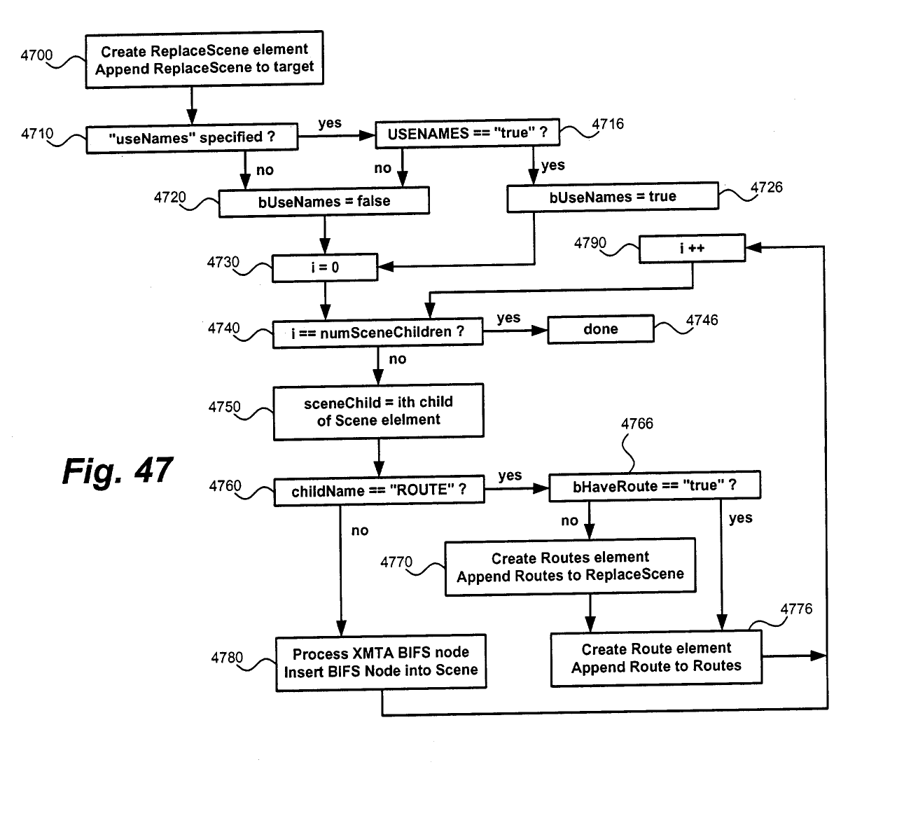

The steps employed to create an mp4-bifs “ReplaceScene” command element are shown in FIG. 47. The XMT-A parent element in this procedure is an XMT-A Scene command element 320. This command element is always subordinate to an XMT-A “Replace” element 200.

At operation 4700, standard XML means are used to create a new mp4-bifs “ReplaceScene” command element 2930 (newCommand). Standard XML means are used to append this new command element to the current mp4-bifs target element. The mp4-bifs target element must be either an mp4-bifs commandFrame element 2830 or an mp4-bifs Conditional node element. The value “false” is assigned to the boolean quantity “bHaveRoutes”.

At operation 4710, the value of the “useNames” attribute of the XMT-A “Scene” element is assigned to the boolean quantity “USENAMES”.

At operation 4716, if a value has been specified for the “useNames” attribute of the XMT-A “Scene” element, the value of the boolean quantity “USENAMES” is compared to the value “true”.

At operation 4720, if a value has not been specified for the “useNames” attribute of the XMT-A “Scene” element, or the value of the boolean quantity “USENAMES” is not “true”,the value “false” is assigned to the boolean quantity “bUseNames”.

At operation 4726, if the value of the boolean quantity “USENAMES” is “true”,the value “true” is assigned to the boolean quantity “bUseNames”.

At operation 4730, the value “0” is assigned to the index “i” which is distinct from other index values defined elsewhere.

At operation 4740, the value of the index “i” is compared to the value of the quantity “numSceneChildren”. The value of the quantity numSceneChildren indicates the number of subordinate elements possessed by the XMT-A Scene element.

At operation 4746, if the value of the index “i” is equal to the value of numSceneChildren, this procedure is completed and processing continues with operation 4656.

At operation 4750, if the value of the index “i” is not equal to the value of numSceneChildren, standard XML means are used to obtain the ith element subordinate to the XMT-A Scene element and the resulting subordinate element is identified as the “sceneChild” element. The element name of the sceneChild element is identified by the string quantity “childName”.

At operation 4760, the value of the string quantity childName is compared to the string “ROUTE”.

At operation 4766, if the value of the string quantity childName is “ROUTE”,the value of the boolean quantity bHaveRoutes is compared to the value “true”.

At operation 4770, if the value of the boolean quantity bHaveRoutes is not “true”,standard XML means are used to create a new mp4-bifs “Routes” element. Standard XML means are used to append the resulting mp4-bifs “Routes” element to the newCommand element. The value “true” is assigned to the boolean quantity “bHaveRoutes”.

At operation 4776, standard XML means are used to create a new mp4-bifs “Route” element. Standard XML means are used to append the resulting mp4-bifs “Route” element to the mp4-bifs “Routes” element.

The value of the “fromNode” attribute of the XMT-A parent element is compared to the entries 3966 in the BIFS NodeId table (see FIG. 39B). The value of the “position” 3960 of the matching entry is assigned to the integer quantity fromNodeId and the result is incremented by “1”. The result is then assigned to the “fromNode” attribute of the mp4-bifs Route element.

The value of the “fromField” attribute of the XMT-A parent element is assigned to the “fromFieldName” attribute of the mp4-bifs Route element.

The value of the “toNode” attribute of the XMT-A parent element is compared to the entries 3966 in the BIFS NodeId table (see FIG. 39B). The value of the “position” 3960 of the matching entry is assigned to the integer quantity fromNodeId and the result is incremented by “1”. The result is then assigned to the “toNode” attribute of the mp4-bifs Route element.

The value of the “toField” attribute of the XMT-A parent element is assigned to the “toFieldName” attribute of the mp4-bifs Route element.

If a value has been specified for the “DEF” attribute of the XMT-A parent element, the value of this attribute is compared to the entries 3976 in the BIFS RouteId table (see FIG. 39C). The value of the “position” 3970 of the matching entry is assigned to the integer quantity routeId and the result is incremented by “1”. The result is then assigned to the “routeId” attribute of the mp4-bifs Route element. If the value of the boolean quantity bUseNames is true, then the value of the “DEFS” attribute is assigned to the “name” attribute of the mp4-bifs Route element.

At operation 4780, if the value of the string quantity childName is not “ROUTE”,the procedure “Process XMT-A BIFS node” is performed using the current sceneChild element as the parent element. Standard XML means are used to append the resulting mp4-bifs node element to the newCommand element. Processing continues with operation 4496.

At operation 4790, the value of the index “i” is incremented by “1” and the comparison to numSceneChildren at operation 4740 is repeated.

### 7.1.7.10 “Process XMT-A BIFS Node” Procedure

More than 100 types of BIFS nodes are defined in the MPEG-4 Systems specifications. Each MPEG-4 BIFS node has a specific node name and a set of named property fields. Each named property field has a specific data type, such as boolean, integer, float, string, “node” or “buffer”. For each type of MPEG-4 BIFS node, corresponding like-named node elements are defined for XMTA documents and mp4bifs documents. Each node element defined for mp4bifs documents possesses a set of attributes with names matching those of the property fields of the corresponding MPEG-4 BIFS node.

As shown in FIG. 30, each MPEG-4 BIFS property field with data type “node” or “buffer” may also be represented by one or more subordinate elements of an mp4bifs node element, and the corresponding attribute of the mp4bifs node element consists of a list of the element names of the subordinate elements associated with this property field. These subordinate elements may be node elements or command elements. In this way, the structure of each mp4bifs node element mimics the structure of the corresponding MPEG-4 BIFS node.

The node elements defined for XMT-A documents are similar to those defined for mp4bifs documents, except that the attributes defined for each XMT-A node element include only the properties which do not have data types of “node” or “buffer”. For each property of an MPEG-4 BIFS node with data type of “node” or “buffer”,XMTA specifications define a like-named subordinate attribute element with no attributes, and the corresponding property fields are represented by node elements or command elements subordinate to these attribute elements.

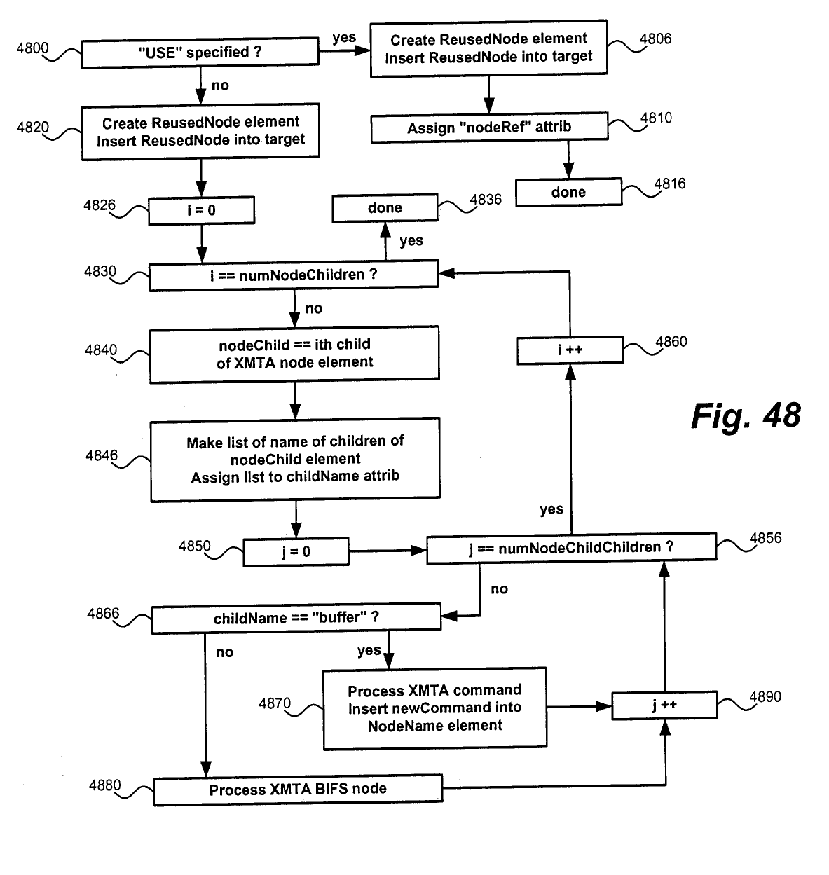

As indicated in FIG. 48, the conversion process for an XMTA BIFS node element begins at operation 4800 by assigning the value of the “USE” attribute of an XMT-A node element to the string quantity “nodeRef”. If a value has been specified for the “USE” attribute of the XMT-A node element, then in operation 4806 standard XML means are used to create a new mp4bifs ReusedNode element. Standard XML means are used to insert the new ReusedNode element into the current mp4bifs target element.

At operation 4810, the value of the string quantity “nodeRef” is compared to the entries 3966 in the BIFS NodeId table (see FIG. 39B). The value of the “position” 3960 of the matching entry is assigned to the integer quantity nodeId and the result is incremented by “1”. The result is then assigned to the “nodeRef” attribute of the newCommand element. Processing of this XMT-A node element is complete at operation 4816 and processing continues with the XMT-A BIFS command element or parent XMT-A BIFS node element that possessed this XMT-A node element.

At operation 4820, if a value has not been specified for the “USE” attribute of the XMT-A node element, standard XML means are used to create a new mp4bifs NodeName element, where “NodeName” represents the name of the current XMT-A BIFS node element. Standard XML means are used to insert the new “NodeName” element into the current mp4bifs target element. For example, if the element name for the current XMT-A BIFS node element is “Geometry”,then a new mp4bifs “Geometry” element is created and inserted into the current mp4bifs target element.

If a value has been specified for the “DEF” attribute of the XMT-A BIFS node element, the value of the “DEF” attribute” is compared to the entries 3966 in the BIFS NodeId table (see FIG. 39B). The value of the “position” 3960 of the matching entry is assigned to the integer quantity nodeId and the result is incremented by “1”. The result is then assigned to the “nodeId” attribute of the mp4bifs “NodeName” element. If the boolean quantity “bUseNames” is true, then the value of the “DEF” attribute of the XMTA BIFS node element is assigned to the “name” attribute of the mp4bifs NodeName element.

The values of all other attributes of the XMT-A BIFS node element are used to assign values to like-named attributes of the new mp4-bifs NodeName element. In most cases, the value assigned to each attribute of the mp4bifs NodeName element is equal to the value of the corresponding attribute of the XMT-A BIFS node element. In certain cases identified below (Data format conversions), the value assigned to an attribute of the mp4bifs NodeName element is derived from the value of the corresponding attribute of the XMT-A BIFS node element.

At operation 4826, the value “0” is assigned to the index “i” which is distinct from other index values defined elsewhere.

At operation 4830, the value of the index “i” is compared to the value of the quantity “numNodeChildren”. The value of the quantity numNodeChildren indicates the number of subordinate elements possessed by the current XMT-A BIFS node element. A non-zero value of numNodeChildren is possible only for an XMT-A BIFS node element representing an MPEG-4 BIFS node having a data field or fields with field data type(s) of “Node” or “Command Buffer”.

At operation 4836, if the value of the index “i” is equal to the value of numNodeChildren, this procedure is completed and processing continues with the XMT-A BIFS command element or parent XMT-A BIFS node element that possessed this XMT-A node element.

At operation 4840, if the value of the index “i” is not equal to the value of numNodeChildren, standard XML means are used to obtain the ith element subordinate to the current parent element and the resulting subordinate element is identified as the “nodeChild” element. The element name of the nodeChild element is identified by the string quantity “childName”. The value of the quantity “childName” will match the field name of an MPEG-4 BIFS node data field with a with field data type of “Node” or “Command Buffer”.

At operation 4846, standard XML means are used to obtain the element names of all elements subordinate to the nodeChild element. The values of each of these element names are concatenated together, separated by blank spaces, into a string quantity “NameList”. The value of the resulting string quantity “NameList” is assigned to the childName attribute of the current mp4bifs NodeName element. For example, if the value of childName is “children”,a list of element names for the XMT-A elements subordinate to the XMT-A “children” element will be assigned to the “children” attribute of the current mp4bifs NodeName element.

At operation 4850, the value “0” is assigned to the index “j” which is distinct from other index values defined elsewhere.

At operation 4856, the value of the index “j” is compared to the value of the quantity “numNodeChildChildren”. The value of the quantity numNodeChildChildren indicates the number of subordinate elements possessed by the current “nodeChild” element.

At operation 4860, if the value of the index “j” is equal to the value of numNodeChildChildren, the value of the index “i” is incremented by “1” and the comparison to numNodeChildren at operation 4830 is repeated.

At operation 4866, if the value of the index “j” is not equal to the value of numNodeChildChildren, standard XML means are used to obtain the j-th element subordinate to the current nodeChild element and the resulting subordinate element is identified as the “attributeChild” element. The element name of the attributeChild element is identified by the string quantity “attributeChildName”.

At operation 4866, the value of the string quantity childName is compared to the string “buffer”.

At operation 4870, if the value of the string quantity childName is “buffer”,the procedure “Process XMT-A command” is performed. Standard XML means are then used to append the resulting newCommand element to the current mp4-bifs NodeName element. The procedure “Process XMT-A command” is equivalent to operations 4360 to 4386 of the procedure “Process XMT-A par element (Pass 2)” shown in FIG. 43, using the value of attributeChildName as the value of childName. This is a recursive process because the current procedure is always subordinate to the procedure “Process XMT-A par element (Pass 2)”. This procedure then continues with operation 4890.

At operation 4880, if the value of the string quantity childName is not “buffer”,the procedure “Process XMT-A BIFS node” is performed recursively. Standard XML means are then used to append the resulting NodeName element to the current mp4-bifs NodeName element.

At operation 4890, the value of the index “j” is incremented by “1” and the comparison to numNodeChildChildren at operation 4856 is repeated.

### 7.1.7.11 Data Format Conversions

Data format conversions are applied to the following property field attributes of an XMTA BIFS node: These conversions are also applied to the values of the “value” attribute of XMT-A Insert command elements operation 4430 and XMT-A Replace command elements operation 4624. In the cases of XMT-A Insert and Replace commands, the data type is determined by the value of the corresponding atField attribute.

1. Each XMTA attribute value for field properties having data type “color” is represented by a six-digit hexadecimal string, “#RRGGBB”. This is converted to a three-part decimal representation, “rrr ggg bbb” where “rrr” is a decimal representation of the hexadecimal value 0×RR divided by 256, “ggg” is a decimal representation of the hexadecimal value 0×GG divided by 256, and “bbb” is a decimal representation of the hexadecimal value 0×BB divided by 256.

2. Each XMTA attribute value for field properties having data type “string” is converted from a quoted string format defined for XMTA to an alternative format used by mp4bifs. This conversion includes removal of “quote” characters (“) unless preceded by a backslash character (\), replacement of blank spaces and other “special” characters within strings by a percent character (%) followed by a two-digit hexadecimal code, and separation of multiple strings by blank spaces. The “special” characters include blank spaces, quotes, percent (%), ampersand (&), greater than (>), characters with numerical values less than 32, and characters with numerical values greater than 127. Blank spaces are then used to separate individual strings within an attribute field composed of two or more strings. This conversion of string attributes is not required by this invention and this may be omitted in alternative embodiments of this invention.

3. If an XMTA attribute value for a field property having data type “url” starts with “od://” or “odid://”,the value assigned to the corresponding mp4bifs attribute is given by “Odid:” followed by the index of the entry 3900 in the Object Table (see FIG. 39A) having an ObjectDescriptorID 3910 matching the remainder of the XMTA url attribute value (following “od://” or “odid://”).

### 7.1.8 Insert Command Frames into mp4bifs Document

After completing the second pass operation 3130 over elements of the XMTA “Body” element 120, the contents of the temporally ordered list of commandFrame elements 2830 are inserted into the mp4bifs document 2800. Any empty commandFrame elements are discarded, and multiple commandFrame elements with the same value for the “time” attribute are consolidated into a single commandFrame element.

The value of the “duration” attribute of the “moov” element of the mp4file document is then updated based on the time value for the last commandFrame element 2830. The value assigned to this attribute is determined by the product of the value in seconds obtained from the last commandFrame element and the timeScale attribute of the “moov” element 2320. The “duration” attribute of the “trak” element 2350 and 2600 for the sdsm data, and the “duration” attribute for the “mdia” element 2604 subordinate to this “trak” element 2600 are each updated in a similar manner.

### 7.1.9 Insert OD Commands into mdat Element for odsm

If the XMTA document was found to contain any media objects, the object table (see FIG. 39A) created in the first pass over the XMTA “Body” element operation 3120 is used to construct an XML description of the odsm (object descriptor stream). If this table has no entries, then the odsm does not exist and this step is skipped. If the object table has at least one entry, this table is used to create a sorted object table, as shown in FIG. 39E.

Each entry (row) 3990 in the sorted object table consists of an OdId value 3992 corresponding to an ObjectDescriptorId entry 3920 in the object table, a time value 3994, and a boolean flag (start) 3996.

The sorted object table contains two entries 3990 for each entry 3900 in the object table. The value of each entry in the OdId column 3992 is a copy of the value found in the corresponding entry 3920 in the object table. The value of the entry in the time column 3994 is a copy of the value found in the corresponding entry in either the startTime column 3830 or the stopTime column 3940 in the object table. If the entry in the time column 3994 of the sorted object table was derived from the corresponding entry in the startTime column 3930 of the object table, the value “true” is assigned to the corresponding entry in the start column 3996 of the sorted object table. Otherwise, the value “false” is assigned to the corresponding entry in the start column 3996 of the sorted object table.

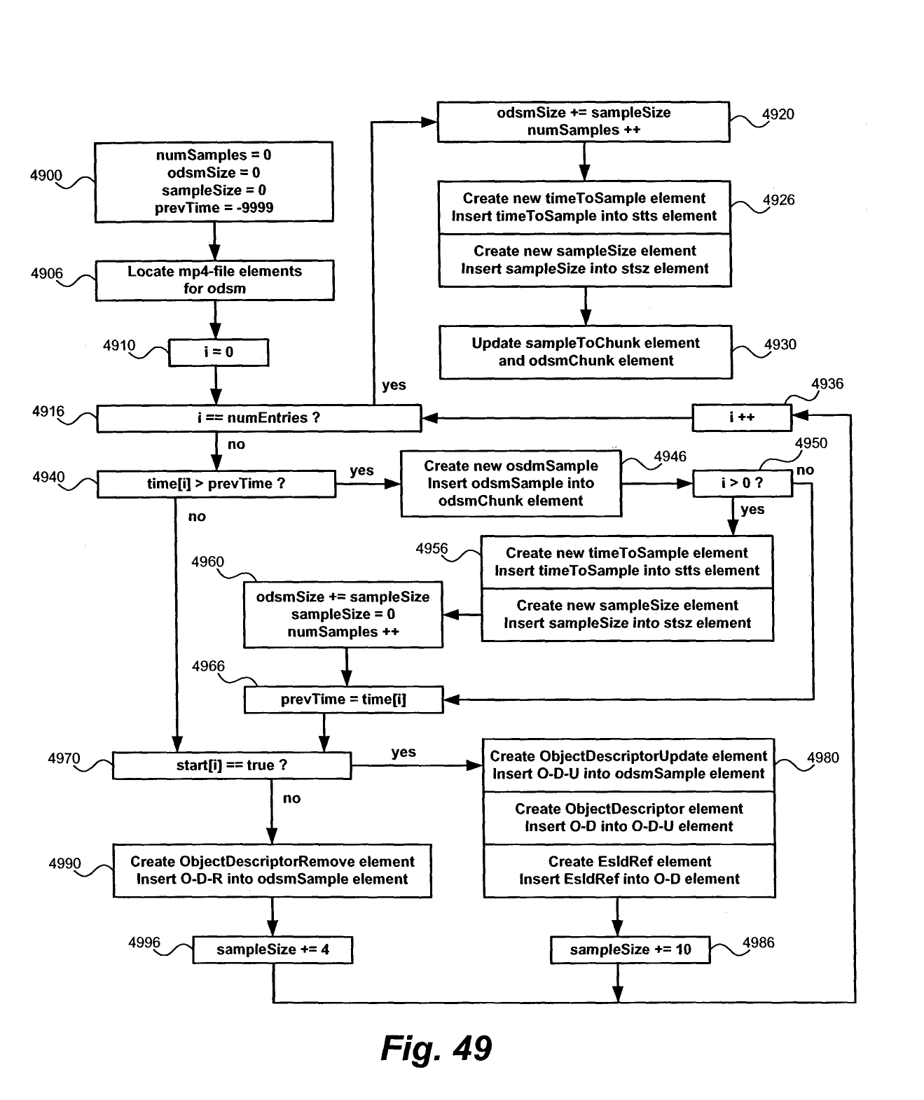

The entries in the sorted object table are sorted in order of increasing time values 3994. After creation of the sorted object table, an XML representation of the odsm is created as shown in FIG. 49.

At operation 4900, the value “0” is assigned to the integer quantities “numSamples”, “odsmSize” and “sampleSize”. A negative value is assigned to the floating point quantity “prevTime”.

At operation 4906, standard XML means are used to locate the “odsmChunk” element 2470 in the “mdat” element 2310 and 2400 for the odsm. Standard XML means are used to locate the “stts” element 2660, the “stsz” element 2668, and the “stsc” element 2656 within the “trak” element 2350 and 2600 previously created for the odsm. Standard XML means are used to locate the “sampleToChunk” element subordinate to this “stsc” element 2656. These elements have all been created previously while processing the XMTA “Header” element 3116.

At operation 4910, the value “0” is assigned to the index “i” which is distinct from other index values defined elsewhere.

At operation 4916, the value of the index “i” is compared to the value of the quantity “numEntries”. The value of the quantity numEntries indicates the number of rows in the sorted object table 3990.

At operation 4940, if the value of the index “i” is not equal to the value of numEntries, the value of the i-th entry in the time column 3994 in the sorted object table is compared to the current value of the quantity prevTime.

At operation 4946, if the value of the i-th entry in the time column 3994 in the sorted object table is greater than the current value of the quantity prevTime, standard XML means are used to create a new mp4file odsmSample element. Otherwise, processing continues with operation 4970.

Standard XML means are then used to insert the new odsmSample element into the odsmChunk element obtained at operation 4906. The current value of the quantity odsmSize is assigned to the “offset” attribute of the new odsmSample element, and the value of the “time” column 3994 for the current entry (“i”) in the sorted object table is assigned to the “time” attribute of the new odsmSample element.

At operation 4950, the value of the index “i” is compared to “0”.

At operation 4956, if the value of the index “i” is greater than zero, standard XML means are used to create a new mp4file timeToSample element. Otherwise, processing continues with operation 4966.

Standard XML means are then used to insert the new timeToSample element into the stts element obtained in operation 4906. The difference between the time value 3994 for the current entry in the sorted object table and the value of the quantity “prevTime” is assigned to the “duration” attribute of the new timeToSample element. The value “1” is assigned to the “numSamples” attribute of the new “timeToSample” element.

Standard XML means are used to create a new mp4file sampleSize element. Standard XML means are then used to insert the new sampleSize element into the stsz element obtained in operation 4906. The value of the quantity sampleSize is assigned to the “size” attribute of the new “sampleSize” element.

At operation 4960, the value of the quantity odsmSize is incremented by the value of the quantity sampleSize, the value “0” is assigned to the value of the quantity sampleSize, and the value of the quantity numSamples is incremented by “1”.

At operation 4966, the value of the i-th entry in the time column 3994 in the sorted object table is assigned to the quantity “prevTime”.

At operation 4970, the value of the i-th entry in the start column 3996 in the sorted object table is compared to the value “true”.

At operation 4980, if the value of the i-th entry in the start column 3996 in the sorted object table has the value “true”,standard XML means are used to create a new mp4file ObjectDescriptorUpdate element 2540. Standard XML means are then used to insert the new ObjectDescriptorUpdate element 2540 into the odsmSample element 2510 created in operation 4946.

Standard XML means are used to create a new mp4file ObjectDescriptor element 2550. Standard XML means are then used to insert the new ObjectDescriptor element 2550 into the new ObjectDescriptorUpdate element 2540. The value of the quantity “OdId” 3992 associated with the current entry in the sorted object table is assigned to the “OdId” attribute of the new ObjectDescriptor element 2950.

Standard XML means are used to create a new mp4file EsIdRef element 2560. Standard XML means are then used to insert the new EsIdRef element 2560 into the new ObjectDescriptor element 2550. The value of the “EsId” entry in operation 3950 in the object table (see FIG. 39A) associated with the “OdId” value 3920 matching the OdId value 3993 for the current entry in the sorted object table is assigned to the “EsId” attribute of the “EsIdRef” element 2560.

At operation 4986, the value of the quantity sampleSize is incremented by “10”.

At operation 4990, if the value of the i-th entry in the start column 3996 in the sorted object table does not have the value “true”, standard XML means are used to create a new mp4file ObjectDescriptorRemove element 2570. Standard XML means are then used to insert the new ObjectDescriptorRemove element 2570 into the odsmSample element 2510 created in operation 4946. The value of the quantity “OdId” 3992 associated with the current entry in the sorted object table is assigned to the “OdId” attribute of the new ObjectDescriptorRemove element 2950.

At operation 4996, the value of the quantity sampleSize is incremented by “4”.

At operation 4936, the value of the index “i” is incremented by “1” and the comparison of the index “i” to the value numEntries is repeated.

At operation 4920, if the value of the index “i” is equal to the value of numEntries, the value of the quantity “odsmSize” is incremented by the value of sampleSize, and the value of the quantity numSamples is incremented by “1”.

At operation 4926, standard XML means are used to create a new mp4file timeToSample element. Standard XML means are then used to insert the new timeToSample element into the stts element obtained in operation 4906. The difference between the time value 3994 for the current entry in the sorted object table and the value of the quantity “prevTime” is assigned to the “duration” attribute of the new timeToSample element. The value “1” is assigned to the “numSamples” attribute of the new “timeToSample” element.

Standard XML means are used to create a new mp4file sampleSize element. Standard XML means are then used to insert the new sampleSize element into the stsz element obtained in operation 4906. The value of the quantity sampleSize is assigned to the “size” attribute of the new “sampleSize” element.

At operation 4930, the value of the quantity “numSamples” is assigned to the “sampleToChunk” element. The value of the quantity odsmSize is assigned to the “size” attribute of the “odsmChunk” element.

### 7.1.10 Update bifsConfig for mp4-bifs and mp4-file Documents

The minimum number of bits required to represent the number of entries in the BIFS NodeID table (see FIG. 39B) is determined and assigned to the quantity “numNodeIdBits”. This is the smallest number “n” such that 2 raised to the power “n” is greater than the number of entries in this table. The value of the quantity numNodeIdBits is assigned to the “nodeIdBits” attribute of the “bifsConfig” element (2810) created in step 2. This values is also assigned to the “nodeIdBits” attribute of the “BIFS_DecoderConfig” element 2720 contained in the “trak” element 2350 and 2600 for the sdsm (scene description stream) created in step 4.

In a similar manner, the minimum number of bits required to represent the number of entries in the BIFS RouteeID table (see FIG. 39C) is determined and assigned to the quantity “numRouteIdBits”. The value of the quantity numRouteIdBits is assigned to the routeIdBits attribute of the “bifsConfig” element 2810 created in step 2. This values is also assigned to the routeIdBits attributes of the “BIFS_DecoderConfig” element 2720 contained in the “trak” element 2350 and 2600 for the sdsm (scene description stream) created in step 4.

This step completes the creation of the mp4-file document and mp4-bifs document. The process of creating an mp4 binary file continues with “3.b. Creation of an mp4 binary file based on the intermediate XML documents”

### 7.1.10.1 Process ES Descriptor

Each “ES_Descriptor” element is processed as shown in FIG. 34. This procedure is used to process ES_Descriptor elements 630 contained within the Body element 120 of an XMT-A document 100 as well as ES_Descriptor elements 180 and 190 contained within the Header element 110 of an XMT-A document 100.

Each “ES_Descriptor” element possesses an attribute named as “ES_ID” and the value of this attribute is assigned to a string quantity “ES_DescriptorId”.

The procedure “Process ES_Descriptor” starts with the procedure “Process decConfigDescr element” in operation 3400. This procedure consists of the following four steps:

1. Standard XML means are used to obtain the decConfigDescr element 646 subordinate to the ES_Descriptor element 640.

2. Standard XML means are used to obtain the DecoderConfigDescriptor element 650 subordinate to the decConfigDescr element 646.

3. The value of the “streamType” attribute of the DecoderConfigDescriptor element 650 is used to establish a numerical value for the streamType property of the data stream described by this ES_Descriptor element. The value of the “streamType” attribute may consist of a numerical value or one of a set of alphanumeric strings defined in tables in the MPEG-4 systems specifications. These defined strings include “ObjectDescriptor”, “SceneDescription”, “Visual”, “Audio”,etc. If the value of the “streamType” attribute matches one of these strings, a numerical value is assigned to streamType based on the associated entry in the MPEG-4 tables. For example, if the value of the “streamType” attribute is “ObjectDescriptor”,the value 1 is assigned to iStreamType. Otherwise, the value of the “streamType” attribute must represent a numerical value and this numerical value is assigned to the streamType property for this stream.

4. The value of the “objectTypeIndication” attribute of the DecoderConfigDescriptor element is used to establish a numerical value for the “objectType” property of the data stream described by this ES_Descriptor element. The value of the “objectTypeIndication” attribute may consist of a numerical value or one of a set of alphanumeric strings defined in tables in the MPEG-4 systems specifications. These defined strings include “MPEG4Systems1”, “MPEG4Visual”, “MPEG4Audio”, “Unspecified”,etc. If the value of the “objectTypeIndication” attribute matches one of these strings, a numerical value is assigned to iObjectTypebased on the associated entry in the MPEG-4 tables. For example, if the value of the “objectTypeIndication” attribute is “Unspecified”,the value 255 is assigned to iObjectType. Otherwise, the value of the “objectTypeIndication” attribute must represent a numerical value and this numerical value is assigned to the objectType property of this stream.

Following the procedure “Process decConfigDescr element” (3400), the procedure “Process ES_Descriptor” continues with the procedure “Process slConfigDescr element” in operation 3410. This procedure consists of the following three steps:

1. Standard XML means are used to obtain the “slConfigDescr” element 660 subordinate to the “ES_Descriptor” element 640.

2. Standard XML means are then used to obtain the “SLConfigDescriptor” element 666 subordinate to the “slConfigDescr” element 660.

3. The value of the “timeStampResolution” attribute of the “SLConfigDescriptor” 666 is used to assign a numerical value to the timeScale property of this stream. If a value is not specified for the “timeStampResolution” attribute, a default value is assigned to timeScale. This default value is 1000 for all streams except MPEG-4 visuals (iStreamType=4 and iObjectType=32) in which case the default timeScale value is 30.

Following the procedure “Process slConfigDescr element” in operation 3410, the procedure “Process ES_Descriptor” continues with the procedure “Process StreamSource element” in operation 3420.

In the case of an ES_Descriptor 630 contained within the XMT-A Body element 120, the procedure “Process ES_Descriptor” consists of the following two steps:

1. Standard XML means are used to obtain the “StreamSource” element subordinate to the “ES_Descriptor” element.

2. The value of the “url” attribute of this “StreamSource” element is assigned to a quantity named “mediaFileName”.

In the case of an ES_Descriptor 180 and 190 contained within the XMT-A Header element 110, a StreamSource element will not be present and the value of the quantity “sdsmFileName” is assigned to the quantity “mediaFileName”.

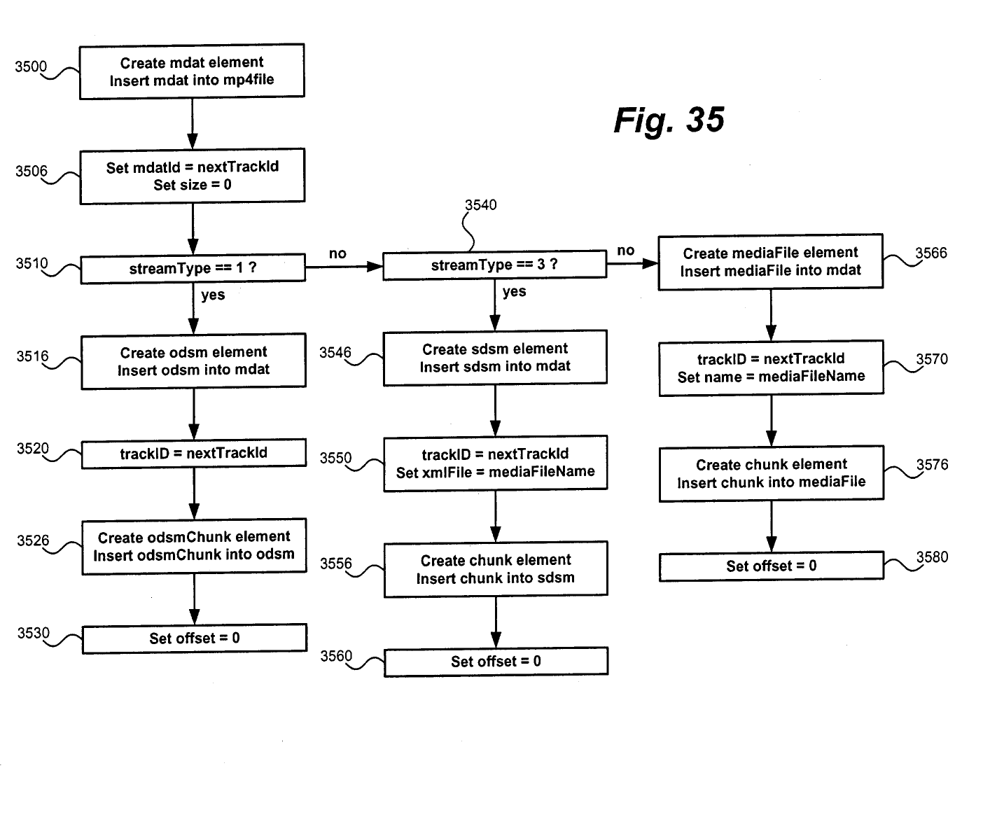

Following the procedure “Process StreamSource element” in operation 3420, the procedure “Process ES_Descriptor” continues with the procedure “Create mdat element for the specified stream” in operation 3430. As shown in FIG. 35, the procedure “Create mdat element for the specified stream” 3430 consists of the following steps:

1. Operation 3500: Standard XML means are used to create a new “mdat” element 2310 and insert it into the mp4file document 2300 preceding the previously created “moov” element 2320.

2. Operation 3506: The current value of the quantity “nextTrackId” is assigned to the “mdatId” attribute of the new mdat element 2320. The “size” attribute of this element is assigned a value of zero (“0”).

3a. Operation 3510: The streamType property established by the procedure “Process decConfigDescr element” operation 3400 is compared to the value “1”.

4a. If the value of the streamType property is “1”, at operation 3516 a new “odsm” element 2420 and 2460 is created and inserted into the new “mdat” element 2310 and 2400, at operation 3520 the current value of the quantity “nextTrackId” is assigned to the “trackID”attribute of this new “odsm” element 2420, at operation 3526 a new “odsmChunk” element 2470 is created and inserted into the new “odsm” element 2460, and at operation 3530 the value zero is assigned to the “offset” attribute of the new “odsmChunk” element 2470.

3b. Operation 3540: If the value of the streamType property is not “1”, the value of the streamType property is compared to the value “3”.

4b. If the value of the streamType property is “3”, at operation 3546 a new “sdsm” element 2410 and 2440 is created and inserted into the “mdat” element 2310 and 2400. At operation 3550 the current value of the quantity “nextTrackId” is assigned to the “trackID” attribute of this new sdsm element 2410 and the value of the quantity “mediaFileName is assigned to the “xmlFile” attribute of the new sdsm element 2410. At operation 3556, a new “chunk” element 2450 is created and inserted into the new “sdsm” element 2440. At operation 3560, the value zero is assigned to the “offset” attribute of the new “chunk” element 2450.

4c. Operation 3566: If the value of the streamType property is neither “1” nor “3”, a new “mediaFile” element 2430 and 2480 is created and inserted into the new “mdat” element 2310 and 2400. At operation 3570, the current value of the quantity “nextTrackId” is assigned to the “trackID” attribute of the new “mediaFile” element 2430. At operation 3576, a new “chunk” element 2490 is created and inserted into the new “mediaFile” element 2480. At operation 3580, the value zero is assigned to the “offset” attribute of the new “chunk” element 2480.

The process of assigning the value zero to the “offset” attribute operations 3530, 3560, and 3580 completes the procedure “Create mdat element for the specified stream” 3430. Following this procedure 3430, the procedure “Process ES_Descriptor” continues with the procedure “Create trak element for the specified stream” 3440. This procedure is described below under “Create trak element”. Following this procedure 3440, the procedure “Process ES_Descriptor” 3340 continues with the test “Is specified stream sdsm or odsm?” 3450.

If the current stream is an odsm (the value of streamType is 1) or sdsm (the value of streamType is 3), at operation 3460 a new “EsIdInc” element 2380 is created and appended to the “mp4fiods” element 2360 in the mp4file document 2300. The value of the quantity “nextTrackID” is then assigned to the “trackID” attribute 2390 of the new “EsIdInc” element 2380.

Otherwise (the value of the quantity “streamType” is not “1” or “3”), at operation 3470 the value of the quantity “nextTrackID” is appended to the value of the “trackID” element of the “mpod” element 2640 in the “tref” element 2636 in the “trak” element 2600 for the odsm. The value of the quantity “nextTrackID” is also assigned to an entry in the “OdId” column 3920 of the object table created in the first pass over the XMT-A “Body” element. This entry corresponds to the row in which the value of the “ObjectDescriptorID” entry 3910 matches the “objectDescriptorId” attribute 606 of the “ObjectDescriptor” element 600 which contains this “ES_Descriptor” element 636. The value of the quantity “nextEsId” is assigned to the EsId entry 3950 in the same row of this table. The value of the quantity “nextEsId” is then incremented by one.

In either case, at operation 3480 the value of the quantity nextTrackID is then incremented by one and the new value of the quantity nextTrackID is assigned to the “nextTrackID” attribute of the “moov” element 2320.

This completes the processing of an “ES_Descriptor” element shown in FIG. 34. This procedure is performed for each “ES_Descriptor” 180 and 190 element found within a “Descr” 160 element within the “InitialObjectDescriptor” element 130 in the “Header” element 110 of an XMT-A document 100. This process is also performed for each “ES_Descriptor” element 630 found within a “Descr” 610 element within an “ObjectDescriptor” element 600 found within the “Body” element 120 of an XMT-A document 100.

Following the completion of this procedure (Process ES_Descriptor), the process of creating the mp4file document 2250 continues with the step of incrementing the value of the index “i” at operation 3350 in the procedure “Process esDescr element” shown in FIG. 33.

### 7.1.10.2 Create Trak Element

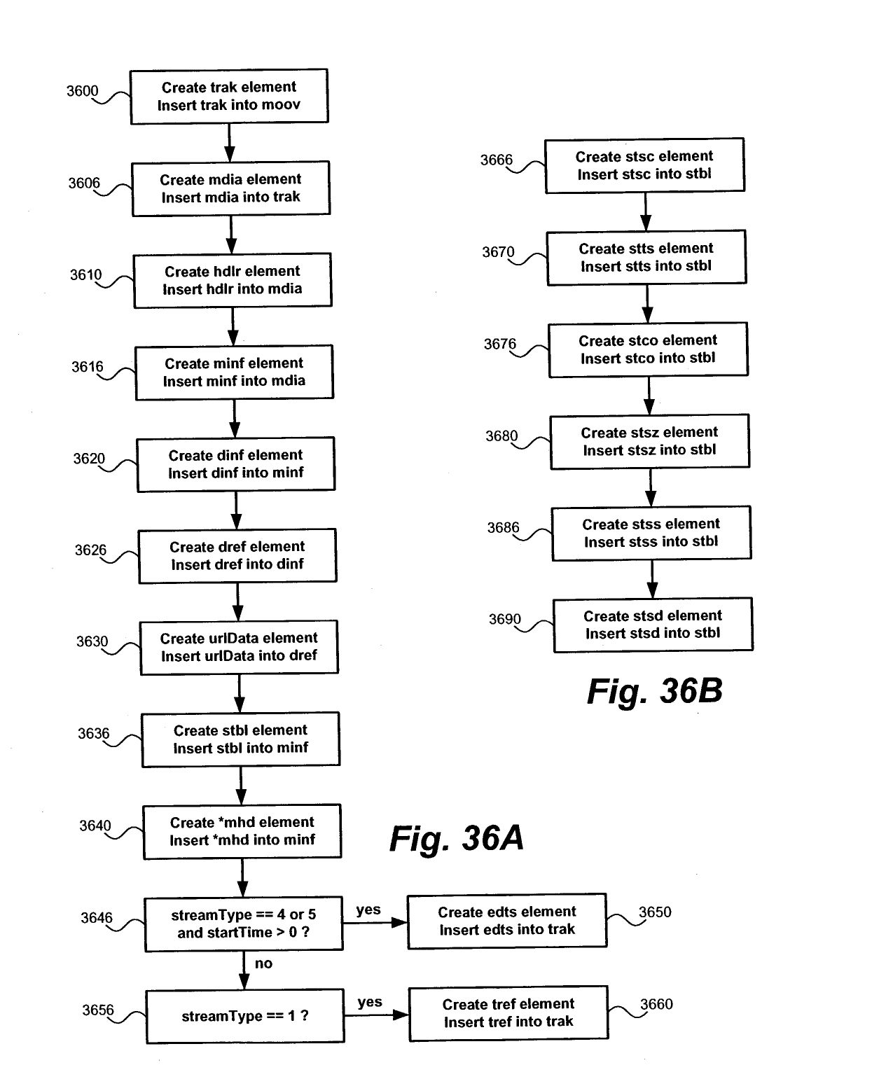

As shown in FIG. 36A, the procedure “Create trak element for the specified stream” 3440 consists of the following eleven steps:

1. At operation 3600, standard XML means are used to create a new “trak” element 2350 and 2600 and insert it into the “moov” element 2320 in the mp4file document 2300.

Values are assigned to the following attributes of the new trak element 2600: The value “1” is assigned to the “flags” attribute. A value equal to the number of seconds since Jan. 1, 1904 is assigned to the “creationTime” and “modifyTime” attributes. The value of the quantity nextTrackId is assigned to the trackID attribute. The value “240” is assigned to the “trackHeight” attribute. The value “320” is assigned to “trackWidth” attribute.

If the value of the streamType property is “1” or “3”, the value “0” is assigned to the duration attribute. These are only preliminary values to be replaced by corrected values determined later. Otherwise, the objectDescriptorID of the enclosing ObjectDescriptor element 600 is used to obtain the corresponding media duration value from a table constructed during the first pass operation 3120 over the Body element 120 of the XMT-A document 100. The media duration value (in seconds) is multiplied by the timeScale value derived from the “SLConfigDescriptor” element 666 and rounded to an integer value.

If the value of the streamType property is “1” (object descriptor stream), the value of the trackID attribute is assigned to the quantity trackIdForOdsm. If the value of the streamType property is “3” (scene description stream), the value of the trackID attribute is assigned to the quantity trackIdForSdsm

2. At operation 3606, standard XML means are used to create a new “mdia” element 2604 and insert it into the new “trak” element 2600 created in Step 1.

Values are assigned to the following attributes of this new “mdia” element 2604: A value equal to the number of seconds since Jan. 1, 1904 is assigned to the “creationTime” and “modifyTime” attributes. This is the same value used for corresponding attributes of the parent trak element 2600. The timeScale value derived from the “SLConfigDescriptor” element 666 is assigned to the “timeScale” attribute. The duration value assigned to the parent trak element 2600 is assigned to the duration attribute.

3. At operation 3610, standard XML means are used to create a new “hdlr” element 2608 and insert it into the new “mdia” element 2604 created in Step 2.

Values are assigned to the following attributes of the “hdlr” element: “handlerType” and “name”. The value assigned to the “handlerType” attribute depends on the streamType. If streamType equals 1 (osdm), 3 (sdsm), 4 (visual stream), or 5 (audio stream), the value “odsm”, “sdsm”, “soun”, or “vide” is assigned to the “handlerType” attribute. Otherwise, the value “none” is assigned to the “handlerType” attribute. The value assigned to the “name” attribute is a copy of the string “Es_DescriptorId” determined by the ES_ID attribute of the enclosing XMT-A ES_Descriptor element 180, 190, or 630. This choice for the “name” attribute is not necessary, but this choice makes it possible to retain and propagate the value of the ES_ID attribute string in the mp4 document and subsequent files.

4. At operation 3616, standard XML means are used to create a new “minf” element 2612 and insert it into the new “mdia” element 2604 created in Step 2.

5. At operation 3620, standard XML means are used to create a new “dinf” element 2616 and insert it into the new “minf” element 2612 created in Step 4.

6. At operation 3626, standard XML means are used to create new “dref” element 2620 and insert it into the new “dinf” element 2616 created in Step 5.

7. At operation 3630, standard XML means are used to create new “urlData” element 2624 and insert it into the new “dref” element 2620 created in Step 6. A value of “1” is assigned to the “flags” attribute of the “urlData” element 2624.

8. At operation 3636, standard XML means are then used to create a new “stbl” element 2628 and 2652 and insert it into the “minf” element 2612 created in Step 4. Preliminary forms of the constituent sample table elements are created as described below under “Creation of preliminary sample table elements”.

9. At operation 3640, standard XML means are used to create a new media header element 2632 and insert it into the “minf” element 2612 created in Step 4. The element name for the media header element depends on the streamType property of this stream:

If streamType property is 1 (odsm) or 3 (sdsm), the media header element is an “nmhd” element with no attributes.

If streamType property is 4 (visual stream), the media header element is a “vmhd” element with attribute “transferMode” having the value “0”.

If streamType property is 5 (audio stream), the media header element is an “smhd” element with attribute “balance” having value “0”.

Otherwise, the media header element is a “gmhd” element having attribute “transferMode” with value “0” and attribute “balance” with value “0”.

10. At operation 3646, the value of the streamType property is compared the values 4 and 5, and the value of the quantity startTime is compared to zero.

In the case of an audio or visual stream, this operation is performed during the procedure “Process XMT-A Body element (pass 2)” 3130. In this case, the value of the quantity “startTime” is obtained from the object tables (see FIG. 39A) created in the procedure “Process XMT-A Body element (pass 1)” 3120. This value is determined by the entry in the startTime column for the row in which the entry for the ObjectDescriptorID column matches the “objectDescrptorId” attribute of the “ObjectDescriptor” element that contains this “ES_Descriptor” element.

In the case of the odsm and sdsm, this operation is performed during the procedure “Process XMT-A Header element” 3116. The object tables used to establish the value of the quantity startTime have not yet been created for those streams. Consequently, the corresponding test for the startTime value for the odsm stream is performed as part of a separate step “Create edit list for odsm” 3126. The sdsm always starts at time zero.

If the value of the streamType property is 4 (visual stream) or 5 (audio stream), and the value of the quantity “startTime” for the stream is not zero, at operation 3650 standard XML means are used to create a new “edts” (edit list) element 2644 and insert it into the current “trak” element 2400. Standard XML means are used to create a new “elst” element 2648 and insert it into the new “edts” element 2644. Two new “segment” elements are then created and inserted into the “elst” element 2648.

Each “segment” element is assigned attributes named “startTime”, “duration”, and “rate”. The value “−1” is assigned to the “startTime” attribute of the first segment element. The value “0” is assigned to the “startTime” attribute of the second segment element. The value “1.0” is assigned to the “rate” attribute of the both segment elements. The value of the “duration” attribute of the first segment is assigned a value determined by the product of the startTime value for this stream and the value of the “timeScale” attribute of the encapsulating moov element. The value of the “duration” attribute of the second segment is assigned a value determined by the product of the duration value for this stream and the value of the “timeScale” attribute of the encapsulating moov element. The duration value for this stream is determined by the difference between a “stopTime” value and a “startTime” value obtained from the object tables (see FIG. 39A) created in the first pass over the XMT-A “Body” element. These values are determined by the entries in the corresponding columns of the row in which the entry for the ObjectDescriptorID column matches the “objectDescrptorId” attribute of the “ObjectDescriptor” element which contains this “ES_Descriptor” element.

11. At operation 3656, the value of the streamType property is compared to “1”. If the streamType is 1 (odsm), at operation 3660 standard XML means are used to create a new “tref” element 2636 and insert it into the “trak” element 2600 created in Step 1. A new “mpod” element 2640 is created and inserted into the new “tref” element 2636. The value “−1” is assigned to the “trackID” attribute of the “mpod” element 2640. This is a temporary value to be replaced by data obtained later.

This step 3656 completes the procedure “Create trak element for the specified stream” 3440. Following this procedure, the procedure “Process ES_Descriptor” 3340 continues with the test “Is specified stream sdsm or odsm?” 3450.

### 7.1.10.3 Creation of Preliminary Sample Table Elements

Each of the sample tables in the final mp4 binary file 2230 contains information which depends on the binary forms of the sdsm, odsm, and media data files. The information necessary to determine the values in these tables is not available at this point. Consequently, as shown in FIG. 36B, preliminary representations of these tables are created to indicate where the final values will be placed when the actual mp4 binary file 2230 is created.

At operation 3666, standard XML means are used to create a new “stsc” element 2656 and insert it into the “stbl” element 2628 and 2652 for the current trak element 2600. Standard XML means are used to create a new “sampleToChunk” element and insert it into the new “stsc”element 2656. A value of “1” is assigned to the “sampleDesc” attribute of the new “sampleToChunk” element. A value of “1” is assigned to the “firstChunk” attribute of the new “sampleToChunk” element. If the streamType property of this stream is 1 or 3 (odsm or sdsm), a value of “0” is assigned to the “numSamples” attribute of the new “sampleToChunk” element. If the objectType property for this stream 108 (JPEG image), a value of “1” is assigned to the “numSamples” attribute of the new “sampleToChunk” element. Otherwise, a value of “−1” is assigned to the “numSamples” attribute of the new “sampleToChunk” element.

At operation 3670, standard XML means are used to create a new “stts” element 2660 and insert it into the “stbl” element 2628 and 2652 for the current trak element 2600. If the current streamType property is not 1 (odsm) and not 3 (sdsm), standard XML means are used to create a new “timeToSample” element and insert it into the new “stts” element 2660. The duration value specified in the “trak” element is assigned to the “duration” attribute of this “timeToSample” element. If the objectType property for this stream 108 (JPEG image), a value of “1” is assigned to the “numSamples” attribute of this “timeToSample” element. Otherwise, a value of “−1” is assigned to the “numSamples” attribute of the new “timeToSample” element.

At operation 3676 Standard XML means are used to create a new “stco” element 2664 and insert it into the “stbl” element 2628 and 2652 for the current trak element 2600. Standard XML means are used to create a new “chunkOffset” element and insert it into the new “stco” element 2664. The current value of nextTrackId is assigned to the “mdatId” attribute of this “chunkOffset” element. A value of “0” is assigned to the “mdatOffset” attribute of this “chunkOffset” element. A value of “8” is assigned to the “offset” attribute of this “chunkOffset” element.

At operation 3680, standard XML means are used to create a new “stsz” element 2668 and insert it into the “stbl” element 2628 and 2652 for the current trak element 2600. If the streamType property of this stream is not 1 (odsm) and not 3 (sdsm), a value is assigned to the “numSamples” attribute of the new “stsz” element 2668. If the objectType property for this stream 108 (JPEG image), a value of “1” is assigned to the “numSamples” attribute of the new “stsz” element 2668. Otherwise, a value of “−1” is assigned to the “numSamples” attribute of the new “stsz” element 2668.

At operation 3686, if the streamType property is 1 (odsm) or 3 (sdsm), standard XML means are used to create a new “stss” element (2672) and insert it into the “stbl” element 2628 and 2652 for the current trak element 2600. If the streamType property is 1, the value “1” is assigned to the “numEntries” attribute of the new “stss” element 2672, and a new “syncSample” element is created and inserted into the new “stss” element 2672. The value “0” is then assigned to the “sampleNumber” attribute of this “syncSample” element. If the streamType property is 3, the value “0” is assigned to the “numEntries” attribute of the new “stss” element 2672.

If the streamType property is 4 and the objectType property is 32 (MPEG-4 video), standard XML means are used to create a new “stss” element 2672 and insert it into the “stbl” element 2628 and 2652 for the current trak element 2600, and the value “−1” is assigned to the “numEntries” attribute of new “stss” element 2672.

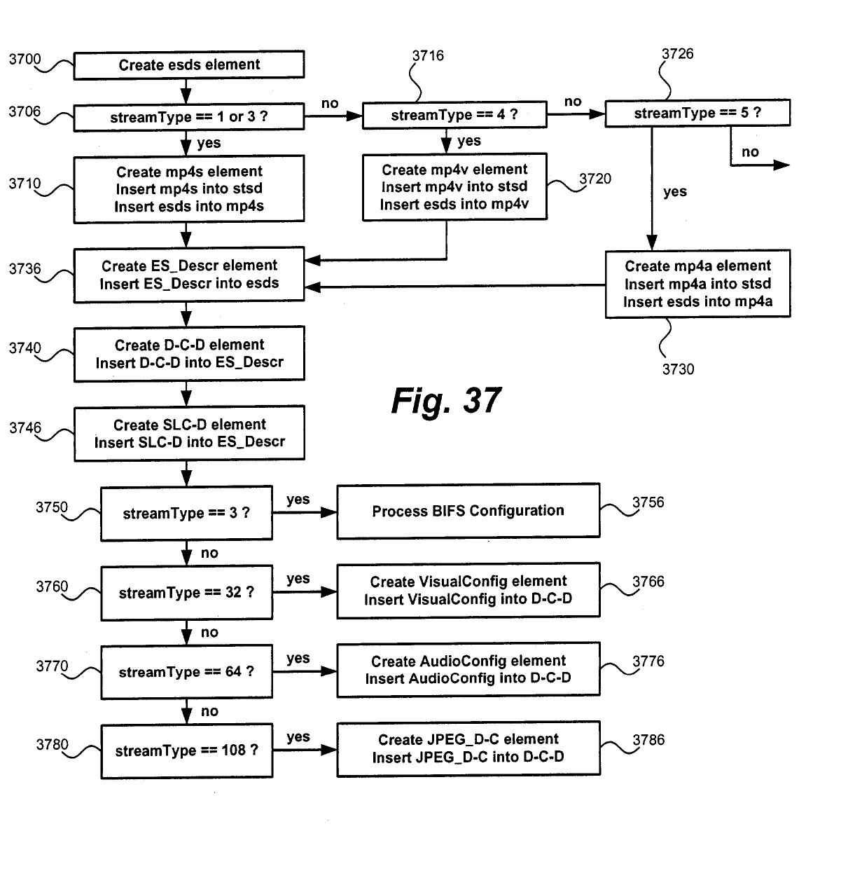

At operation 3690, standard XML means are used to create a new “stsd” element 2676 and insert it into the “stbl” element 2628 and 2652 for the current trak element 2600. Subordinate elements within the new “stsd” element 2676 are created as shown in FIG. 37.

At operation 3700, standard XML means are used to create a new “esds” element 2684.

At operation 3706, the value of the streamType property is compared to “1” and “3”.

At operation 3710, if the value of the streamType property is “1” or “3”, standard XML means are used to create a new “mp4s”element 2680 and insert it into the current “stsd” element 2676. The new “esds” element 2684 is inserted into the new “mp4s” element 2680 and the value “1” is assigned to the “dataRefIndex” attribute of the new “mp4s” element 2680.

At operation 3716, if the value of the streamType property is not “1” or “3”, the streamType property is compared to “4”.

At operation 3720, if the value of the streamType is 4, standard XML means are used to create a new “mp4v” element 2680 and insert it into the current “stsd” element 2676. The new “esds” element 2684 is inserted into the new “mp4v” element 2680, and the values “−1”, “1”, “1”, “72.0”, “72.0”, “24”, “240”, and “320” are assigned to the attributes “colorTable”, “dataRefIndex”, “frameCount”, “horizontalRes”, “verticalRes”, “pixelDepth”, “height”, and “width”, respectively, of the new “mp4v” element 2680.

At operation 3726, if the value of the streamType property is not “4”, the streamType property is compared to “5”. If the value of the streamType property is not “5”, this procedure (operation 3690) is completed.

At operation 3730, if the value of the streamType is 5, standard XML means are used to create a new “mp4a” element 2680 and insert it into the current “stsd” element 2676. The new “esds” element 2684 is inserted into the new “mp4a” element 2680 and the values “1”, “−1”, and “−1” are assigned to the attributes “dataRefIndex”, “numChannels”, and “sampleSize”, respectively, of the new “mp4a” element 2680.

Additional streamType cases can easily be handled, but these cases (1, 3, 4, 5) are the only ones required for the current implementation. If the value of the streamType property is not 1, 3, 4, or 5, no further processing is performed for the stsd element 2676.

At operation 3736, if the value of the streamType property is “1”, “3”, “4”, or “5”, standard XML means are used to create a new “Es_Descr” element 2688 and insert it into the current “esds” element 2684. The value “0” is assigned to the “ES_ID” attribute of the new “ES_Descr” element 2688. The value “0” is assigned to the “priority” attribute of the new “ES_Descr” element 2688.

At operation 3740, standard XML means are used to create a new “DecoderConfigDescriptor” (D-C-D) element 2710 and insert it into the current “ES_Descr” element 2676. The values of the “bufferSizeDB”, “avgBitrate”, and “maxBitrate” attributes are obtained from the XMT-A “DecoderConfigDescriptor” 650 for this stream, and the values of these attributes are assigned to the “bufferSize”, “avgBitrate”, and “maxBitRate” attributes of the new “DecoderConfigDescriptor” element 2710. The values of the streamType and objectType properties of the current stream are assigned to the “streamType” and “objectType” attributes of the new “DecoderConfigDescriptor” element 2710.

At operation 3746, standard XML means are used to create a new “SLConfigDescriptor” (SLC-D) element 2760 and insert it into the current “ES_Descr” element 2676. The value “2” is assigned to the “predefined” attribute of the new “SLConfigDescriptor” element 2760.

Depending on the values of the streamType and objectType properties, a decoder specific info element may be inserted into the “DecoderConfigDescriptor” element 2710. If the value of the streamType property is 1 (odsm), a decoder specific info element is not required.

At operation 3750, the value of the streamType property is compared to “3”.

At operation 3756, if the value of the streamType property is 3 (sdsm), the procedure “Process BIFS Configuration” is performed. This procedure is described below.

At operation 3760, the value of the objectType property is compared to “32”.

At operation 3766, if the value of the objectType property is 32 (MPEG-4 video), standard XML means are used to create a new “VisualConfig” element 2740 and insert it into the current “DecoderConfigDescriptor” element 2710.

At operation 3770, the value of the objectType property is compared to “64”.

At operation 3776, if the value of the objectType property is 64 (MPEG-4 audio), standard XML means are used to create a new “AudioConfig” element is created and inserted into the current “DecoderConfigDescriptor” element 2710.

At operation 3780, the value of the objectType property is compared to “108”.

At operation 3786, if the value of the objectType property is 108 (JPEG image), standard XML means are used to create a “JPEG_DecoderConfig” element 2730 and insert it into the current “DecoderConfigDescriptor” element 2710.

Additional streamType and objectType cases can easily be handled, but these cases are the only ones required for the current implementation.

Except for the “BIFS_DecoderConfig” element 2720, the decoder specific info elements 2730, 2740, and 2750 specified above are mere stubs or placeholders. If the value of the streamType property is 3 (sdsm), the procedure “Process BIFS Configuration” described below is performed. Otherwise, processing of an ES_Descriptor element 640 continues with Step 9 (operation 3640) of the process “Create trak element” 3440.

### 7.1.10.4 Process BIFS Configuration

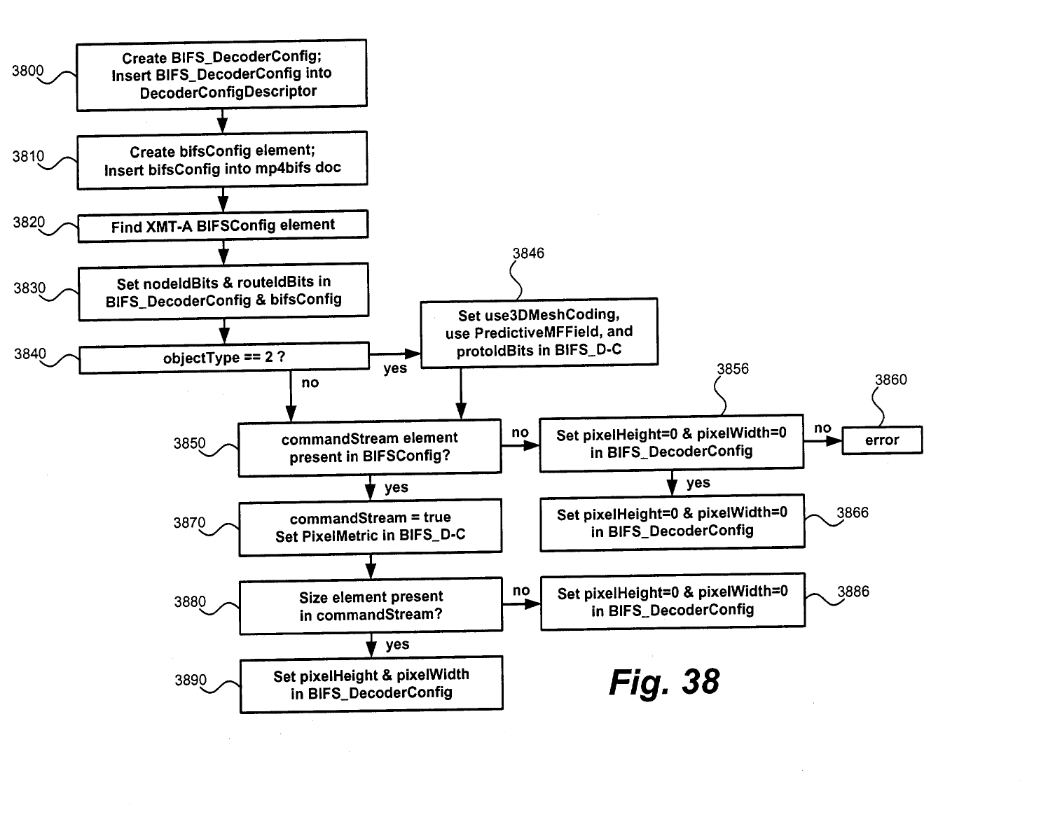

The procedure “Process BIFS Configuration” is shown in FIG. 38.

At operation 3800, standard XML means are used to create a new “BIFS_DecoderConfig” element 2720 and insert it into the “DecoderConfigDescriptor” element 2710.

At operation 3810, standard XML means are used to obtain the “bifsConfig” element 2810 in the mp4bifs document 2800.

At operation 3820, standard XML means are used to obtain the “decSpecificInfo” element 656 and 680 subordinate to the “DecoderConfigDescriptor” element 650 for the sdsm. Standard XML means are then used to obtain the “BIFSConfig” element 686 subordinate to this “decSpecificInfo” element 680.

At operation 3830, the value “0” is assigned to the “nodeIdBits” attribute of the “BIFS_DecoderConfig” element 2720 and the corresponding attribute of the “bifsConfig” element 2810. The value “0” is assigned to the “routeIdBits” attribute of the “BIFS_DecoderConfig” element 2720 and the corresponding attribute of the “bifsConfig” element 2810.

At operation 3840, the current value of the objectType property is compared to “2”.

At operation 3846, if the current value of the objectType property is “2”, the value “0” is assigned to the “protoIdBits” attribute of the BIFS_DecoderConfig element 2720 and the corresponding attribute of the bifsConfig element 2810, the values determined by the “use3DMeshCoding” and “usePredictiveMFField” attributes of the BIFSConfig element 686 are assigned to the like-named attributes of the BIFS_DecoderConfig element 2720 and bifsConfig element 2810.

At operation 3850, standard XML means are used to obtain the commandStream element 690 subordinate to the BIFSConfig element (686).

At operation 3856, if the BIFSConfig element 686 does not contain a subordinate commandStream element 690, standard XML means are used to obtain the animMask element subordinate to the BIFSConfig element 686. If the BIFSConfig element does not possess a subordinate animMask element, the XMT-A document is invalid and an error is reported at operation 3860.

At operation 3866, if the BIFSConfig element 686 possesses a subordinate animMask element, the value “false” is assigned to the commandStream attribute of the BIFS_DecoderConfig element 2720.

At operation 3870, if the BIFSConfig element 686 possesses a subordinate commandStream element 690, the value “true” is assigned to the commandStream attribute of the BIFS_DecoderConfig element 2720. The value of the pixelMetric attribute of the commandStream element 690 is assigned to the pixelMetric attribute of the BIFS_DecoderConfig element 2720. If a value has not been specified for the pixelMetric attribute of the commandStream element 690, the default value of “false” is assigned to the pixelMetric attribute of the BIFS_DecoderConfig element 2720.

At operation 3880, standard XML means are then used to obtain the “size” element 696 subordinate to the commandStream element 690.

At operation 3886, if the commandStream element 690 does not possess a subordinate size element 696, the value “0” is assigned to the “pixelHeight” and “pixelWidth” attributes of the BIFS_DecoderConfig element 2720.

At operation 3890, if the commandStream element 690 possesses a subordinate size element 696, the values of the “pixelHeight” and “pixelWidth” attributes of the “size” element 696 are assigned to the “pixelHeight” and “pixelWidth” attributes of the BIFS_DecoderConfig element 2720.

After these steps have been completed, processing of an ES_Descriptor element 640 continues with Step 9 (operation 3640) of the process “Create trak element” 3440.

### 7.2 Creation of mp4 Binary File Based on Intermediate XML Documents

After creation of the intermediate XML documents 2250 and 2260, the intermediate XML documents 2250 and 2260 and any associated media data files 2220 are used to create a new mp4 binary file 2230 representing the information specified in the original XMT-A document 2210. This new mp4 file is called the “output mp4 file” or “the mp4 file”. The means used to create this new mp4 file are comprised of the following six steps:

1. Establish the input documents and output destination;

2. Create working arrays;

3. Process “mdat” elements 2310;

4. Process the “moov” element 2320;

5. Process optional user data elements 2330; and

6. Update odsm buffer size.

Each of these steps is described below.

### 7.2.1 Establish Input Documents and Output Destination

The first of these steps consists of obtaining references to the XML data structures representing the mp4file document 2250 and mp4bifs document 2260 created above. This step also includes receiving a data structure which specifies a file name for the output mp4 binary file 2230. If the specified file name corresponds to an existing file, that file is deleted. A new empty output file is then created using the specified file name.

After creating the empty output file, standard XML means are used to obtain the top level element of the mp4file document. The top level element of the mp4bifs document may also be obtained at this point, but this is not required until later.

The new output file (the “mp4 file”) will consist of a hierarchical set of data structures called “mp4 atoms” and “mp4 object structures”. In the current implementation, each mp4 atom consists of a 32-bit “size” value, a 32-bit “atom ID”, and a set of property values. An mp4 atom may also contain one or more of subordinate mp4 atoms or mp4 object structures. The size value specifies the number of bytes in the complete mp4 atom including the size and atom ID. An mp4 object structure consists of a 1-byte object structure tag, a variably-sized size value, a set of property values, and a set of zero or more subordinate mp4 object structures. In this case, the size value specifies the number of bytes in the object structure exclusive of the object structure tag and size values.

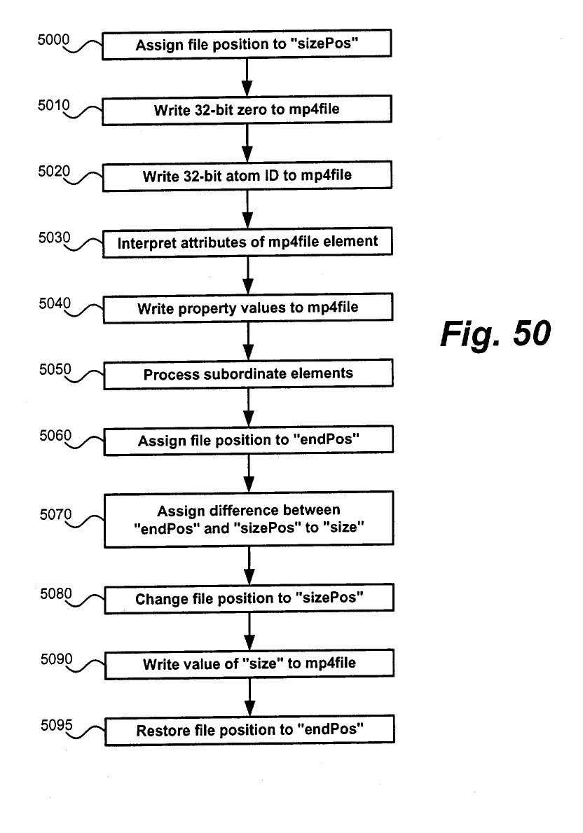

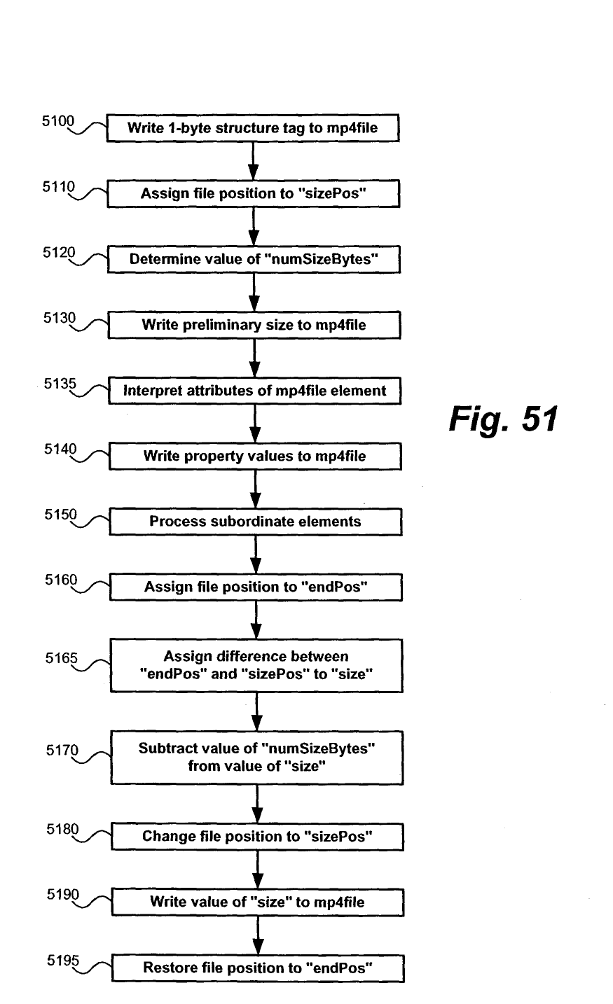

The general procedure for creating each atom is shown in FIG. 50. The corresponding procedure for creating an object structure is shown in FIG. 51. These procedures require the ability to control the “file position” of the output mp4 file. The “file position” is defined as the number of bytes from the beginning of the file to the point where the next byte is to be written. Because of the need to control the file position, this new file must be opened as a “random access” or “read/write” type of file.

### 7.2.1.1 Process for Creation of mp4 Atom

The process of creating an mp4 atom consists of the following steps:

1. At operation 5000, the current file position of the output file is assigned the quantity “sizePos”. The value of the quantity “sizePos” is unique to each mp4 atom or object structure.

2. At operation 5010, a 32-bit integer with the value zero is written to the output file.

3. At operation 5020, a 32-bit atom ID value is written to the output file. For example, in the case of an “mdat” atom, four bytes representing the ascii values of the characters “m”, “d”, “a”, and “t” are written to the output file.

4. At operation 5030, the attributes of the mp4file element represented by the current mp4 atom are interpreted. The particular set of attributes possessed by each mp4 atom is determined by the atom ID, as indicated in the MPEG-4 specifications for the MP4 file format. Default values are provided for attributes not specified in the mp4file document.

5. At operation 5040, the values of the attributes of the current mp4 atom are written to the output file. The number of bits used to represent each attribute value is indicated in the MPEG-4 specifications for the MP4 file format.

6. At operation 5050, if the current mp4file element possesses any subordinate elements, each such subordinate element is processed. If the subordinate element corresponds to an mp4file atom element, the current procedure is repeated recursively. If the subordinate element corresponds to an mp4file object element, the procedure shown in FIG. 51 is performed.

7. At operation 5060, the current file position is assigned the quantity “endPos”.

8. At operation 5070, the difference between the value of the quantity “endPos” and the value of the quantity “sizePos” is assigned to the quantity “size”.

9. At operation 5080, the file position of the output file is changed to the position specified by the value of the quantity “sizePos”.

10. At operation 5090, a 32-bit integer representing the value of the quantity “size” is written to the output file.

11. At operation 5095, the file position of the output file is changed to the position specified by the value of the quantity “endPos”.

### 7.2.1.2 Process for Creation of mp4 Object Structure

The process of creating an mp4 object structure consists of the following steps:

1. At operation 5100, a one-byte object structure tag is written to the output file. The value of the object structure tag is determined by the element name of the mp4file element represented by the mp4 object structure and tables provided in the MPEG-4 specifications.

2. At operation 5110, the current file position of the output file is assigned the quantity “sizePos”. The value of the quantity “sizePos” is unique to each mp4 atom or object structure.

3. At operation 5120, a value is assigned to the quantity “numSizeBytes” based on an estimate or upper bound on the number of bytes required to represent the mp4 object structure. If the number of bytes required to represent the mp4 object structure is less than 128, the value “1” is assigned to the quantity “numSizeBytes”. In most cases, this is sufficient.

4. At operation 5130, a sequence of one-byte values is written the output file. The number of these one-byte values is specified by the value of the quantity “numSizeBytes”. The values of these one-byte quantities is moot because they will be subsequently overwritten. The value zero may be used for each of these bytes.

5. At operation 5135, the attributes of the mp4file element represented by the current mp4 object element are interpreted. The particular set of attributes possessed by each mp4 object element is determined by the object tag, as indicated in the MPEG-4 systems specifications. Default values are provided for attributes not specified in the mp4file document.

6. At operation 5140, the values of the attributes of the current mp4 object structure are written to the output file. The number of bits used to represent each attribute value is indicated in the MPEG-4 systems specifications.

7. At operation 5150, if the current mp4file element possesses any subordinate elements, each such subordinate element is processed according to the procedure shown in FIG. 51 (recursively).

8. At operation 5160, the current file position is assigned the quantity “endPos”.

9. At operation 5165, the difference between the value of the quantity “endPos” and the value of the quantity “sizePos” is assigned to the quantity “size”.

10. At operation 5170, the value of the quantity “numSizeBytes” is subtracted from the value of the quantity “size”.

11. At operation 5180, the file position of the output file is changed to the position specified by the value of the quantity “sizePos”.

12. At operation 5190, a sequence of one-byte values representing the value of the quantify “size” is written to the output file. The number of these one-byte values is specified by the value of the quantity “numSizeBytes”. The low-order seven bits of each of these one-byte values is determined by the corresponding seven-bit portion of the value of the quantity “size”. The value of the high-order bit of each of these one-byte values is “1”, except for the last one-byte value. The value of the high-order bit of the last one-byte value in this sequence is “0”.

13. At operation 5195, the file position of the output file is changed to the position specified by the value of the quantity “endPos”.

### 7.2.2 Create Working Arrays

The second step identified above consists of creating a number of working arrays based on the number of “trak” elements 2350, the number of chunk elements 2450 and 2490, and the number of odsmSample elements 2510 represented in the mp4file document 2250 and 2300.

The following means are used to determine the value of the quantity “MaxNumTracks”:

Standard XML means are used to identify all elements 2310 and 2320 subordinate to the top level element of the mp4file document 2300. One of these subordinate elements will be the “moov” element 2320. The value of the “nextTrackID” attribute of this “moov” element 2320 provides an upper bound on the number of “trak” elements 2350 subordinate to the “moov” element 2320. If the mp4file document was created as indicated above, the value of the “nextTrackID” attribute specifies the number of “trak” elements 2350 subordinate to the “moov” element 2320. The value of the “nextTrackID” attribute is assigned to the quantity “MaxNumTracks”.

The following nine lists are created using the value of the quantity “MaxNumTracks” to specify the number of entries in each of these lists:

1. MediaSamples,

2. MediaDataFile (an array of “File” objects),

3. MediaHeaderSize,

4. MediaHeader (an array of location values),

5. EsDescrSize,

6. TrackIdForTrack,

7. StreamTypeForTrack,

8. ObjectTypeForTrack,

9. TrackIdfor OdId.

Each of these lists is an array of integers, except for the MediaDataFile list and the MediaHeader list.

After creating this set of nine lists, the value zero is assigned to the quantities TrackNum, MaxNumChunks, and MaxNumOdsmSamples.

The following means are used to determine the entries in the lists TrackIdForTrack, StreamTypeForTrack, and ObjectTypeForTrack:

Standard XML means are used to identify all elements subordinate to the “moov” element 2320. For each such subordinate element of type “trak” 2350, the value of the “trackID” attribute is assigned to entry TrackNum in the TrackIdForTrack list. Standard XML means are used to identify the “DecoderConfigDescriptor” element 2710 subordinate to this “trak” element (by nine levels). The value of the “streamType” attribute of this element 2710 is assigned to entry TrackNum in the list StreamTypeForTrack. The value of the “objectType” attribute of this element 2710 is assigned to entry TrackNum in the list ObjectTypeForTrack. The value of the quantity TrackNum is then incremented by one.

The following means are used to determine the values of the quantities “MaxNumChunks” and “MaxNumOdsmSamples”:

Standard XML means are used to identify all “mdat” elements 2310 subordinate to the top level element of the mp4file document 2300. Standard XML means are used to identify all elements subordinate to each “mdat” element 2310 and 2400. The resulting subordinate elements may include “mediaFile” elements 2430, “sdsm” elements 2410, and “odsm” elements 2420. Standard XML means are used to identify each “chunk” element 2450 and 2490 and “odsmChunk” element 2470 subordinate to each of the elements 2410, 2420, and 2430 subordinate to each “mdat” element 2400.

The value of the quantity MaxNumChunks is incremented by one for each “chunk” element 2450 and 2490 and each “odsmChunk” element 2470 subordinate to each element 2410, 2420, and 2430 subordinate to each “mdat” element 2400.

Standard XML means are used to identify each “odsmSample” element 2510 subordinate to each “odsmChunk” element 2470 and 2500. The value of the quantity MaxNumOdsmSamples is incremented by one for each “odsmSample” element 2510 subordinate to each “odsmChunk” element 2500.

The following four lists are created using the value of the quantity “MaxNumChunks” to specify the number of entries in each of these lists:

1. MdatIdForChunk,

2. TrackIdForChunk,

3. OffsetForChunk,

4. MediaDataSize.

Each of these lists is an array of integers. After these lists are created, the value zero is assigned to the quantity NumChunks.

If the value of the quantity “MaxNumOdsmSamples” is greater than zero, the following two lists are created using the value of the quantity “MaxNumOdsmSamples” to specify the number of entries in each of these lists:

1. OdsmSampleSize,

2. OdsmSampleTime.

Each of these lists is an array of integers. After these lists are created, the value zero is assigned to the quantity NumOdsmSamples.

### 7.2.3 Process “mdat” Elements

The third step in the creation of the output mp4 file 2230 consists of processing each of the mdat elements 2310 contained in the mp4file document 2300.

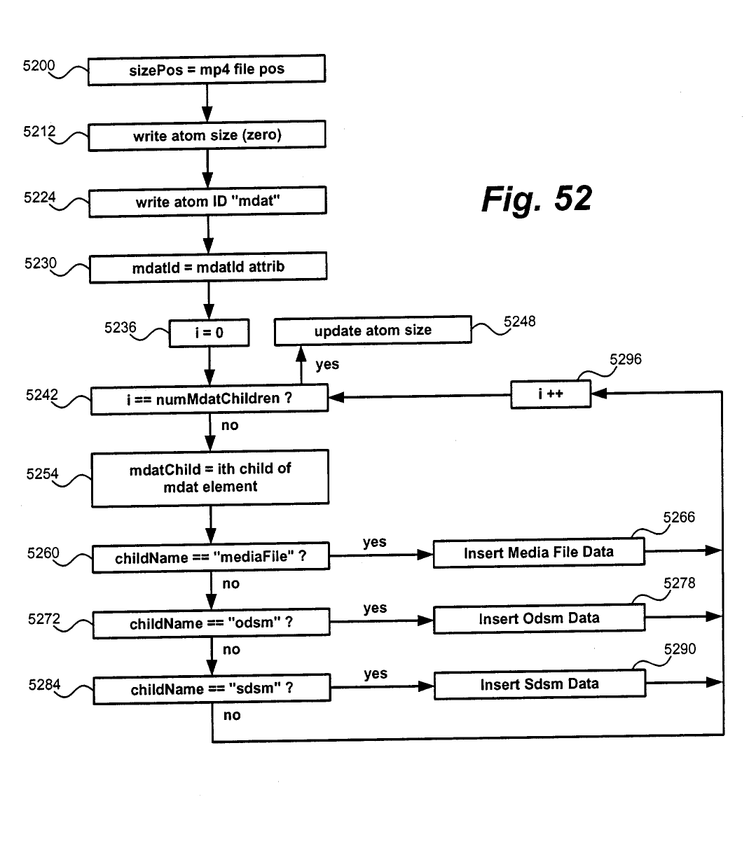

Standard XML means are used to identify each mdat element 2310 subordinate to the top level element of the mp4file document 2300 as shown in FIG. 23A. Each of these “mdat” elements 2310 is then processed using the means shown in FIG. 52. The procedure shown in FIG. 52 is an example of the process shown in FIG. 50.

At operation 5200, the current file position for the output mp4 file is assigned to the quantity “sizePos”. At operation 5212, a 32-bit integer with the value zero is written to the output mp4 file 724. At operation 5224, four bytes representing the ASCII values of the characters “m”, “d”, “a”, and “t” are written to the output mp4 file 730. The value of the “mdatId” attribute of this mdat element is assigned to the quantity “mdatId”. No property values are written to the output mp4 file.

At operation 5236, the value zero is assigned to the index “i”. At operation 5242, the value of the index “i” is compared to the value of the quantity “numMdatChildren”,where the quantity “numMdatChildren” indicates the number of subordinate elements possessed by the current mdat element. At operation 5248, if the value of the index “i” equals the value of the quantity “numMdatChildren”,the size of the mdat atom 724 is updated as indicated in the last five parts of FIG. 50 (operations 5060 through 5095).

At operation 5254, if the value of the index “i” does not equal the value of the quantity “numMdatChildren”,standard XML means are used to obtain each XML element subordinate to the current mdat element. The ith XML element subordinate to the current mdat element is represented by “mdatChild” and the element name for element mdatChild is indicated by “childName”.

At operation 5260, the name of the XML element mdatChild is compared to the string “mediaFile”. At operation 5266, if the name of the XML element mdatChild matches the string “mediaFile”,the procedure “Insert Media File Data” is performed. After performing the procedure “Insert Media File Data”,the value of the index “i” is incremented by one 5296 and the comparison of the value of the index “i” with the value of the quantity “numMdatChildren” operation 5242 is repeated.

At operation 5272, if the name of the XML element mdatChild does not match the string “mediaFile”,the name of the XML element mdatChild is compared to the string “odsm”. At operation 5278, if the name of the XML element mdatChild matches the string “odsm”,the procedure “Insert Odsm Data” is performed. After performing the procedure “Insert Odsm Data”,the value of the index “i” is incremented by one at operation 5296 and the comparison of the value of the index “i” with the value of the quantity “numMdatChildren” operation 5242 is repeated.

At operation 5284, if the name of the XML element mdatChild does not match the string “odsm”,the name of the XML element mdatChild is compared to the string “sdsm”. At operation 5290, if the name of the XML element mdatChild matches the string “sdsm”,the procedure “Insert Sdsm Data” is performed. After performing the procedure “Insert Sdsm Data”,the value of the index “i” is incremented by one at operation 5296 and the comparison of the value of the index “i” with the value of the quantity “numMdatChildren” operation 5242 is repeated.

If the name of the XML element mdatChild does not match the string “sdsm”,the value of the index “i” is incremented by one at operation 5296 and the comparison of the value of the index “i” with the value of the quantity “numMdatChildren” operation 5242 is repeated.

### 7.2.3.1 Insert Media File Data

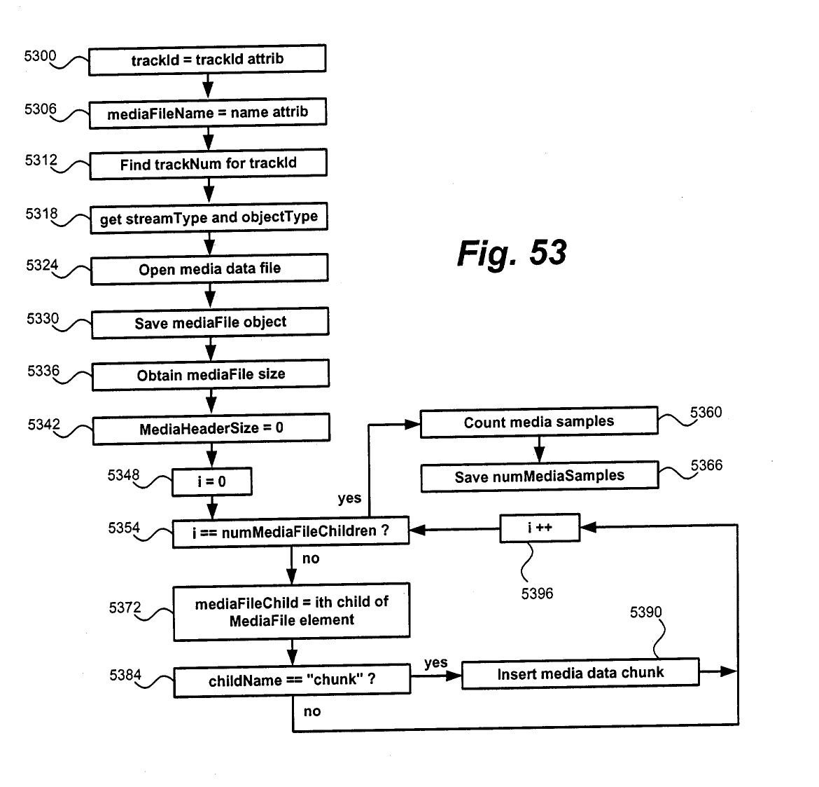

The procedure “Insert Media File Data” 5266 shown in FIG. 53 is used to process a “mediaFile” element 2430 subordinate to an “mdat” element 2400. At operation 5300, the value of the “trackId” attribute of the “mediaFile” element 2430 is assigned to the quantity “trackId”. At operation 5306, the value of the “name” attribute of the “mediaFile” element 2430 is assigned to the quantity “mediaFileName”.

At operation 5312, the value of the quantity “trackNum” is determined by the index of the entry in the TrackIdForTrack list which matches the value of the quantity “trackId”. At operation 5318, the values of the corresponding entries (with index trackNum) in the list StreamTypeForTrack and the list ObjectTypeForTrack are assigned to the quantities “streamType” and “objectType”.

At operation 5324, a new “File” object is created for the media data file identified by the value of the mediaFileName quantity. At operation 5330, this object is saved as an entry in the MediaDataFile list with index determined by the value of the quantity trackNum. At operation 5336, the size of this media data file, defined as the number of bytes comprising this media data file, is obtained as the length property of this new File object. This size value is assigned to the quantity “mediaFileSize”. At operation 5342, the value of the quantity “MediaHeaderSize” is initialized to zero.

At operation 5348, the value zero is assigned to the index “i”. At operation 5354, the value of the index “i” is compared to the value of the quantity “numMediaFileChildren”,where the value of the quantity “numMediaFileChildren” is determined by the number of XML elements subordinate to the current mediaFile element 2430.

At operation 5360, if the value of the index “i” equals the value of the quantity “numMediaFileChildren”,the number of samples in the media data file is counted. The means used to count the samples in a media data file depend on the values of “streamType” and “objectType”, and the detailed file structure specifications for each particular type of media data file. These means are not particular to this invention and are not presented here. At operation 5366, after counting the number of samples in the media data file, the resulting sample count is saved as the entry in the MediaSamples list with index determined by the value of the quantity trackNum.

At operation 5372, if the value of the quantity “i” is not equal to the value of the quantity “numMediaFileChildren”,standard XML means are used to obtain each XML element subordinate to the current mediaFile element 2480. The ith XML element subordinate to the current mediaFile element is represented by “mediaFileChild” and the element name for element mediaFileChild is indicated by “childName”.

At operation 5384, the name of the XML element mediaFileChild is compared to the string “chunk”.

At operation 5390, if the name of the XML element mdatChild matches the string “chunk”,the procedure “Insert Media Data Chunk” is performed. After performing the procedure “Insert Media Data Chunk”, the value of the index “i” is incremented by one at operation 5396 and the comparison of the value of the index “i” with the value of the quantity “numMediaFileChildren” operation 5354 is repeated.

If the name of the XML element mediaFileChild does not match the string “chunk”,the value of the index “i” is incremented by one at operation 5396 and the comparison of the value of the index “i” with the value of the quantity “numMediaFileChildren” operation 5354 is repeated.

### 7.2.3.2 Insert Media Data Chunk

The procedure “Insert Media Data Chunk” 5390 consists mainly of appending the contents of the media data file 2220 to the output mp4 file 2230. Certain types of media data, determined by the values of the quantities “streamType” and “objectType”,may begin with an initial “header” data section. These include “MPEG-4 Video” (streamType=4 and objectType=32). The precise means required to identify the header data section of a particular type of media data depend on the detailed specifications for each type of media data file. These file specifications are outside the scope of this invention and are not covered here. See ISO/IEC document 14496-2 (1999, amended, 2000) “Information Technology-Coding of Audio-Visual Objects—Part 2: Visual”,for a description of MPEG-4 video streams.

Before copying the media data from the media data file to the mp4 binary file, the following operations are performed:

1. The value of the quantity “mdatId” determined in operation 5230 is assigned to the entry “NumChunks” in the list “MdatIdForChunk”,

2. The value of the quantity “trackId” determined in operation 5300 is assigned to the entry “NumChunks” in the list “TrackIdForChunk”,

3. The value of the current file position in the output mp4 file is assigned to the entry “NumChunks” in the list “OffsetForChunk”,

4. The value of the quantity “mediaFileSize” determined in operation 5336 is assigned to the entry “NumChunks” in the list “MediaDataSize”,

5. The value zero is assigned to the entry “trackNum” in the list “MediaHeaderSize”,

6. If the media file type specified by the values of the quantities “streamType” and “objectType” includes an initial header data section, the number of bytes comprising this header section are assigned to the entry “trackNum” in the list “MediaHeaderSize”. A byte array of this size is created, and the data in the media header section are copied from the media data file to this array. The value of the location of this byte array is assigned to the entry “trackNum” in the list “MediaHeader”.

7. The remainder of the media data is copied from the (input) media data file 2220 to the output mp4 binary file 2230 and 730.

If necessary, data format conversions can be applied to the data at this stage. For example, MPEG-2 audio data (streamType=5 and objectType=64), may be modified to meet requirements of MPEG-4 audio streams. These modifications depend on the detailed specifications for the MPEG-2 Advanced Audio Coding (AAC) data [ISO/IEC document 13818-7 (1997) “Information Technology—Generic Coding of Moving Pictures and Associated Audio Information—Part 7: Advanced Audio Coding”]. These specifications and the associated data conversions are outside the scope of this invention and are not covered here.

8. The value of the quantity “numChunks” is incremented by one.

### 7.2.3.3 Insert odsm Data

The procedure “Insert Odsm Data” 5278 is used to process an “odsm” element 2420 subordinate to an “mdat” element 2400. This procedure will produce a new chunk 736 in the output mp4 file for each “odsmChunk” element 2470 subordinate to the current odsm element 2460.

The value of the “trackId” attribute of the “odsm” element 2420 is assigned to the quantity “trackId”. Standard XML means are used to obtain each “odsmChunk” element 2470 subordinate to the “odsm” element 2420 and 2460.

The following operations are performed for each “odsmChunk” element 2470 subordinate to the current “odsm” element 2460:

1. The value of the quantity “mdatId” determined in operation 5230 is assigned to the entry “NumChunks” in the list “MdatIdForChunk”,

2. The value of the quantity “trackId” is assigned to the entry “NumChunks” in the list “TrackIdForChunk”,

3. The value of the current file position of the output mp4 file is assigned to the entry “NumChunks” in the list “OffsetForChunk”,

4. The value “−1” is assigned to the entry “NumChunks” in the list “MediaDataSize”,

5. The value of the quantity “numChunks” is incremented by one.

6. Standard XML means are used to obtain each “odsmSample” element 2510 subordinate to the “odsmChunk” element 2500.

For each “odsmSample” element 2510 identified in Step 6, the current mp4 file position is assigned to the quantity “sampleStart”, the value of the “size” attribute is assigned to the quantity “sampleSize”, and the value of the “time” attribute is assigned to the quantity “sampleTime. The value of the quantity “sampleTime” is assigned to entry numOdsmSamples in the list “OdsmSampleTime”. The value of “sampleSize” is treated as an estimate of the resulting binary odsm sample. This will be replaced by the exact value determined by the difference between the final file position and the value of “sampleStart”.

Standard XML means are used to obtain each XML element 2530 subordinate to the “odsmSample” element 2520. These subordinate elements are expected to have element names of “ObjectDescrUpdate” 2540 or “ObjectDescrRemove” 2570. Each of these cases is processed as indicated below.

After completing the processing of all XML elements 2530 subordinate to the “odsmSample” element 2520, the difference between the resulting file position of the output mp4 file and the value of the quantity “sampleStart” is assigned to the quantity “sampleSize” (replacing the estimate derived from the corresponding attribute value). This value is assigned to entry “numOdsmSamples” in the list “OdsmSampleSize” list. Then the value of the quantity “numOdsmSamples” is then incremented by one.

### 7.2.3.4 ObjectDescrUpdate Elements

For each “ObjectDescrUpdate” element 2540 subordinate to the “odsmSample” element 2520, the procedure shown in FIG. 51 is used to create an ObjectDescrUpdate object structure 2000 in the output mp4 file. The structure tag “ObjectDescrUpdateTag” (value=1) 2010 is written to the output mp4 file as an 8-bit integer at operation 5100. The current file position for the output mp4 file is assigned to the quantity “sizePos” at operation 5110, and the value of “sizePos” is assigned to the quantity “filePos1”. The value “1” is assigned to the quantity “numSizeBytes” at operation 5120. The value zero is written to the output mp4 file as the preliminary size value 2020 at operation 5130.

An “ObjectDescrUpdate” element 2540 has no attributes, so nothing is done in operations 5135 and 5140.

Standard XML means are used to obtain each XML element 2550 subordinate to the “ObjectDescrUpdate” element 2540. These subordinate elements are expected to have element names of “ObjectDescriptor” 2550. After processing each subordinate “ObjectDescriptor” element 2550 as described below in operation 5150, size of the ObjectDescrUpdate structure 2020 is updated as indicated in FIG. 51 (operations 5160 to 5195).

For each “ObjectDescriptor” element 2550 subordinate to the “ObjectDescrUpdate” element 2540, the procedure shown in FIG. 51 is used to create an ObjectDescriptor object structure 2030 and 2100 in the output mp4 file. The structure tag “MP4_OD_Tag” (value=17) 2108 is written to the output mp4 file as an 8-bit integer at operation 5100. The current file position for the output mp4 file is assigned to the quantity “sizePos” at operation 5110, and the value of “sizePos” is assigned to the quantity “filePos2”. The value “1” is assigned to the quantity “numSizeBytes” at operation 5120. The value zero is written to the output mp4 file as the preliminary size value 2116 at operation 5130.

The value of the “OdId” attribute of the “ObjectDescriptor” element 2550 is assigned to the quantity “OdId”. The numerical value of the quantity “OdId” is multiplied by 64 (shifted left by six bits) and the value “31” is added to the result to determine a modified value for the quantity “OdId”. The value “31” represents the “reserved field 2140 within the ObjectDescriptor object structure 2100.

If the “url” attribute of the “ObjectDescriptor” element 2550 is specified, then the value “32” is added to the modified “OdId” value. The resulting value is written to the mp4 file as a 16-bit integer. One byte indicating the number of characters in the value of the “url” attribute is then written to the mp4 file. The value of the “url” attribute is then written to the mp4 file a sequence of characters.

If the “url” attribute of the “ObjectDescriptor” element 2550 is not specified, then the modified “OdId” value is written to the mp4 file as a 16-bit integer 2124, 2132, and 2140.

Standard XML means are then used to obtain each XML element 2560 subordinate to the “ObjectDescriptor” element 2550. These subordinate elements are expected to have element names of “EsIdRef” 2560.

For each “EsIdRef” element 2560 subordinate to the current “ObjectDescriptor” element 2550, the procedure shown in FIG. 51 is used to create an EsIdRef object structure 2148 and 2160 in the output mp4 file. The structure tag “EsIdRefTag” (value=15) 2170 is written to the output mp4 file as an 8-bit integer at operation 5100. The current file position for the output mp4 file is assigned to the quantity “sizePos” at operation 5110. The value “1” is assigned to the quantity “numSizeBytes” at operation 5120. The value zero is written to the output mp4 file as the preliminary size value 2180 at operation 5130.

The value of the “EsId” attribute of the “EsIdRef” element 2560 is assigned to the quantity “EsId” at operation 5135. The numerical value of the quantity “EsId” then written to the output mp4 file as a 16-bit integer 2190 at operation 5140. An EsIdRef element 2560 has no subordinate elements 5150.

After processing the “EsId” value 2190, the size 2180 of the EsIdRef object structure is updated as indicated in FIG. 51 (operations 5160 to 5195).

After processing the “ObjectDescriptor” element at operation 2550, the value of filePos2 is assigned to the quantity “sizePos”, and the size 2116 of the MP4_OD object structure 2100 is updated as indicated in FIG. 51 (operations 5160 to 5195).

After processing the “ObjectDescrUpdate” element at operation 2540, the value of filePos1 is assigned to the quantity “sizePos”, and the size 2020 of the ObjectDescrUpdate object structure 2000 is updated as indicated in FIG. 51 (operations 5160 to 5195).

### 7.2.3.5 ObjectDescrRemove Elements

For each “ObjectDescrRemove” element 2570 subordinate to the current “odsmSample” element 2520, the procedure shown in FIG. 51 is used to create an ObjectDescrRemove object structure 2040 in the output mp4 file. The structure tag “ObjectDescrRemoveTag” (value=2) 2050 is written to the output mp4 file as an 8-bit integer at operation 5100. The current file position for the output mp4 file is assigned to the quantity “sizePos” at operation 5110, and the value of “sizePos” is assigned to the quantity “filePos1”. The value “1” is assigned to the quantity “numSizeBytes” at operation 5120. The value zero is written to the output mp4 file as the preliminary size value 2060 at operation 5130.

The value of the “OdId” attribute of the “ObjectDescrRemove” element 2570 is assigned to the quantity “OdIdList”.

The quantity “OdIdList” consists of a character string representing one or more integers separated by “white space” (blank spaces and other non-numeric characters). Each sequence of numeric characters within “OdIdList” is interpreted as an integer and the resulting value is written to the mp4 file as a ten-bit objectDescriptorId value 2070. Successive objectDescriptorId values 2070 written to the mp4 file are not byte-aligned. If the total number of bits (nBits) occupied by the sequence of objectDescriptorId values 2070 is not a multiple of eight, then nPad zero bits 2080 are written to the mp4 file, where the value of nPad is given by nBits modulo 8.

After processing the “OdIdList” quantity, the size 2060 of the ObjectDescrRemove object structure 2040 is updated as indicated in FIG. 51 (operations 5160 to 5195).

### 7.2.3.6 Insert sdsm Data

The procedure “Insert Sdsm Data” is used to process an “sdsm” element 2410 subordinate to an “mdat” element 2400. The value of the “trackId” attribute of the “sdsm” element 2410 and 2440 is assigned to the quantity “trackId”. An optional attribute “xmlFile” may be present. This attribute may be used to specify the name of an input XML file representing the mp4bifs document 2800. Alternatively, the mp4bifs document 2800 may be obtained from the result of another process, such as the process described above for creating mp4file and mp4bifs documents based on an XMT-A document. Standard XML means are then used to obtain the top level element of the mp4bifs document 2800.

As shown in FIG. 28A, the mp4bifs document 2800 consists of an mp4bifs top-level element with a single subordinate “bifsConfig” element 2810 and one or more subordinate “commandFrame” elements 2820. Each “commandFrame” element 2820 represents a “sample” for the scene description stream (sdsm). In preparation for interpreting the mp4bifs document 2800, the number of sdsm samples is determined by counting the number of “commandFrame” elements 2820 subordinate to the mp4bifs top element 2800. The resulting value is assigned to the quantity “MaxNumSdsmSamples”, and two lists are created each having MaxNumSdsmSamples entries. One of these lists, “SdsmSampleSize”,is a list of integer values. The second list, “SdsmSampleTime”,is a list of floating point values, preferably double precision floating point values (64 bits per entry). The value zero is assigned to the quantity “NumSamples”. Standard XML means are used to obtain each “chunk” element 2450 subordinate to the “sdsm” element 2440. At most one subordinate “chunk” element 2440 is expected for each “sdsm” element 2440. The following operations are performed the “chunk” element 2440:

1. The value of the quantity “mdatId” determined at operation 5230 is assigned to the entry “NumChunks” in the list “MdatIdForChunk”,

2. The value of the quantity “trackId” is assigned to the entry “NumChunks” in the list “TrackIdForChunk”,

3. The value of the current file position is assigned to the entry “NumChunks” in the list “OffsetForChunk”,

4. The value “−1” is assigned to the entry “NumChunks” in the list “MediaDataSize”,

5. The value of the quantity “numChunks” is incremented by one.

The mp4bifs document 2800 is then interpreted as described below. As this document is interpreted, data values are written to the output mp4 file 700, and values are entered into the lists “SdsmSampleSize” and “SdsmSampleTime”. In an object-oriented implementation, this is accomplished by creating a new SdsmEncoder object, and invoking a method “encodeSdsm” for this object. This method will return the completed lists, “SdsmSampleSize” and “SdsmSampleTime”,as well as appending data representing the binary encoding of the sdsm to the output mp4 file 700.

Standard XML means are used to obtain the “bifsConfig” element 2810 subordinate to the mp4bifs top level element 2800. The value of the “routeIdBits” attribute of this element is assigned to the quantity “RouteIdBits”. The value of the “nodeIdBits” attribute of this element is assigned to the quantity “NodeIdBits”. The value of the number 2 raised to the power “NodeIdBits” (or “1” shifted left by NodeIdBits bits) is assigned to the quantity MaxUpdateableNodes. Two new lists of integers, “UpdateableNodeId” and “UpdateableNodeNumber” are created. The number of entries in each of these lists is determined by the value of “MaxUpdateableNodes”. The value zero is assigned to the quantity “NumUpdateableNodes”. The value “false” is assigned to the boolean quantity “bUseNames”.

Standard XML means are then used to obtain each “commandFrame” element 2820 subordinate to the mp4bifs top level element 2800. The following means are used to process each such “commandFrame” element 2820:

1. The value of the current file position for the output mp4 file is assigned to the quantity “FilePointerAtStart”.

2. The value of the “time” attribute of the “commandFrame” element 2820 is assigned to the quantity “Time”. The value of the quantity “Time” is assigned to entry “NumSamples” in the list “SdsmSampleTime”.

3. Standard XML means are used to obtain each of the bifsCommand elements 2840 subordinate to the “commandFrame” element 2830. Each such subordinate element is processed as described below.

4. The value of the current file position for the output mp4 file is assigned to the quantity “FilePointerAtEnd”, and the difference between the value of the quantity “FilePointerAtEnd” and the value of the quantity “FilePointerAtStart” is assigned to entry “NumSamples” in the list “SdsmSampleSize”.

5. The value of the quantity “NumSamples” is incremented by one.

As shown in FIG. 28B, each “commandFrame” element 2830 contains one or more subordinate bifsCommand elements 2840. Each bifsCommand element 2910 represents one of eleven possible BIFS commands that may be encoded in the sdsm data. These include three insertion commands (“InsertNode”, “InsertRoute”, and “InsertIndexedValue”), three deletion commands (“DeleteNode”, “DeleteRoute”, and “DeleteIndexedValue”), and five replacement commands (“ReplaceNode”, “ReplaceRoute” “ReplaceIndexedValue”, “ReplaceField”, and “ReplaceScene”). As shown in FIG. 29A, a BIFS command element 2910 may have subordinate elements representing BIFS nodes 2920. As shown in FIG. 29B, the bifsCommand element 2930 representing a ReplaceScene command may also contain a single subordinate Routes element 2950 containing one or more Route elements 2960.

Before generating binary representations of the bifsCommand elements 2840 subordinate to a particular “commandFrame” element 2830, each subordinate bifsCommand element 2910 is “scanned” to identify all subordinate Node elements 2920 and 3000 for which a value has been specified for the “NodeId” attribute 3010. This “scanning” operation is accomplished by using standard XML means to obtain each bifsCommand element 2840 subordinate to the current “commandFrame” element 2830. This operation is applied only to the six bifsCommand elements (“InsertNode”, “InsertIndexedValue”, “ReplaceNode”, “ReplaceIndexedValue”, “ReplaceField”, and “ReplaceScene”) 2910 that may include one or more subordinate BIFS Node elements 2920 and 2940.

The procedures used to perform this “scan” operation are equivalent to those used for the subsequent BIFS command interpretation procedures described below, except that nothing is done to the output mp4 file, and all attributes are ignored except for “nodeId” attributes, and attributes with field data types of “node” or “command buffer”. For each node for which the “NodeId” attribute is specified, the value of the “NodeId” attribute is assigned to the entry “numUpdateableNodes” in the list “UpdateableNodeId”. The value of the “node number” property of this node is assigned to the corresponding entry in the “UpdateableNodeNumber” list. The “node number” property for a particular node element is determined by the index of the entry in a table of node names that matches the element name for this node element. The table of node names is defined in the MPEG-4 Systems specifications documents. The value of the quantity “NumUpdateableNodes” is then incremented by one.

After scanning the subordinate bifsCommand elements 2840, standard XML means are again used to obtain each XML element 2840 subordinate to the current “commandFrame” element 2830. As shown in FIG. 11B, each BIFS command 1120 is followed by a “continue” bit 1130 and 1140. Before processing each bifsCommand element 2840 subordinate to a “commandFrame” element 2830, except for the first such command, a single bit with the value “1” is written to the output mp4 file to specify “continue=1” 1130. Each of the subordinate bifsCommand elements 2840 is then processed as described below. After all of the subordinate elements have been processed, a single bit with the value “0” is written to the output mp4 file to specify “continue=0” (end of command frame) 1140. If the total number of bits used to represent this command frame in binary form is not a multiple of eight, the last byte is padded with zeroes 1150 to bring the total number of bits up to a multiple of eight.

The following means are then used to append a binary BIFS command data structure to the output mp4 file for each bifsCommand element 2840 subordinate to the current commandFrame element 2830.

If a bifsCommand element 2840 represents one of the three insertion commands, the two-bit insertion code (binary value=00) 1206 is written to the output mp4 file. If a BIFS command element 2840 represents one of the three deletion commands, the two-bit deletion code (binary value=01) 1220 is written to the output mp4 file. If a BIFS command element 2840 represents one of the four replacement commands (other than ReplaceScene), the two-bit replacement code (binary value=10) 1240 is written to the output mp4 file. If a BIFS command element 2840 represents the ReplaceScene command, the two-bit scene replacement code (binary value=11 ) 1280 is written to the output mp4 file.

### 7.2.3.7 Node Insertion BIFS Command

In the case of an “InsertNode” bifsCommand element 2840 and 2910, a Node Insertion BIFS command 1300, as shown in FIG. 13A, is appended to the output mp4 file. The two-bit parameter type code for “node” (binary value=00) 1308 is written to the output mp4 file following the insertion code 1304. The value of the “parentId” attribute of the InsertNode element is assigned to the quantity “nodeID” and the integer value of this quantity 1312 is written to the mp4 file. The number of bits used to encode the value of the quantity “nodeID” is specified by the value of the quantity “nodeIdBits”. The value of the “parentID” attribute of the InsertNode element must match one of the entries in the UpdateableNodeId list. The corresponding entry in the UpdateableNodeNumber list specifies the value of the “node number” property of the parent node for the subordinate Node element.

The value of the “insertionPosition” attribute of the InsertNode element is assigned to the quantity “insertionPosition”, and two bits representing the integer value of this quantity 1316 are written to the mp4 file. If the value of the quantity “insertionPosition” is zero, the value of the “position” attribute of the InsertNode element is assigned to the quantity “position” and eight bits representing the integer value of this quantity 1320 are written to the mp4 file.

Each InsertNode element contains a subordinate Node element 2920. A binary SFNode representation of this Node element 1324 is appended to the output mp4 file following the data representing the insertion position 1316 and 1320. The format of an SFNode structure is shown in FIG. 17. The procedures used to create this SFNode structure are described below.

### 7.2.3.8 Indexed Value Insertion BIFS Command

In the case of an “InsertIndexedValue” bifsCommand element 2840 and 2910, an IndexedValue Insertion BIFS command 1328, as shown in FIG. 13B, is appended to the output mp4 file. The two-bit parameter type code for “indexed value” (binary value=10) 1336 is written to the mp4 file following the insertion code 1332. The value of the “nodeId” attribute of the InsertIndexedValue element is assigned to the quantity “nodeID” and the integer value of this quantity 1340 is written to the mp4 file. The number of bits used to encode the value of the quantity “nodeID” is specified by the value of the quantity “nodeIdBits”.

The value of the “nodeId” attribute of the InsertIndexedValue element must match one of the entries in the UpdateableNodeId list. The corresponding entry in the UpdateableNodeNumber list specifies the value of the “node number” property for the BIFS node to be modified by the field value associated with this BIFS command.

The value of the “field index” property for this BIFS command is determined by the index of the entry in a list of field names for this node number having a value matching the value of the “inFieldName” attribute of the InsertIndexedValue element. This list of field names is defined in the MPEG-4 Systems specifications. The value of the inFieldID property for this field is determined by the value of the node number, the value of the field index, and a set of tables defined in the MPEG-4 Systems specifications. The value of the quantity “numBits” is determined by the value of the node number, the value of inFieldID, and a table defined in the MPEG-4 Systems specifications. The integer value of the quantity inFieldID is then written to the mp4 file using numBits bits 1344.

The value of the “insertionPosition” attribute of the InsertIndexedValue element is assigned to the quantity “insertionPosition”, and two bits representing the integer value of this quantity are written to the mp4 file 1348. If the value of the quantity “insertionPosition” is zero, the value of the “position” attribute of the InsertIndexedValue element is assigned to the quantity “position” and 16 bits representing the integer value of this quantity are written to the mp4 file 1352.

Each InsertIndexedValue element includes a “value” attribute. The interpretation of this value attribute depends on the “field data type” property of the property field identified by the inFieldName attribute of the InsertIndexedValue element. The field data type property is determined by the value of the node number, the field index, and a set of tables defined in the MPEG-4 Systems specifications. If the field data type property is “SFNode”,the value of the “value” attribute specifies the name of a subordinate Node element. Otherwise, the value of the “value” attribute specifies the value of the “field value” directly. In either case, the means described below under “SFField structure” are used to interpret the value attribute, create a binary representation of the field value specified by the value attribute, and append the result to the output mp4 file 1356.

### 7.2.3.9 Route Insertion BIFS Command

In the case of an “InsertRoute” bifsCommand element 2840 and 2910, a Route Insertion BIFS command 1360, as shown in FIG. 13C, is appended to the output mp4 file. The two-bit parameter type code for “route” (binary value=11) 1368 is written to the mp4 file following the insertion code 1364. If a value has not been specified for the “routeId” attribute of the InsertRoute element, a single bit with the value “0” is written to the output mp4 file as the “isUpdateable” value 1372. Otherwise, the value “1” is written to the output mp4 file as the “isUpdateable” value 1372 followed by the value 1376 specified by the “routeId” attribute of the InsertRoute element. The number of bits used to represent the integer value of the routeId attribute is specified by the value of the quantity RouteIdBits.

The value of the “departureNode” attribute of the InsertRoute element is assigned to the quantity “departureNodeID” and this value is written to the mp4 file 1380. The number of bits used to represent the integer value of the quantity “departureNodeID” is specified by the value of the quantity “NodeIdBits”.

The value of the “departureNode” attribute of the InsertRoute element must match one of the entries in the UpdateableNodeId list. The corresponding entry in the UpdateableNodeNumber list specifies the value of the “node number” property for the “departure node”.

The value of the “field index” property for the departure node is determined by the index of the entry in a list of field names for this node number having a value matching the value of the “departureFieldName” attribute of the InsertRoute element. This list of field names is defined in the MPEG-4 Systems specifications. The value of the departureFieldID property for this field is determined by the value of the node number for the departure node, the value of the field index for the departure node, and a set of tables defined in the MPEG-4 Systems specifications. The value of the quantity “numBits” is determined by the value of the node number for the departure node, the value of departureFieldID, and a table defined in the MPEG-4 Systems specifications. The value of the quantity departureFieldID is then written to the mp4 file using numBits bits 1384.

The value of the “arrivalNode” attribute of the InsertRoute element is assigned to the quantity “arrivalNodeID” and this value is written to the mp4 file 1388. The number of bits used to represent the integer value of the quantity “arrivalNodeID” is specified by the value of the quantity “NodeIdBits”.

The value of the “arrivalNode” attribute of the InsertRoute element must match one of the entries in the UpdateableNodeId list. The corresponding entry in the UpdateableNodeNumber list specifies the value of the “node number” property for the “arrival node”.

The value of the “field index” property for the arrival node is determined by the index of the entry in a list of field names for this node number having a value matching the value of the “arrivalFieldName” attribute of the InsertRoute element. This list of field names is defined in the MPEG-4 Systems specifications. The value of the arrivalFieldID property for this field is determined by the value of the node number for the arrival node, the value of the field index for the arrival node, and a set of tables defined in the MPEG-4 Systems specifications. The value of the quantity “numBits” is determined by the value of the node number for the arrival node, the value of arrivalFieldID, and a table defined in the MPEG-4 Systems specifications. The integer value of the quantity arrivalFieldID is then written to the mp4 file using numBits bits 1392.

### 7.2.3.10 Node Deletion Command

In the case of a “DeleteNode” bifsCommand element 2840 and 2910, a Node Deletion BIFS command 1400, as shown in FIG. 14A, is appended to the output mp4 file. In this case, the two-bit parameter type code for “node” (binary value=00) 1412 is written to the mp4 file following the deletion code 1406. The value of the “nodeId” attribute is assigned to the quantity “nodeID” and an integer representation of this value is written to the mp4 file 1418. The number of bits used to represent the integer value of the quantity “nodeID” is specified by the value of the quantity “NodeIdBits”.

### 7.2.3.11 Indexed Value Deletion BIFS Command

In the case of a “DeleteIndexedValue” bifsCommand element 2840 and 2910, an IndexedValue Deletion BIFS command 1424, as shown in FIG. 14B, is appended to the output mp4 file. The two-bit parameter type code for “indexed value” (binary value=10) 1436 is written to the mp4 file following the deletion code 1430. The value of the “nodeId” attribute is assigned to the quantity “nodeID” and this value is written to the mp4 file 1442. The number of bits used to represent the integer value of the quantity “nodeID” is specified by the value of the quantity “nodeIdBits”.

The value of the “nodeId” attribute of the DeleteIndexedValue element must match one of the entries in the UpdateableNodeId list. The corresponding entry in the UpdateableNodeNumber list specifies the value of the “node number” property for the BIFS node associated with this BIFS command.

The value of the “field index” property for this BIFS command is determined by the index of the entry in a list of field names for this node number having a value matching the value of the “inFieldName” attribute of the DeleteIndexedValue element. This list of field names is defined in the MPEG-4 Systems specifications. The value of the inFieldID property for this field is determined by the value of the node number, the value of the field index, and a set of tables defined in the MPEG-4 Systems specifications. The value of the quantity “numBits” is determined by the value of the node number, the value of inFieldID, and a table defined in the MPEG-4 Systems specifications. The integer value of the quantity inFieldID is then written to the mp4 file using numBits bits 1448.

The value of the “deletion Position” attribute of the DeleteIndexedValue element is assigned to the quantity “deletionPosition”, and two bits representing the integer value of this quantity are written to the mp4 file 1454. If the value of the quantity “deletionPosition” is zero, the value of the “position” attribute of the DeleteIndexedValue element is assigned to the quantity “position” and 16 bits representing the integer value of this quantity are written to the mp4 file 1460.

### 7.2.3.12 Route Deletion BIFS Command

In the case of a “DeleteRoute” bifsCommand element 2840 and 2910, a Route Deletion BIFS command 1466, as shown in FIG. 14C, is appended to the output mp4 file. The two-bit parameter type code for “route” (binary value=11) 1478 is written to the mp4 file following the deletion code 1472. The value of the “routeId” attribute of the DeleteRoute element is assigned to the quantity “routeID” and an integer representation of this value is written to the mp4 file 1484. The number of bits used to represent the integer value of the quantity “routeID” is specified by the value of the quantity “RouteIdBits”.

### 7.2.3.13 Node Replacement BIFS Command

In the case of a “ReplaceNode” bifsCommand element 2840 and 2910, a Node Replacement BIFS command 1500, as shown in FIG. 15A, is appended to the output mp4 file. The two-bit parameter type code for “node” (binary value=00) 1508 is written to the mp4 file following the replacement code 1504. The value of the “nodeId” attribute of the ReplaceNode element is assigned to the quantity “nodeID” and this value is written to the mp4 file 1510. The number of bits used to represent the integer value of the quantity “nodeID” is specified by the value of the quantity “NodeIdBits”.

Each ReplaceNode element contains a subordinate Node element 2920. A binary SFNode representation of this Node element 1514 is appended to the output mp4 file following the data representing the nodeID value 1510. The format of an SFNode structure is shown in FIG. 17. The procedures used to create this SFNode structure are described below.

### 7.2.3.14 Field Replacement BIFS Command

In the case of a “ReplaceField” bifsCommand element 2840 and 2910, a Field Replacement BIFS command 1520, as shown in FIG. 15B, is appended to the output mp4 file. The two-bit parameter type code for “field” (binary value=01) 1528 is written to the mp4 file following the replacement code 1524. The value of the “nodeId” attribute of the ReplaceField element is assigned to the quantity “nodeID” and this value is written to the mp4 file 1530. The number of bits used to represent the integer value of the quantity “nodeID” is specified by the value of the quantity “NodeIdBits”.

The value of the “nodeId” attribute of the ReplaceField element must match one of the entries in the UpdateableNodeId list. The corresponding entry in the UpdateableNodeNumber list specifies the value of the “node number” property for the BIFS node to be modified by the field value associated with this BIFS command.

The value of the “field index” property for this BIFS command is determined by the index of the entry in a list of field names for this node number having a value matching the value of the “inFieldName” attribute of the ReplaceField element. This list of field names is defined in the MPEG-4 Systems specifications. The value of the inFieldID property for this field is determined by the value of the node number, the value of the field index, and a set of tables defined in the MPEG-4 Systems specifications. The value of the quantity “numBits” is determined by the value of the node number, the value of inFieldID, and a table defined in the MPEG-4 Systems specifications. The value of the quantity inFieldID is then written to the mp4 file using numBits bits 1534.

Each ReplaceField element includes a “value” attribute. The interpretation of this value attribute depends on the “field data type” property of the property field identified by the inFieldName attribute of the ReplaceField element. The field data type property is determined by the value of the node number, the field index, and a set of tables defined in the MPEG-4 Systems specifications. If the field data type property is “SFNode”,the value of the “value” attribute specifies the name of a subordinate Node element. Otherwise, the value of the “value” attribute specifies the value of the “field value” directly. In either case, the means described below under “SFField structure” are used to interpret the value attribute, create a binary representation of the field value specified by the value attribute, and append the result to the output mp4 file 1538.

### 7.2.3.15 Indexed Value Replacement BIFS Command

In the case of a “ReplaceIndexedValue” bifsCommand element 2840 and 2910, an Indexed Value Replacement BIFS command 1540, as shown in FIG. 15C, is appended to the output mp4 file. The two-bit parameter type code for “indexed value” (binary value=10) 1548 is written to the mp4 file following the replacement code 1544. The value of the “nodeId” attribute is assigned to the quantity “nodeID” and this value is written to the mp4 file 1550. The number of bits used to represent the integer value of the quantity “nodeID” is specified by the value of the quantity “NodeIdBits”.

The value of the “nodeId” attribute of the ReplaceIndexedValue element must match one of the entries in the UpdateableNodeId list. The corresponding entry in the UpdateableNodeNumber list specifies the value of the “node number” property for the BIFS node to be modified by the field value associated with this BIFS command.

The value of the “field index” property for this BIFS command is determined by the index of the entry in a list of field names for this node number having a value matching the value of the “inFieldName” attribute of the ReplaceIndexedValue element. This list of field names is defined in the MPEG-4 Systems specifications. The value of the inFieldID property for this field is determined by the value of the node number, the value of the field index, and a set of tables defined in the MPEG-4 Systems specifications. The value of the quantity “numBits” is determined by the value of the node number, the value of inFieldID, and a table defined in the MPEG-4 Systems specifications. The value of the quantity inFieldID is then written to the mp4 file using numBits bits 1554.

The value of the “replacementPosition” attribute of the InsertIndexedValue element is assigned to the quantity “replacementPosition”, and two bits representing the value of this quantity are written to the mp4 file 1558. If the value of the quantity “replacementPosition” is zero, the value of the “position” attribute of the ReplaceIndexedValue element is assigned to the quantity “position” and 16 bits representing the integer value of this quantity are written to the mp4 file 1560.

Each ReplaceIndexedValue element includes a “value” attribute. The interpretation of this value attribute depends on the “field data type” property of the property field identified by the inFieldName attribute of the ReplaceIndexedValue element. The field data type property is determined by the value of the node number, the field index, and a set of tables defined in the MPEG-4 Systems specifications. If the field data type property is “SFNode”,the value of the “value” attribute specifies the name of a subordinate Node element. Otherwise, the value of the “value” attribute specifies the value of the “field value” directly. In either case, the means described below under “SFField structure” are used to interpret the value attribute, create a binary representation of the field value specified by the value attribute, and append the result to the output mp4 file 1564.

### 7.2.3.16 Route Replacement BIFS Command

In the case of a “ReplaceRoute” bifsCommand element 2840 and 2910, a Route Replacement BIFS command 1570, as shown in FIG. 15D, is appended to the output mp4 file. The two-bit parameter type code for “route” (binary value=11) 1578 is written to the mp4 file following the replacement code 1574. The value of the “routeId” attribute of the ReplaceRoute element is assigned to the quantity “routeID” and an integer representation of this value is written to the mp4 file 1580. The number of bits used to represent the integer value of the quantity “routeID” is specified by the value of the quantity “RouteIdBits”.

The value of the “departureNode” attribute of the ReplaceRoute element is assigned to the quantity “departureNodeID” and this value is written to the mp4 file 1584. The number of bits used to represent the integer value of the quantity “departureNodeID” is specified by the value of the quantity “NodeIdBits”.

The value of the “departureNode” attribute of the ReplaceRoute element must match one of the entries in the UpdateableNodeId list. The corresponding entry in the UpdateableNodeNumber list specifies the value of the “node number” property for the “departure node”.

The value of the “field index” property for the departure node is determined by the index of the entry in a list of field names for this node number having a value matching the value of the “departureFieldName” attribute of the ReplaceRoute element. This list of field names is defined in the MPEG-4 Systems specifications. The value of the departureFieldID property for this field is determined by the value of the node number for the departure node, the value of the field index for the departure node, and a set of tables defined in the MPEG-4 Systems specifications. The value of the quantity “numBits” is determined by the value of the node number for the departure node, the value of departureFieldID, and a table defined in the MPEG-4 Systems specifications. The value of the quantity departureFieldID is then written to the mp4 file using numBits bits 1588.

The value of the “arrivalNode” attribute of the ReplaceRoute element is assigned to the quantity “arrivalNodeID” and this value is written to the mp4 file 1590. The number of bits used to represent the integer value of the quantity “arrivalNodeID” is specified by the value of the quantity “NodeIdBits”.

The value of the “arrivalNode” attribute of the ReplaceRoute element must match one of the entries in the UpdateableNodeId list. The corresponding entry in the UpdateableNodeNumber list specifies the value of the “node number” property for the “arrival node”.

The value of the “field index” property for the arrival node is determined by the index of the entry in a list of field names for this node number having a value matching the value of the “arrivalFieldName” attribute of the ReplaceRoute element. This list of field names is defined in the MPEG-4 Systems specifications. The value of the arrivalFieldID property for this field is determined by the value of the node number for the arrival node, the value of the field index for the arrival node, and a set of tables defined in the MPEG-4 Systems specifications. The value of the quantity “numBits” is determined by the value of the node number for the arrival node, the value of arrivalFieldID, and a table defined in the MPEG-4 Systems specifications. The integer value of the quantity arrivalFieldID is then written to the mp4 file using numBits bits 1594.

### 7.2.3.17 Scene Replacement BIFS Command

In the case of a “ReplaceScene” bifsCommand element 2930, a scene replacement BIFS command 1290 is appended to the output mp4 file. As shown in FIG. 12D, a scene replacement BIFS command 1290 consists of a two-bit scene replacement code (binary value=11) 1280 followed by a BIFSScene data structure 1290 and 1600. The components of a BIFSScene structure 1600 are shown in FIG. 16.

After writing the two-bit scene replacement code 1280, a six-bit zero value (“reserved”) 1610 is written to the output mp4 file.

The value of the “USENAMES” attribute of the ReplaceScene element is used to determine the value of the boolean quantity bUseNames. If the value of the value of the “USENAMES” attribute is “true” then the value “true” is assigned to “bUseNames” and a single “1” bit is written to the mp4 file 1620. Otherwise, the value “false” is assigned to the bUsenames and a single “0” bit is written to the mp4 file 1620. Next, a single “0” bit is written to the mp4 file to indicate that there will be no “protoList” in this mp4 file 1630.

The protoList bit 1630 is followed by an “SFTopNode” structure. This is equivalent to an “SFNode” structure described below, except that only members of a subset of nodes defined in the MPEG-4 Systems specifications are permitted. The description of the SFTopNode structure is specified by an mp4bifs Node element 2940 subordinate to the ReplaceScene command element 2930.

In addition to a required subordinate Node element, an mp4bifs ReplaceScene element 2930 may also have a single subordinate “Routes” element 2950. If the ReplaceScene element 2930 does not have a subordinate “Routes” element 2950, a single “0” bit is written to the mp4 file as the “hasRoutes” bit 1650, thereby indicating the end of the BIFS scene replacement command 1270. If the ReplaceScene command element 2930 has a subordinate “Routes” element 2950, a single “1” bit is written to the mp4 file as the “hasRoutes” bit 1650, followed by a Routes structure 1660 described in FIG. 18.

A Routes structure 1660 may have either of two forms, the list form 1800 shown in FIG. 18A, or the vector form 1830 shown in FIG. 18B. These are distinguished by the value of the first bit which is “1” 1805 for the list form and “0” 1835 for the vector form. In one embodiment of this invention, the list form is always chosen. Consequently, if the “hasRoutes” 1650 is set to “1”, the next bit 1805 is also set to “1”. The choice of list form versus vector form is not important, and this invention could equally well employ the vector form 1830 of the Routes structure.

An mp4bifs “Routes” element 2950 may have one or more subordinate “Route” elements 2960. For each “Route” element 2960 subordinate to a “Routes” element 2950, a single “1” bit 1805 and 1815 is written to the output mp4 file, followed by a binary description 1810 and 1860 of the Route element 2960. A single “0” bit 1820 is written to the output mp4 file after the description of the last “Route” element 2960 subordinate to the “Routes” element 2950. The “1” bit 1805 preceding the binary description 1810 of the first subordinate “Route” element 2960 specifies that the “list form” 1800 of the binary Routes data structure 2960 is being used. Subsequent “1” bits 1815 specify “moreRoutes=true”. The terminal “0” bit 1820 specifies “moreRoutes=false” and indicates the end of the Routes structure 1800 and 2960.

The structure of the binary description 1860 of each Route element is shown in FIG. 18C. The means used to create the binary description 1860 of each Route element are described below under “Route structure”.

### 7.2.3.18 Route Structure

A binary Route structure 1860 is appended to the output mp4 file for each Route element 2960 subordinate to a Routes element 2950 subordinate to a ReplaceScene element 2930. If a value has not been specified for the “routeId” attribute of the Route element 2960, a single bit with the value “0” is written to the output mp4 file as the “isUpdateable” value 1865. Otherwise, the value “1” is written to the output mp4 file as the “isUpdateable” value 1865 followed by the value 1870 specified by the “routeId” attribute of the Route element 2960. The number of bits used to represent the integer value of the routeId attribute is specified by the value of the quantity RouteIdBits.

If a value has been specified for the “routeId” attribute of the Route element 2960, and the value of the USENAMES attribute of the corresponding ReplaceScene element 2930 is “true”,then the value of the “name” attribute of the Route element 2960 is appended to the output mp4 file as a null-terminated string 1875. The value of the “name” attribute of the Route element 2960 is a copy of the DEF attribute of the corresponding XMT-A Route element 390.

The value of the “toNode” attribute of the Route element is assigned to the quantity “outNodeID” and this value is written to the mp4 file 1880. The number of bits used to represent the integer value of the quantity “outNodeID” is specified by the value of the quantity “NodeIdBits”.

The value of the “outNodeID” attribute of the Route element must match one of the entries in the UpdateableNodeId list. The corresponding entry in the UpdateableNodeNumber list specifies the value of the “node number” property for the “departure node”.

The value of the “field index” property for the departure node is determined by the index of the entry in a list of field names for the corresponding node number having a value matching the value of the “toFieldName” attribute of the Route element. This list of field names is defined in the MPEG-4 Systems specifications. The value of the outFieldRef property for this field is determined by the value of the node number for the departure node, the value of the field index for the departure node, and a set of tables defined in the MPEG-4 Systems specifications. The value of the quantity “numBits” is determined by the value of the node number for the departure node, the value of outFieldRef property, and a table defined in the MPEG-4 Systems specifications. The value of the quantity outFieldRef is then written to the mp4 file using numBits bits 1885.

The value of the “fromNode” attribute of the Route element 2960 is assigned to the quantity “inNodeID” and this value is written to the mp4 file 1890. The number of bits used to represent the integer value of the quantity “inNodeID” is specified by the value of the quantity “NodeIdBits”.

The value of the “inNodeID” attribute of the Route element 2960 must match one of the entries in the UpdateableNodeId list. The corresponding entry in the UpdateableNodeNumber list specifies the value of the “node number” property for the “arrival node”.

The value of the “field index” property for the arrival node is determined by the index of the entry in a list of field names for this node number having a value matching the value of the “fromFieldName” attribute of the Route element. This list of field names is defined in the MPEG-4 Systems specifications. The value of the inFieldRef property for this field is determined by the value of the node number for the arrival node, the value of the field index for the arrival node, and a set of tables defined in the MPEG-4 Systems specifications. The value of the quantity “numBits” is determined by the value of the node number for the arrival node, the value of inFieldRef, and a table defined in the MPEG-4 Systems specifications. The integer value of the quantity inFieldRef is then written to the mp4 file using numBits bits 1895.

### 7.2.3.19 SFNode Structure

An mp4bifs Node element 3000, 3040, and 3080 may be appear as a subordinate element to an InsertNode element, a ReplaceNode element, a ReplaceScene element, or another mp4bifs Node element 3000. Each mp4bifs Node element 3000, 3040, and 3080 has the structure shown in FIG. 30A, FIG. 30B, or FIG. 30C. There are over 100 types of mp4bifs Node elements. Each of these is corresponds to one of the BIFS nodes defined in the MPEG-4 Systems specifications. Each BIFS node has a prescribed node name (a character string) and an ordered set of property fields. Each property field has a prescribed name (a character string), a prescribed data type (such as boolean, integer, float), and other characteristics. Each type of BIFS node is represented by a like-named mp4bifs Node element and each property field of a BIFS node is represented by a like-named attribute of the corresponding mp4bifs Node element.

For most BIFS node property field data types, including boolean, integer, float, color, and string, the associated data values are represented by the value of a corresponding attribute of an mp4bifs Node element. There are two exceptions: field data types “node” and “buffer”. In the cases of field data types “node” and buffer”,the associated data values are represented by subordinate mp4bifs elements 3030 and 3070, and the corresponding attributes contain ordered lists of the names of the associated subordinate elements. These ordered lists of names may be used to determine the particular subordinate elements associated with each attribute of an mp4bifs Node element in cases where more than one attribute has a field data type of node or buffer.

In addition to the property fields, which are unique to each type of BIFS node, every BIFS node has a set of common properties. These include the reused state, the updateable state, and the mask access state. The resulting combination of property fields and common properties are illustrated in FIG. 17.

The following means are used to create a binary SFNode structure represented by an mp4bifs Node element.

The first step is to check for the presence of the optional “nodeRef” attribute of the mp4bifs Node element. If a value has been specified for this attribute, the value of this attribute is assigned to the quantity “nodeIDref”. In this case, the node is classified as a “reused” node and the resulting BIFS node has the structure shown in FIG. 17A. In this case, a single bit with the value “1” 1704 is written to the mp4 file. This bit specifies the condition “isReused=true”. This bit is followed by the value of the quantity “nodeIDref” 1708. The number of bits used to represent the value of the quantity “nodeIDref” is given by the value of the quantity “NodeIdBits”. No subordinate elements or other attributes are permitted in this case.

If a value has not been specified for the “nodeRef” attribute of an mp4bifs Node element, a single “0” bit 1712 and 1730 is written to the mp4 file. This bit specifies the condition “isReused=false”. The resulting BIFS SFNode may have the structure shown in FIG. 17B (mask Node) 1710 or FIG. 17C (list Node) 1730. The current embodiment of this invention always chooses the mask Node form 1710. The choice of the mask Node rather than the list Node is not important and this invention could be implemented equally well using the list Node form 1730 of SFNode.

Next, the element name (NodeName) for the mp4bifs Node element at operation 3000 is compared to entries in a list of BIFS node names defined in the MPEG-4 Systems specifications to determine the value of the “node number” for the corresponding BIFS node. The value of this “node number”,the “node data type” of the BIFS node, and a set of tables defined in the MPEG-4 Systems specifications are used to determine the value of the “localNodeType” for this BIFS node and the number of bits to be used to represent this value. The value of this “localNodeType” is then written to the mp4 file using the specified number of bits 1714.

If an mp4bifs Node element is subordinate to a ReplaceScene bifsCommand element, the “node data type” of the corresponding BIFS node is defined as “SFWorldNode”. Otherwise, the “node data type” of a BIFS node is determined by the node number for the “parent node”,the field index for the associated property field of the parent node, and a set of tables defined in the MPEG-4 Systems specifications. If an mp4bifs Node element is subordinate to another mp4bifs Node element, then the “parent Node” is defined by the mp4bifs Node element to which it is subordinate. If an mp4bifs Node element is subordinate to an mp4bifs bifsCommand element, then the “parent Node” is determined by the “NodeId” or “parentId” attribute of the mp4bifs bifsCommand element to which it is subordinate.

Next, the mp4bifs Node element is checked for the presence of the optional “NodeId” attribute at operation 3010. If a value has not been specified for the “NodeId” attribute of this Node element, a single “0” bit is written to the mp4 file to indicate the condition “isUpdateable=false” 1716. Otherwise (that is, a value has been specified for the NodeId attribute of this Node element), the value of the NodeId attribute at operation 3010 is assigned to the quantity “nodeID”,the node is classified as an “updateable” node, and a single “1” bit is written to the mp4 file 1716. This is followed by the value of the quantity “nodeID” 1718. The number of bits used to represent the integer value of the quantity “nodeID” is specified by the value of the quantity “NodeIdBits”. If the value of the boolean quantity “bUseNames” is “true”,the value of the “name” attribute at operation 3016 of the Node element is copied to the mp4 file character-by character, followed by a null byte (8 bits of zeroes) 1720.

Next, a single “1” bit is written to the mp4 file to indicate that the “mask node” form of the BIFS node has been selected 1722. This is followed by a sequence of mask bits 1726 and possible property field values 1728. Each mask bit 1726 corresponds to an “exposed” property field for the type of BIFS node specified by the element name of the mp4bifs Node element. The exposed property fields are defined by tables in the MPEG-4 Systems specifications. Each member of the ordered set of property fields of the specified BIFS node is considered in sequence. For each property field which corresponds to one of the exposed property fields, and for which an attribute value is specified in the mp4bifs Node element, a mask bit with value “1” is written to the mp4 file, followed by a binary representation of the associated attribute value. The means used to represent each such attribute value are described below. For each property field which corresponds to one of the exposed property fields, and for which an attribute value is not specified in the mp4bifs node element, a mask bit with value “0” is written to the mp4 file.

In addition to a prescribed property field name and a prescribed property field data type, each property field of each type of BIFS node has a prescribed characteristic which determines whether the property field consists of a single value of the prescribed data type (an SFField property) or multiple values of the prescribed data type (an MFField property field). Each MFField property field contains zero or more SFField structures, as shown in FIG. 17D (1760) and FIG. 17E (1780). In the current embodiment of this invention, the list form shown in FIG. 17D (1760) is always selected. The choice of the list form or the vector form is not important and this invention could have been implemented equally well using the vector form for MFField structures 1780.

### 7.2.3.20 SFField Structure

Each SFField data structure represents a prescribed data type. The supported data types include “simple data types” such as boolean, int, float, string, and color, and “complex data types”. The complex data types consist of data types “node” and “buffer”. The binary representation of each property field with a simple data type is determined by the value of the like-named attribute of an mp4bifs Node element. For example, a “boolean” property field is represented by a single bit. An “integer” property field is represented by a 32-bit integer value, etc. The number of bits used to represent each type of property field is defined in the MPEG-4 Systems specifications.

In the case of a property field of type “node”,the value of the property field is represented by subordinate mb4bifs Node elements. The value of the attribute associated with this property field consists of a list of the element names of the subordinate mp4bifs Node elements. The binary representation of each such subordinate Node element is created by recursively applying the procedures specified above for mp4bifs Node elements (SFNode structure).

In the case of a property field of type “buffer”,the subordinate elements consist of mb4bifs bifsCommand elements. The value of the attribute associated with this property field consists of a list of the element names of the subordinate mp4bifs bifsCommand elements. The binary representation of each such subordinate bifsCommand element is created by recursively applying the same procedures specified above for mp4bifs commandFrame elements.

### 7.2.4 Process “moov” Element

The fourth step in the creation of the output mp4 file 2230 consists of processing the single moov element 2320 contained in the mp4file document 2300.

Standard XML means are used to obtain the single “moov” element 2320 subordinate to the top level element of the mp4file document 2300 as shown in FIG. 23A. The procedure shown in FIG. 50 is used to create an atom with atom ID “moov” 712 and 754 in the output mp4 file. The current file position for the output mp4 file is assigned to the quantity “sizePos” at operation 5000. The value zero is written to the output mp4 file at operation 5010 in place of the atom size value 760. The atom ID “moov” 766 is written to the output mp4 file at operation 5020. The value of “sizePos” is assigned to the quantity “moovSizePos”.

The following attributes are defined for an mp4bifs “moov” element: version, flags, creationTime, modifyTime, timeScale, duration, and nextTrackID. Values specified for each of these attributes are assigned to like-named quantities (“property values”). None of these property values are written to the output mp4 file until the “mvhd” atom 772 has been created.

The procedure shown in FIG. 50 is used to create an atom 772 with atom ID “mvhd” in the output mp4 file. The current file position for the output mp4 file is assigned to the quantity “sizePos” at operation 5000. The value zero is written to the output mp4 file at operation 5010 in place of the atom size value. The atom ID “mvhd” is written to the output mp4 file at operation 5020. The value of “sizePos” is assigned to the quantity “mvhdSizePos”.

The following property values derived from the attributes of the “moov” element are then written to the output mp4 file at operation 5040:

1. version (8 bit integer),

2. flags (24 bit integer),

3. creationTime (32 bit integer),

4. modifyTime (32 bit integer),

5. timeScale (32 bit integer),

6. duration (32 bit integer),

7. reserved (76 bytes)

8. nextTrackID (32 bit integer)

The “reserved” data values are all zeroes except bytes 1, 4, 17, and 33 have value “1” and byte 48 has value “4”.

The mvhd atom 772 has no subordinate atoms 5050.

After the property fields of the mvhd atom 772 have been written, the value of the atom size of the mvhd atom 772 in the mp4 file is updated as indicated in FIG. 50 (operations 5060 to 5095).

After completing the mvhd atom 772, the value of the quantity “trackNum” is set to zero. Standard XML means are then used to obtain each of the mp4file elements subordinate to the “moov” element 2320. As shown in FIG. 23, these subordinate elements may include a single “mp4fiods” element 2330, an optional “udta” (user data) element 2340, and one or more “trak” elements 2350. Each of these subordinate elements is processed as described below operation 5050.

After completing the processing of all of the mp4file elements subordinate to the “moov” element 2320, the value of the quantity “moovSizePos” is assigned to “sizePos”, and the value of the atom size 760 of the moov atom 754 is updated as indicated in FIG. 50 (operations 5060 to 5095).

### 7.2.4.1 Process mp4fiods Element

Standard XML means are used to obtain the “mp4fiods” element 2330 subordinate to the “moov” element 2320, as shown in FIG. 23A. The procedure shown in FIG. 50 is used to create an atom with atom ID “iods” 778 and 800 in the output mp4 file. The current file position for the output mp4 file is assigned to the quantity “sizePos” at operation 5000. The value zero is written to the output mp4 file at operation 5010 in place of the atom size value 804. The atom ID “iods” 808 is written to the output mp4 file at operation 5020. The value of “sizePos” is assigned to the quantity “iodsSizePos”.

The following attributes are defined for an “mp4iods” element: version, objectDescriptorID 2370, url, includeInlineProfilesFlag, ODProfileLevel Indication, sceneProfileLevel Indication, audioProfileLevelIndication, visualProfileLevelIndication, graphicsProfileLevelIndication. Values specified for each of these attributes are assigned to like-named quantities (property values).

The value of the quantity “version” is written to the mp4 file as a 32-bit integer 812 and 816. This value represents both the “version” 812 and “flags” 816 values for the iods atom.

The procedure shown in FIG. 51 is used to create an Mp4fInitObjectDescr object structure 824 in the output mp4 file. The structure tag “MP4_IOD_Tag” (value=16) 828 is written to the output mp4 file as an 8-bit integer at operation 5100. The current file position for the output mp4 file is assigned to the quantity “sizePos” at operation 5110, and the value of “sizePos” is assigned to the quantity “mp4fiodPos”. The value “1” is assigned to the quantity “numSizeBytes” at operation 5120. The value zero is written to the output mp4 file as the preliminary size value 832 at operation 5130.

The value of the quantity “objectDescriptorID” is written to the mp4 file as a 10-bit integer 836. If a value has been specified for the “url” attribute, a single “1” bit is written to the mp4 file 840. Otherwise, a single “0” bit is written to the mp4 file 840. If the value of the quantity “includeInlineProfilesFlag” is true, a single “1” bit is written to the mp4 file 844. Otherwise, a single “0” bit is written to the mp4 file 844. The value “15” is written to the mp4 file as a 4-bit integer (binary value=1111) 848.

If a value has been specified for the “url” attribute, the value of the quantity “url” is written to the mp4 file as a “Pascal string” (one byte for the number of characters followed by the specified number of character bytes). Otherwise, the values of the quantities ODProfileLevelIndication 852, sceneProfileLevelIndication 856, audioProfileLevelIndication 860, visualProfileLevelIndication 864, and graphicsProfileLevelIndication 868 are each written to the mp4 file as 8-bit integers at operation 5140.

Standard XML means are then used to obtain each element subordinate to the “mp4fiods” element at operation 5050. As shown in FIG. 23B, an “mp4fiods” element 2360 is expected to have one or more subordinate “EsIdInc” elements 2390, and each “EsIdInc” element 2390 has a “trackID” attribute.

For each “EsIdInc” element 2390 subordinate to an “mp4fiods” element 2360, an ES_ID_Inc object structure 876 comprised of the following values is appended to the output mp4 file:

1. one byte representing the value of the “ES_ID_IncTag” (value=14) 880,

2. one byte representing the value “4” (“numBytes”) 884, and

3. four bytes representing the value of the “trackID” attribute as a 32-bit integer (“ES_ID”) 888.

After completing the processing of all of the “EsIdInc” elements 2390 subordinate to the “mp4fiods” element 2360 at operation 5050, the value of the MP4_IOD size 832 is updated as indicated in FIG. 51 (operations 5160 to 5195). The value of the quantity “iodsSizePos” is then assigned to the quantity “sizePos” and the atom size 804 of the iods atom 800 is updated as indicated in FIG. 50 (operations 5060 to 5095).

### 7.2.4.2 Process Each trak Element

Standard XML means are used to obtain each “trak” element 2350 subordinate to the “moov” element 2320 as shown in FIG. 23A. The procedure shown in FIG. 50 is used to create an atom with atom ID “trak” 790 and 900 in the output mp4 file. The current file position for the output mp4 file is assigned to the quantity “sizePos” at operation 5000. The value zero is written to the output mp4 file at operation 5010 in place of the atom size value 903. The atom ID “trak” 906 is written to the output mp4 file at operation 5020. The value of “sizePos” is assigned to the quantity “trakSizePos”.

The following attributes are defined for a “trak” element: version, flags, creationTime, modifyTime, trackID, and duration. Values specified for each of these attributes are assigned to like-named quantities (property values). None of these property values are written to the output mp4 file until the “tkhd” atom 910 has been created.

The procedure shown in FIG. 50 is used to create an atom with atom ID “tkhd” 910 in the output mp4 file. The current file position for the output mp4 file is assigned to the quantity “sizePos” at operation 5000. The value zero is written to the output mp4 file in place of the atom size value at operation 5010. The atom ID “tkhd” is written to the output mp4 file at operation 5020. The value of “sizePos” is assigned to the quantity “tkhdSizePos”.

The values of the following quantities are then written to the mp4 file at operation 5040:

1. version (8 bit integer),

2. flags (24 bit integer),

3. creationTime (32 bit integer),

4. modifyTime (32 bit integer),

5. trackID (32 bit integer),

6. reserved1 (32 bits, zero), then save file position as “durationPos”,

7. duration (32 bit integer),

8. reserved2 (56 bytes)

9. reserved3 (32 bits, value=0×01400000),

10. reserved4 (32 bits, value=0×00f00000),

The “reserved2” data values are all zeroes except bytes 17, and 33 have value “1” and byte 48 has value “4”.

The tkhd atom 910 has no subordinate atoms. After the property fields of the tkhd atom 910 have been written at operation 5040, the value of the atom size of the tkhd atom 910 in the mp4 binary file is updated as indicated in FIG. 50 (operations 5060 to 5195).

After completing the tkhd atom 910, standard XML means are used to obtain each of the mp4file elements subordinate to the “trak” element 2600. As shown in FIG. 26, these subordinate elements may include a single “mdia” element 2604, a possible “tref” (track reference) element 2636, and a possible “edts” (edit list) element 2644. Each of these subordinate elements is processed as described below at operation 5050.

After completing the processing of all of the mp4file elements subordinate to the “trak” element 2600, the value of the quantity “trakSizePos” is assigned to “sizePos”, and the value of the atom size 903 of the trak atom 900 is updated as indicated in FIG. 50 (operations 5060 to 5095). The value of the quantity “trackNum” is incremented by one.

### 7.2.4.3 Process mdia Element

Standard XML means are used to obtain the single “mdia” element 2604 subordinate to each “trak” element 2600 as shown in FIG. 26A. The procedure shown in FIG. 50 is used to create an atom with atom ID “mdia” 912 in the output mp4 file. The current file position for the output mp4 file is assigned to the quantity “sizePos” at operation 5000. The value zero is written to the output mp4 file in place of the atom size value at operation 5010. The atom ID “mdia” is written to the output mp4 file at operation 5020. The value of “sizePos” is assigned to the quantity “mdiaSizePos”.

The following attributes are defined for an “mdia” element: version, flags, creationTime, modifyTime, timeScale, duration, language, and quality. Values specified for each of these attributes are assigned to like-named quantities (property values). None of these property values are written to the output mp4 file until the “mdhd” atom 915 has been created.

The procedure shown in FIG. 50 is used to create an atom with atom ID “mdhd” 915 in the output mp4 file. The current file position for the output mp4 file is assigned to the quantity “sizePos” at operation 5000. The value zero is written to the output mp4 file in place of the atom size value at operation 5010. The values of the following quantities are then written to the mp4 file at operation 5040:

1. version (8 bit integer),

2. flags (24 bit integer),

3. creationTime (32 bit integer),

4. modifyTime (32 bit integer),

5. timeScale (32 bit integer),

6. duration (32 bit integer),

7. language (16 bit integer),

8. quality (16 bit integer),

The mdhd atom 915 has no subordinate atoms. After the property fields of the mdhd atom 915 have been written at operation 5040, the value of the atom size of the mdhd atom 915 in the mp4 file is updated as indicated in FIG. 50 (at operation 5060 to 5095).

The media data 2220 is then examined to determine the size and duration of each “sample” (also called an “access unit”). The value of the entry specified by the value of the quantity trackNum in the list StreamTypeForTrack is assigned to the quantity streamType. The value of the entry specified by the value of the quantity trackNum in the list ObjectTypeForTrack is assigned to the quantity objectType.

If the value of the quantity streamType is “4”, three new lists named sampleSize, sampleTime, and syncSample are created. The number of entries in each list is determined by the value of the entry specified by the value of the quantity trackNum in the list MediaSamples. The data in the media data file is then examined in a media-dependent manner to determine the size, and duration of each sample. The results are assigned to entries in the lists sampleSize and sampleTime. The index of each sample determined to be a “random access sample” is assigned to an entry in the list “syncSample”.

If the value of the quantity streamType is “5”, two new lists named sampleSize and sampleTime are created. The number of entries in each list is determined by the value of the entry specified by the value of the quantity trackNum in the list MediaSamples. The data in the media data file is then examined in a media-dependent manner to determine the size, and duration of each sample. The results are assigned to entries in the lists sampleSize and sampleTime.

In any other case (streamType not “4” or “5”), the entire media data stream is defined to by one big sample.

Standard XML means are then used to obtain each element subordinate to the “mdia” element 2604. As shown in FIG. 26A, these subordinate elements include a single “hdlr” (handler) element 2608, a single “minf” (media info) element 2612, a single “stbl” (sample table) element 2628, and a media header (“*mhd”) element 2632. Each of these subordinate elements is processed as described below at operation 5050.

After completing the processing of all of the mp4file elements subordinate to the “mdia” element 2604, the value of the quantity “mdiaSizePos” is assigned to “sizePos”, and the value of the atom size of the mdia atom 912 is updated as indicated in FIG. 50 (operation 5060 to 5095).

### 7.2.4.4 Process hdlr Element

Standard XML means are used to obtain the single “hdlr” element 2608 subordinate to the “mdia” element 2604 as shown in FIG. 26A. The procedure shown in FIG. 50 is used to create an atom with atom ID “hdlr” 918 in the output mp4 file. The current file position for the output mp4 file is assigned to the quantity “sizePos” at operation 5000. The value zero is written to the output mp4 file in place of the atom size value at operation 5010. The atom ID “hdlr” is written to the output mp4 file at operation 5020.

The following attributes are defined for an “hdlr” element 2608: version, flags, handlerType, and name. Values specified for each of these attributes are assigned to like-named quantities. The values of the following quantities are then written to the mp4 file at operation 5040:

1. version (8 bit integer),

2. flags (24 bit integer),

3. handlerType (32 bit integer),

4. reserved (12 bytes, all zeroes)

5. name (null-terminated character string)

The hdlr element 2608 has no subordinate elements 5050. After the property fields of the hdlr atom 918 have been written, the value of the atom size for the hdlr atom 918 is updated as indicated in FIG. 50 (operations 5060 to 5095).

### 7.2.4.5 Process minf Element

Standard XML means are used to obtain the single “minf” element 2612 subordinate to the “mdia” element 2604, as shown in FIG. 26A. The procedure shown in FIG. 50 is used to create an atom with atom ID “minf” 918 in the output mp4 file. The current file position for the output mp4 file is assigned to the quantity “sizePos” at operation 5000. The value zero is written to the output mp4 file in place of the atom size value at operation 5010. The atom ID “minf” is written to the output mp4 file at operation 5020. The value of “sizePos” is assigned to the quantity “minfSizePos”.

There are no attributes for the “minf” element 2612 and no property fields for the minf atom 920 (see operations 5030 and 5040).

Standard XML means are then used to obtain all elements subordinate to the “minf” element 2612 at operations 5050. As shown in FIG. 26A, these subordinate elements may include a “dinf” element 2616, an “stbl” element 2628, and a media header (*mhd) element 2632. The means used to process an “stbl” element 2628 and a media header (*mhd) element 2632 are described below.

In the case of the “dinf” element 2616, the procedure shown in FIG. 50 is used to create an atom with atom ID “dinf” 924 in the output mp4 file. The current file position for the output mp4 file is assigned to the quantity “sizePos” at operation 5000. The value zero is written to the output mp4 file in place of the atom size value at operation 5010. The atom ID “dinf” is written to the output mp4 file at operation 5020. The value of “sizePos” is assigned to the quantity “dinfSizePos”.

There are no attributes for the “dinf” element 2616 and no property fields for the dinf atom 924 (see operation 5030).

Standard XML means are then used to obtain all elements subordinate to the “dinf” element 2616 at operation 5040. As shown in FIG. 26A, these subordinate elements may include a “dref” element 2620.

If the “dinf” element 2616 possesses a subordinate “dref” element 2620, the procedure shown in FIG. 50 is used to create an atom with atom ID “dref” 927 in the output mp4 file. The current file position for the output mp4 file is assigned to the quantity “sizePos” at operation 5000. The value zero is written to the output mp4 file in place of the atom size value at operation 5010. The atom ID “dref” is written to the output mp4 file at operation 5020. The value of “sizePos” is assigned to the quantity “drefSizePos”. There are no attributes for the “dref” element and no property fields for the dref atom.

Standard XML means are then used to obtain all elements subordinate to the “dref” element 2620. As shown in FIG. 26A, these subordinate elements may include a “urlData” element 2624.

If the “dref” element 2620 possesses a subordinate “urlData” element 2624, the procedure shown in FIG. 50 is used to create an atom with atom ID “url” 930 in the output mp4 file. The current file position for the output mp4 file is assigned to the quantity “sizePos” at operation 5000. The value zero is written to the output mp4 file in place of the atom size value at operation 5010. The four-character atom ID “url” (u-r-l-space) is written to the output mp4 file at operation 5020.

The values of the “version”, “flags”, and “location” attributes of the “urlData” element are assigned to like-named quantities at operation 5030:

The following values are written to the output mp4 file at operation 5040:

1. an 8-bit integer representing the value of the quantity “version”,

2. a 24-bit integer representing the value of the quantity “flags”,

3. a null-terminated character string representing the value of the quantity “location”

The “urlData” element 2624 has no subordinate elements (see operation 5050). After writing these property values to the output mp4 file, the value of the atom size of the “url” atom 930 is updated as indicated in FIG. 50 (operations 5060 to 5095).

The value of the quantity “drefSizePos” is then assigned to “sizePos” and the value of the atom size of the dref atom 927 is updated as indicated in FIG. 50 (operations 5060 to 5095).

The value of the quantity “dinfSizePos” is then assigned to “sizePos” and the value of the atom size of the dinf atom 924 is updated as indicated in FIG. 50 (operation 5060 to 5095).

After completing the processing of all mp4file elements subordinate to the “minf”, element 2612, the value of the quantity “minfSizePos” is assigned to the quantity “sizePos”, and the value of the atom size of the minf atom 920 is updated as indicated in FIG. 50 (operations 5060 to 5095).

### 7.2.4.6 Process stbl Element

Standard XML means are used to obtain the single “stbl” element 2628 subordinate to the “minf” element 2612 as shown in FIG. 26A. The procedure shown in FIG. 50 is used to create an atom with atom ID “stbl” 933, 950 in the output mp4 file. The current file position for the output mp4 file is assigned to the quantity “sizePos” at operation 5000. The value zero is written to the output mp4 file in place of the atom size value 954 at operation 5010. The atom ID “stbl” 957 is written to the output mp4 file at operation 5020. The value of “sizePos” is assigned to the quantity “stblSizePos”.

There are no attributes for the “stbl” element 2628 and no property fields for the stbl atom (see operations 5030 and 5040).

Standard XML means are then used to obtain all elements subordinate to the “stbl” element 2652. As shown in FIG. 26B, these subordinate elements may include an “stsc” element 2656, an “stts” element 2660, an “stco” element 2664, an “stsz” element 2668, an “stss” element 2672, and an “stsd” element 2676. One of each of these elements is required, except for the “stss” element 2672 for which a single instance is optional. The means used to process each of these elements are described below at operation 5050.

After completing the processing of all of the mp4file elements subordinate to the “stbl” element 2652, the value of the quantity “stblSizePos” is assigned to “sizePos”, and the value of the atom size 954 of the stbl atom 950 is updated as indicated in FIG. 50 (operations 5060 to 5095).

### 7.2.4.7 Process stsc Element

Standard XML means are used to obtain the single “stsc” element 2656 subordinate to the “stbl” element 2652 as shown in FIG. 26B. The procedure shown in FIG. 50 is used to create an atom with atom ID “stsc” 960 in the output mp4 file. The current file position for the output mp4 file is assigned to the quantity “sizePos” at operation 5000. The value zero is written to the output mp4 file in place of the atom size value at operation 5010. The atom ID “stsc” is written to the output mp4 file at operation 5020.

An “stsc” element 2656 has attributes “version” and “flags”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

The file position for the mp4 file is assigned to the quantity “numEntriesPos”,a 32-bit zero value is written to the mp4 file, and the value zero is assigned to the quantity “numEntries”.

Standard XML means are then used to obtain all elements subordinate to the “stsc” element 2656 at operation 5050. These subordinate elements will consist of one or more “sampleToChunk” elements. Each “sampleToChunk” element possesses attributes “firstChunk”, “numSamples”, and “sampleDesc”.

The following operations are performed for each “sampleToChunk” element subordinate to the “stsc” element 2656:

(1) The value of the “firstChunk” attribute is written to the mp4 file as a 32-bit integer.

(2) The value of the “numSamples attribute is written to the mp4 file as a 32-bit integer.

(3) The value of the “sampleDesc” attribute is written to the mp4 file as a 32-bit integer.

(4) The value of the quantity “numEntries” is incremented by one.

After completing the processing of all of the elements subordinate to the “stsc” element 2656, the file position of the mp4 file is assigned to the quantity “endpos” at operation 5060. The file position of the mp4 file is changed to the value specified by the quantity “numEntriesPos”, and the value of the quantity “numEntries” is written to the mp4 file as a 32-bit integer. The value of the atom size for the stsc atom 960 is then updated as indicated in FIG. 50 (operations 5070 to 5095).

### 7.2.4.8 Process stts Element

Standard XML means are used to obtain the single “stts” element 2660 subordinate to the “stbl” element 2652 as shown in FIG. 26B. The procedure shown in FIG. 50 is used to create an atom with atom ID “stts” 963 in the output mp4 file. The current file position for the output mp4 file is assigned to the quantity “sizePos” at operation 5000. The value zero is written to the output mp4 file in place of the atom size value at operation 5010. The atom ID “stts” is written to the output mp4 file at operation 5020.

An “stts” element 2660 has attributes “version” and “flags”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

The file position for the mp4 file is assigned to the quantity “numEntriesPos”,a 32-bit zero value is written to the mp4 file, and the value zero is assigned to the quantity “numEntries”.

The value of entry “trackNum” in the list StreamTypeForTrack is assigned to the quantity “streamType”. The value of entry “trackNum” in the list ObjectTypeForTrack is assigned to the quantity “objectType”. The value of the quantity “trackNum” was determined as part of the procedure “Process trak element”.

If the value of the quantity “streamType” is “1”, the list of odsm sample time values (OdsmSampleTime) which was created when the odsm data was entered into the mdat atom for the odsm is used to determine a duration value for each odsm sample. The duration of each odsm sample is determined by the difference between the values of successive entries in this list. These values are specified in track time units.

If the value of the quantity “streamType” is “3”, the list of sdsm sample time values (SdsmSampleTime) which was created when the sdsm data was entered into the mdat atom for the sdsm is used to determine a duration value for each sdsm sample. The duration of each sdsm sample is determined by the difference between the values of successive entries in this list. The resulting duration value in seconds is multiplied by the value of the “timeScale” attribute for the “trak” element which contains this “stts” element to determine the duration value in track time units.

If the value of the quantity “streamType” is “4”, or the value of the quantity “streamType” is “5” and the value of the quantity objectType is “64” or “107”, the list of media sample time values (sampleTime) which was created when the corresponding media data was entered into an mdat atom is used to determine a duration value for each media sample. The duration of each media sample is specified by the corresponding entry in this list. These values are specified in track time units.

In each of the preceding three cases, the number of successive samples with the same duration is assigned to the quantity “numSamples”. Each time the value of the duration of a sample differs from the duration of the previous sample, the value of “numSamples” is written to the mp4 file as a 32-bit integer, the value of the duration of the previous sample(s) is written to the mp4 file as a 32-bit integer, the value one is assigned to the value “numSamples”, and the value of the quantity “numEntries” is incremented by one.

Otherwise, standard XML means are used to obtain all elements subordinate to the “stts” element 2660. These subordinate elements will include one or more “timeToSample” elements. Each “timeToSample” element possesses attributes “numSamples”, and “duration”.

The following operations are repeated for each “timeToSample” element subordinate to the “stts” element 2660:

(1) The value of the “numSamples” attribute is written to the mp4 file as a 32-bit integer.

(2) The value of the “duration” attribute is written to the mp4 file as a 32-bit integer.

(3) The value of the quantity “numEntries” is incremented by one.

After completing the processing of all of the elements subordinate to the “stts” element 2660, the file position of the mp4 file is assigned to the quantity “endPos” at operation 5060. The file position of the mp4 file is changed to the value specified by the quantity “numEntriesPos”, and the value of the quantity “numEntries” is written to the mp4 file as a 32-bit integer. The value of the atom size for the stts atom 963 is then updated as indicated in FIG. 50 (operations 5070 to 5095).

### 7.2.4.9 Process stco Element

Standard XML means are used to obtain the single “stco” element 2664 subordinate to the “stbl” element 2652 as shown in FIG. 26B. The procedure shown in FIG. 50 is used to create an atom with atom ID “stco” 966 in the output mp4 file. The current file position for the output mp4 file is assigned to the quantity “sizePos” at operation 5000. The value zero is written to the output mp4 file in place of the atom size value at operation 5010. The atom ID “stco” is written to the output mp4 file at operation 5020.

An “stco” element 2664 has attributes “version” and “flags”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

The file position for the mp4 file is assigned to the quantity “numEntriesPos”,a 32-bit zero value is written to the mp4 file, and the value zero is assigned to the quantity “numEntries”.

Standard XML means are then used to obtain all elements subordinate to the “stco” element 2664 at operation 5050. These subordinate elements will consist of one or more “chunkOffset” elements. The following two attributes are defined for a “chunkOffset” element: “mdatId” and “mdatOffset”.

The following operations are repeated for each “chunkOffset” element subordinate to the “stco” element 2664:

(1) The values specified for the “mdatId” and “mdatOffset” attributes are assigned to like-named quantities.

(2) The value of the quantity “chunk” is determined by the following three conditions:

a. the corresponding entry in the list mdatIdForChunk matches the value of the quantity mdatId,

b. the corresponding entry in the list trackIdForChunk matches the value of the quantity trackId, and

c. the value of numEntries matches number of entries which satisfy the preceding two conditions.

(3) The value of the entry “chunk” in the list offsetForChunk is assigned to the quantity “chunkOffset”.

(4) The value of the quantity “chunkOffset” is written to the mp4 file as a 32-bit integer.

(5) The value of the quantity “numEntries” is incremented by one.

After completing the processing of all of the elements subordinate to the “stco” element 2664, the file position of the mp4 file is assigned to the quantity “endPos” at operation 5060. The file position of the mp4 file is changed to the value specified by the quantity “numEntriesPos”, and the value of the quantity “numEntries” is written to the mp4 file as a 32-bit integer. The value of the atom size for the stco atom 966 is then updated as indicated in FIG. 50 (operations 5070 to 5095).

### 7.2.4.10 Process stsz Element

Standard XML means are used to obtain the single “stsz” element 2668 subordinate to the “stbl” element 2652 as shown in FIG. 26B. The procedure shown in FIG. 50 is used to create an atom with atom ID “stsz” 970 in the output mp4 file. The current file position for the output mp4 file is assigned to the quantity “sizePos” at operation 5000. The value zero is written to the output mp4 file in place of the atom size value at operation 5010. The atom ID “stsz” is written to the output mp4 file at operation 5020.

An “stsz” element 2668 has attributes “version”, “flags”, “sizeForAll” and “numSamples”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

The value of entry “trackNum” in the list StreamTypeForTrack is assigned to the quantity “streamType”. The value of entry “trackNum” in the list ObjectTypeForTrack is assigned to the quantity “objectType”. The value of the quantity “trackNum” was determined as part of the procedure “Process trak element”.

If the value of the quantity “streamType” is “1” and the value of the quantity “numOdsmSamples” is “1”, then the value “1” is assigned to the quantity “numSamples” and the value of the first entry in the list OdsmSampleSize is assigned to the quantity “sizeForAll”.

If the value of the quantity “streamType” is “3” and the second entry in the list SdsmSampleSize is negative, then the value “1” is assigned to the quantity “numSamples” and the value of the first entry in the list SdsmSampleSize is assigned to the quantity “sizeForAll”. A negative entry in the list SdsmSampleSize indicates the end of this list.

If the value of the quantity “streamType” is “5”, the value of the quantity “objectType is “193”, and the value of the quantity “sizeForAll” is less than 1, then the value “24” is assigned to the quantity “numSamples” and the value of the first entry in the list SdsmSampleSize is assigned to the quantity “sizeForAll”. 24 bytes is the size of each sample in an audio stream defined by objectType of “193”.

The file position for the mp4 file is assigned to the quantity “sizeForAllPos”, and the value of the quantity “sizeForAll” is written to the mp4file as a 32-bit integer. The file position for the mp4 file is assigned to the quantity “numEntriesPos”, and the value of the quantity “numSamples” is written to the mp4file as a 32-bit integer. The value zero is assigned to the quantity “numEntries”.

The “stsz” element 2668 may have subordinate “sampleSize” elements, but these are ignored because the data values contained within these elements is not necessarily consistent with the current media data streams. Instead, all sample size values have been recalculated as the streams have been created (for odsm and sdsm), or when the mdia atom was created (audio and visual streams). The resulting sample size values have been entered into one of the lists OdsmSampleSize, SdsmSampleSize, or sampleSize. If the media data has uniform sample size, the value of each sample is specified by the quantity “sizeForAll”.

If the value of the quantity “streamType” is “1” (odsm) and the value of the quantity “numOdsmSamples” is greater than 1, the value of the quantity “numOdsmSamples” is assigned to the quantity “numEntries”. The value of the quantity “numOdsmSamples” indicates the number of entries in the list OdsmSampleSize. The value of each entry in the list OdsmSampleSize is written to the mp4 file as a 32-bit integer. If the value of the quantity “numOdsmSamples” is not the same as the value of the quantity “numSamples”,the file position of the mp4 file is assigned to the quantity “mp4FilePos”,the file position is changed to the value specified by the quantity “numEntriesPos”,the value of the quantity “numOdsmSamples” is written to the mp4 file as a 32-bit integer, and the file position is restored to the value specified by the quantity “mp4FilePos”.

If the value of the quantity “streamType” is “3” (sdsm) and the second entry in the list SdsmSampleSize is not negative, the value of each entry in the list SdsmSampleSize is written to the mp4 file as a 32-bit integer until a negative entry is found. The value of the quantity “numEntries” is incremented by one for each non-negative entry in the list SdsmSampleSize. The final negative value in this list is not written to the mp4 file. If the value of the quantity “numEntries” is not the same as the value of the quantity “numSamples”,the file position of the mp4 file is assigned to the quantity mp4FilePos, the file position is changed to the value specified by the quantity “numEntriesPos”,the value of the quantity “numEntries” is written to the mp4 file as a 32-bit integer, and the file position is restored to the value specified by the quantity “mp4FilePos”.

If the value of the quantity “streamType” is not “1” and not “3”, the value of the quantity “sizeForAll” is not positive, and the value of the quantity “numSamples” is negative, the value of the quantity “numMediaSamples” is assigned to the quantity “numSamples”. This case includes most video media data and audio media data with varying sample sizes. The quantity “numMediaSamples” specifies the number of entries in the list “sampleSize” created then the mdia atom was created. The value of each entry in the list sampleSize is written to the mp4 file as a 32-bit integer. The file position of the mp4 file is assigned to the quantity “mp4FilePos”,the file position is changed to the value specified by the quantity “numEntriesPos”,the value of the quantity “numMediaSamples” is written to the mp4 file as a 32-bit integer, and the file position is restored to the value specified by the quantity “mp4FilePos”.

If the value of the quantity “streamType” is not “1” and not “3”, the value of the quantity “sizeForAll” is positive, and the value of the quantity “numSamples” is zero, the value of the quantity “numSamples” is determined by dividing the size of the media data for this track by the value of the quantity “sizeForAll”. This case includes certain audio media data with uniform sample sizes. The file position of the mp4 file is assigned to the quantity “mp4FilePos”,the file position is changed to the value specified by the quantity “numEntriesPos”,the value of the quantity “numSamples” is written to the mp4 file as a 32-bit integer, and the file position is restored to the value specified by the quantity “mp4FilePos”.

If the value of the quantity “streamType” is not “1” and not “3”, the value of the quantity “sizeForAll” is zero, and the value of the quantity “numSamples” is positive, the value of the quantity “sizeForAll” is determined by dividing the size of the media data for this track by the value of the quantity “numSamples”. This case includes certain media data with uniform sample size and known sample count, usually “1”, such as media data representing a single image. The file position of the mp4 file is assigned to the quantity “mp4FilePos”, the file position is changed to the value specified by the quantity “sizeForAllPos”,the value of the quantity “sizeForAll” is written to the mp4 file as a 32-bit integer, and the file position is restored to the value specified by the quantity “mp4FilePos”.

In all cases, processing of an “stsz” element 2668 is completed by updating the value of the atom size for the stsz atom 970 as indicated in FIG. 50 (operations 5060 to 5095).

### 7.2.4.11 Process stss Element

An “stss” element 2672, if present, contains a “sync-sample table”. This table is required for certain types of media data streams such as MPEG-4 video streams. An “stbl” element 2652 will contain a subordinate “stss” element 2672 only when required. Standard XML means are used to determine whether a subordinate “stss” element 2672 is present within an “stbl” element 2652.

If a subordinate “stss” element 2672 is present, standard XML means are used to obtain this element. The procedure shown in FIG. 50 is then used to create an atom with atom ID “stss” 974 in the output mp4 file. The current file position for the output mp4 file is assigned to the quantity “sizePos” at operation 5000. The value zero is written to the output mp4 file in place of the atom size value at operation 5010. The atom ID “stss” is written to the output mp4 file at operation 5020.

An “stss” element 2672 has attributes “version”, “flags”, and “numEntries”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

The file position for the mp4 file is assigned to the quantity “numEntriesPos” and a 32-bit zero value is written to the mp4 file.

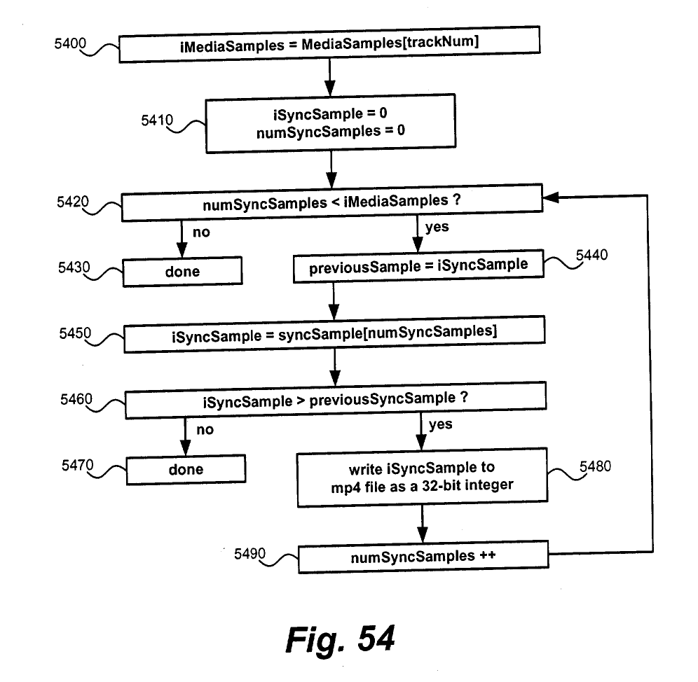

The means shown in FIG. 54 is then used to construct a sync sample table in the output mp4 file. According to this procedure, entry “trakNum” in the list “MediaSamples” is assigned to the value of the quantity “iMediaSamples” at operation 5400. This quantity indicates the number of samples (or “access units”) representing the media data stream associated with the current trak atom 790 and 900. The value of this quantity also provides an upper bound on the number of entries in the list “syncSample”. The list “iSynSample” consists of a monotonically increasing set of sample index values, where the first sample in the media data stream is represented by the sample index value “1”. If the number of entries in this list is less than the value of iMediaSamples, the last sample index value in the stream is followed by an entry with the value zero.

The value zero is assigned to the value of the quantities “iSyncSample” and “numSyncSamples” at operation 5410.

At operation 5420, the value of numSyncSamples is compared to the value of iMediaSamples.

If the value of the quantity “numSyncSamples” is not less than the value of the quantity “iMediaSamples”,this process is complete at operation 5430.

Otherwise, that is, the value of the quantity “numSyncSamples” is less than the value of the quantity “iMediaSamples”,the value of the quantity “iSyncSample” is assigned to the value of the quantity “previousSample” at operation 5440. The value of entry “numSyncSamples” is assigned to the quantity “iSyncSample” at operation 5450, and the resulting value of the quantity “iSyncSample” is compared to the value of the quantity “iSyncSample” at operation 5460.

If the value of the quantity “iSyncSample” is not greater than the value of the quantity “iSyncSample”,this process is complete at operation 5470. Otherwise, that is the value of the quantity “iSyncSample” is greater than the value of the quantity “iSyncSample”, the value of the quantity “iSyncSample” is written to the output mp4 file as a 32-bit integer at operation 5480. The value of the quantity “numSyncSamples” is incremented by one at operation 5490 and the comparison of the value of the quantity “numSyncSamples” with the value of the quantity “iMediaSamples” at operation 5420 is repeated.

After completing the procedure shown in FIG. 54, the file position of the mp4 file is assigned to the quantity “endPos” at operation 5060. The file position of the mp4 file is changed to the value specified by the quantity “numEntriesPos”, and the value of the quantity “numSyncSamples” is written to the mp4 file as a 32-bit integer. The value of the atom size for the stss atom 974 is then updated as indicated in FIG. 50 (operation 5070 to 5095).

### 7.2.4.12 Process stsd Element

Standard XML means are used to obtain the single “stsd” element 2676 subordinate to the “stbl” 2652 element as shown in FIG. 26B. The procedure shown in FIG. 50 is used to create an atom with atom ID “stsd” 978 in the output mp4 file. The current file position for the output mp4 file is assigned to the quantity “sizePos” at operation 5000. The value zero is written to the output mp4 file in place of the atom size value at operation 5010. The atom ID “stsd” is written to the output mp4 file at operation 5020.

An “stsd” element 2676 has attributes “version” and “flags”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

The file position for the mp4 file is assigned to the quantity “numEntriesPos”,a 32-bit zero value is written to the mp4 file, and the value zero is assigned to the quantity “numEntries”. The value of the quantity “sizePos” is assigned to the quantity “stsdSizePos”.

Standard XML means are then used to obtain all elements subordinate to the “stsd” element 2676 at operation 5050. The set of such subordinate elements is expected to consist of a single element of type “mp4s”, “mp4a”, or “mp4v”. These element types are described collectively as “mp4*” 2680, as shown in FIG. 26B. Each of these subordinate elements represents an entry in a “sample description table” and the value of the quantity “numEntries” is incremented by one for each such subordinate element.

Each of these types of elements (“mp4s”, “mp4a”, or “mp4v”) has a single attribute named “dataRefIndex”.

For each subordinate element of type “mp4s”,the procedure shown in FIG. 50 is used to create an atom with atom ID “mp4s” 982 in the output mp4 file. The current file position for the output mp4 file is assigned to the quantity “sizePos” at operation 5000, and the value of the quantity “sizePos” is assigned to the quantity “mp4xSizePos”. The value zero is written to the output mp4 file in place of the atom size value 5010. The atom ID “mp4s” is written to the output mp4 file at operation 5020.

The value zero is assigned to the quantity “dataRefIndex”. If a value is specified for the “dataRefIndex” attribute of the mp4s element, the value of this attribute is assigned to the quantity “dataRefIndex” at operation 5030. The following values are then written to the mp4 file at operation 5040:

1. Six bytes with the value zero,

2. a 16-bit integer representing the value of the quantity “dataRefIndex”

For each subordinate element of type “mp4a”,the procedure shown in FIG. 50 is used to create an atom with atom ID “mp4a” 982 in the output mp4 file. The current file position for the output mp4 file is assigned to the quantity “sizePos” at operation 5000, and the value of the quantity “sizePos” is assigned to the quantity “mp4xSizePos”. The value zero is written to the output mp4 file in place of the atom size value at operation 5010. The atom ID “mp4a” is written to the output mp4 file at operation 5020.

The value zero is assigned to the quantity “dataRefIndex”. If a value is specified for the “dataRefIndex” attribute of the mp4a element, the value of this attribute is assigned to the quantity “dataRefIndex” at operation 5030. The following values are then written to the mp4 file at operation 5040:

1. Six bytes with the value zero,

2. a 16-bit integer representing the value of the quantity “dataRefIndex”

3. two 32-bit integers with value zero,

4. a 16-bit integer representing value “2”,

5. a 16-bit integer representing value “16”,

6. a 32-bit integer with value zero,

7. a 16-bit integer representing the value of the quantity “timeScale” obtained from the corresponding attribute of the “mdia” element 2604

8. a 16-bit integer with value zero.

For each subordinate element of type “mp4v”,the procedure shown in FIG. 50 is used to create an atom with atom ID “mp4v” 982 in the output mp4 file. The current file position for the output mp4 file is assigned to the quantity “sizePos” at operation 5000, and the value of the quantity “sizePos” is assigned to the quantity “mp4xSizePos”. The value zero is written to the output mp4 file in place of the atom size value at operation 5010. The atom ID “mp4v” is written to the output mp4 file at operation 5020.

The value zero is assigned to the quantity “dataRefIndex”. If a value is specified for the “dataRefIndex” attribute of the mp4v element, the value of this attribute is assigned to the quantity “dataRefIndex” at operation 5030. The following values are then written to the mp4 file at operation 5040:

1. Six bytes with the value zero,

2. a 16-bit integer representing the value of the quantity “dataRefIndex”

3. Four 32-bit integers with value zero

4. a 16-bit integer with value “320”,

5. a 16-bit integer with value “240”,

6. a 16-bit integer with value “72”,

7. a 16-bit integer with value zero,

8. a 16-bit integer with value “72”,

9. a 16-bit integer with value zero,

10. a 32-bit integer with value zero,

11. a 16-bit integer with value “1”,

12. 32 bytes with the value zero,

13. a 16-bit integer with value “24”,

14. a 16-bit integer with value “−1”.

Each element of type “mp4s”, “mp4a”, or “mp4v” 2680 is expected to have a single subordinate element of type “esds” 2684, as shown in FIG. 26B. For each subordinate element of type “esds”,the procedure shown in FIG. 50 is used to create an atom with atom ID “esds” 986 in the output mp4 file. The current file position for the output mp4 file is assigned to the quantity “sizePos” at operation 5000, and the value of the quantity “sizePos” is assigned to the quantity “esdsSizePos”. The value zero is written to the output mp4 file in place of the atom size value at operation 5010. The atom ID “esds” is written to the output mp4 file at operation 5020.

An element of type “esds” has attributes “version” and “flags”. The value of each of these attributes is assigned to a like-named quantity at operation 5030. The value of the quantity “version” is then written to the mp4 file as an 8-bit integer and the value of the quantity “flags” is written to the mp4 file as a 24-bit integer at operation 5040.

Each element of type “esds” is expected to have a single subordinate element of type “ES_Descr” 2688, as shown in FIG. 26B. This subordinate “ES_Descr” element is processed using the means described below at operation 5050.

After completing the processing of the “ES_Descr” element 2688 subordinate to the “esds” element 2684, the file position of the mp4 file is assigned to the quantity “endPos” at operation 5060. The value of the quantity “esdsSizePos” is assigned to the quantity “sizePos” and the value of the atom size of the esds atom 986 is updated as indicated in FIG. 50 (operations 5070 to 5095).

The value of the quantity “mp4xSizePos” is assigned to the quantity “sizePos” and the value of the atom size for the “mp4s”, “mp4a”, or “mp4v” is then updated as indicated in FIG. 50 (operations 5070 to 5095).

The file position of the mp4 file is changed to the value specified by the quantity “numEntriesPos”, and the value of the quantity “numEntries” is written to the mp4 file as a 32-bit integer. The value of the quantity “stsdSizePos” is assigned to “sizePos”. The value of the atom size for the stsd atom 978 is then updated as indicated in FIG. 50 (operations 5070 to 5095).

### 7.2.4.13 Process ES_Descr Element

For each “ES_Descr” element 2688 and 2700 subordinate to an “esds” element 2684, the procedure shown in FIG. 51 is used to create an ES_Descr object structure 990 and 1000 in the output mp4 file. The structure tag “ES_DescrTag” (value=3) 1004 is written to the output mp4 file as an 8-bit integer at operation 5100. The current file position for the output mp4 file is assigned to the quantity “sizePos” at operation 5110, and the value of “sizePos” is assigned to the quantity “filePos1”. The value “1” is assigned to the quantity “numSizeBytes” at operation 5120. The value zero is written to the output mp4 file as the preliminary size value 1008 at operation 5130.

The following attributes are defined for an “ES_Descr” element: “ES_ID” and “priority”. A value of zero is assigned to quantities named “ES_ID” and “priority”. If a value is specified for either attribute, the specified value is assigned to the like-named quantity at operation 5135.

The following values are then written to the mp4 file at operation 5140:

1. a 16-bit integer representing the value of the quantity “ES_ID”,

2. a three bit integer with the value zero,

3. a five bit integer representing the value of the quantity “priority”.

Standard XML means are then used to obtain each XML element subordinate to the “ES_Descr” element 2688 and 2700. These subordinate elements are expected to include one element with an element name of “DecoderConfigDescriptor” 2710, and one element with an element name of “SLConfigDescriptor” 2760, as shown in FIG. 27.

For each “DecoderConfigDescriptor” element 2710 subordinate to an ES_Descr” element 2700, the procedure shown in FIG. 51 is used to create a DecoderConfigDescriptor object structure 1024 and 1032 in the output mp4 file. The structure tag “DecoderConfigDescrTag” (value=4) 1036 is written to the output mp4 file as an 8-bit integer at operation 5100. The current file position for the output mp4 file is assigned to the quantity “sizePos” at operation 5110, and the value of “sizePos” is assigned to the quantity “filePos2”. The value “1” is assigned to the quantity “numSizeBytes” at operation 5120. The value zero is written to the output mp4 file as the preliminary size value 1040 at operation 5130.

The following attributes are defined for a “DecoderConfigDescriptor” element 2710: “objectType”, “streamType”, “upStream”, “maxBitrate”, and “avgBitrate”. If a value is specified for any of these attributes, each specified value is assigned to a like-named quantity at operation 5135.

The value of the quantity “bufferSize” is determined by the size of the largest sample in the corresponding media data stream. If the value of the quantity “streamType” is “1”, the value the largest entry in the list “OdsmSampleSize” is assigned to the quantity “bufferSize”. If the value of the quantity “streamType” is “3”, the value the largest entry in the list “SdsmSampleSize” is assigned to the quantity “bufferSize”. If the value of the quantity “streamType” is “4” and the value of the quantity “objectType” is “32”, or the value of the quantity “streamType” is “5” and the value of the quantity “objectType” is “64”, or the value of the quantity “streamType” is “5” and the value of the quantity “objectType” is “107”, the value the largest entry in the list “sampleSize” is assigned to the quantity “bufferSize”. If the value of the quantity “streamType” is and the value of the quantity “objectType” is “193”, the value “2400” is assigned to the quantity “bufferSize”. Otherwise, the value of the media data is determined by the sum of entries in the list mediaDataSize for which the corresponding entry in the list trackIdForChunk matches the value of the quantity “trackId” for the current track.

The following values are then written to the mp4 file at operation 5140:

1. one byte representing the integer value of the quantity “objectType” 1044,

2. six bits representing the integer value of the quantity “streamType” 1048,

3. one bit representing the boolean value of the quantity “upStream” 1052 (“1” if “true”, else “0”),

4. one bit with the value “1” (as “reserved”) 1056,

5. three bytes representing the integer value of the quantity “bufferSize” 1060 (as “bufferSizeDB”),

6. a 32-bit integer representing the value of the quantity “maxBitrate” 1064, and

7. a 32-bit integer representing the value of the quantity “avgBitrate” 1068.

Standard XML means are then used to obtain any elements subordinate to the “DecoderConfigDescriptor” element 2710. This may include one of the following types of elements: “BIFS_DecoderConfig” 2720, “JPEG_DecoderConfig” 2730, “VisualConfig” 2740, or “AudioConfig” 2750, as shown in FIG. 27. If any one of these subordinate elements is found, the procedure shown in FIG. 51 is used to create a DecoderSpecificInfo object structure 1072 and 1076 in the output mp4 file. The structure tag “DecoderSpecificInfoTag” (value=5) 1080 is written to the output mp4 file as an 8-bit integer at operation 5100. The current file position for the output mp4 file is assigned to the quantity “sizePos” at operation 5110. The value “1” is assigned to the quantity “numSizeBytes” at operation 5120. The value zero is written to the output mp4 file as the preliminary size value 1084 at operation 5130.

The properties of each type of decoder specific info element are described below. After these properties have been processed at operation 5150, the size value (numBytes) 1084 of the DecoderSpecificInfo object structure 1076 is updated as indicated in FIG. 51 (operations 5160 to 5195). The value of the quantity “filePos2” is assigned to the quantity “sizePos” and the size value (numBytes) 1040 of the DecoderConfigDescriptor object structure 1032 is then updated as indicated in FIG. 51 (operations 5160 to 5195).

For each “SLConfigDescriptor” element 2760 subordinate to the “ES_Descr” element 2700, the following procedure is used to create an SLConfigDescriptor object structure 1028 and 1088 in the output mp4 file. The following attribute is defined for an “SLConfigDescriptor” element 2760: “predefined”. If a value is specified for the attribute “predefined”,the value of this attribute is assigned to the quantity “predefined”. Otherwise, the value “2” is assigned to the quantity “predefined”.

The following values are written to the mp4 file:

1. one byte with the value of the “SLConfigDescrTag” (value=6) 1090,

2. one byte with the value “1” (numBytes) 1094, and

3. one byte representing the value of the quantity “predefined” 1098.

After processing each of these subordinate elements, the value of the quantity “filePos1” is assigned to the quantity “sizePos” and the size value (numBytes) 1008 of the ES_Descr structure 1000 is updated as indicated in FIG. 51 (operations 5160 to 5195).

### 7.2.4.14 Process BIFS DecoderConfig Element

A “BIFS_DecoderConfig” element 2720 may have “version 1” or “version 2” properties, depending on the value of the quantity “objectType”. If the value of the quantity “objectType” is not “2”, the following attributes are defined for a “BIFS_DecoderConfig” element (version 1): “nodeIdBits”, “routeIdBits”, “pixelMetric”, “pixelWidth”, and “pixelHeight”.

The value specified for each of these attributes is assigned to a like-named quantity at operation 5135. The following values are then written to the mp4 file at operation 5140:

1. 5 bits representing the integer value of the quantity “nodeIdBits”,

2. 5 bits representing the integer value of the quantity “routeIdBits”,

3. 1 bit with the value “1”,

4. 1 bit determined by the boolean value of the quantity “pixelMetric” (“1” if “true” else “0”),

5. 1 bit with the value “1”,

6. a 16-bit integer with the integer value of the quantity “pixelWidth”,

7. a 16-bit integer with the integer value of the quantity “pixelHeight”, and

8. 3 bits with the value zero.

If the value of the quantity “objectType” is “2”, the following attributes are defined for a “BIFS_DecoderConfig” element (version 2): “nodeIdBits”, “routeIdBits”, “protoIdBits”, “use3DMeshCoding”, “usePredictiveMFField”, “pixelMetric”, “pixelWidth”, and “pixelHeight”.

The value specified for each of these attributes is assigned to a like-named quantity at operation 5135. The following values are then written to the mp4 file at operation 5140:

1. 1 bit determined by the boolean value of the quantity “use3DMeshCoding” (“1” if “true” else “0”),

2. 1 bit determined by the boolean value of the quantity “usePredictiveMFField” (“1” if “true” else “0”),

3. 5 bits representing the integer value of the quantity “nodeIdBits”,

4. 5 bits representing the integer value of the quantity “routeIdBits”,

5. 5 bits representing the integer value of the quantity “protoIdBits”,

6. 1 bit with the value “1”,

7. 1 bit determined by the boolean value of the quantity “pixelMetric” (“1” if “true” else “0”),

8. 1 bit with the value “1”,

9. a 16-bit integer with the integer value of the quantity “pixelWidth”,

10. a 16-bit integer with the integer value of the quantity “pixelHeight”, and

11. 4 bits with the value zero.

### 7.2.4.15 Process JPEG DecoderConfig Element

The following attributes are defined for a “JPEG_DecoderConfig” element: “headerLength”, “Xdensity”, and “Ydensity”.

Like named quantities are assigned default values of 0, 1, and 1. The value specified for each of these attributes is assigned to a like-named quantity at operation 5135.

A value of “1” or “3” is assigned to the quantity “numComponents” based on the contents of the media data associated with this track. If the associated media data represents a grayscale image, the value “1” is assigned to the quantity “numComponents” otherwise, the value “3” is assigned to the quantity “numComponents” at operation 5135.

The following values are then written to the mp4 file at operation 5140:

1. a 16-bit integer representing the value of the quantity “headerLength”,

2. a 16-bit integer representing the value of the quantity “Xdensity”,

3. a 16-bit integer representing the value of the quantity “Ydensity”, and

4. One byte with representing integer value of the quantity “numComponents”.

### 7.2.4.16 Process VisualConfig Element

The following attribute is defined for a “VisualConfig” element: “profile_and_level_indication”.

A like named quantity is assigned a default values of 1. If a value is specified for this attribute, the specified value is assigned to the like-named quantity at operation 5135.

Further processing of this type of decoder specific info depends on the “mediaHeader” data extracted from the corresponding media data when the mdat atom for this track was created.

If media header data is available for this track, the media data is tested for the presence of the “visual object sequence start code” (0x000001b0) and “visual object sequence end code” (0x000001b1).

If media header data is available for this track, but the media data does not include the “visual object sequence start code”, or if no media header data is available for this track, the following values are written to the mp4 file at operation 5140:

1. 32-bit integer with the value 0x000001b0 (visual object sequence start code),

2. one byte representing the value of the quantity “profile_and_level_indication”,

3. 32-bit integer representing the value 0x000001b5 (visual object start code), and

4. one byte with the value “9”.

If no media header data is available for this track, the following value is written to the mp4 file at operation 5140:

5. 32-bit integer with the value 0x00000100 (video object start code).

If media header data is available for this track, and the last four bytes of the media header data are not the “visual object sequence end code”,the remainder of the media header data is copied into the mp4 file at operation 5140.

If media header data is available for this track, and the last four bytes of the media header data consist of the “visual object sequence end code”,the remainder of the media header data, except for the last four bytes, is copied into the mp4 file at operation 5140.

### 7.2.4.17 Process AudioConfig Element

No attributes are specified for the “AudioConfig” element at operation 5135. All data values to be written to the mp4 file are derived from the media header data derived from the media data for this track.

The first byte of the media header data is assigned to the quantity “audioObjectType”. The second byte of the media header data is assigned to the quantity “sampleRateIndex”. The third byte of the media header data is assigned to the quantity “channelConfig”. The following values are then written to the mp4 file at operation 5140:

1. 5 bits representing the integer value of the quantity “audioObjectType”,

2. 4 bits representing the integer value of the quantity “sampleRateIndex”,

3. 4 bits representing the integer value of the quantity “channelConfig”, and

4. 3 bits with the value zero.

If the value of the quantity “channelConfig” is zero, a “program configuration element” (PCE) is added to the decoder specific info. The structure of a PCE is defined in the MPEG-4 specifications for encoding audio data. The data required to create the PCE is contained in the media header data array. This data was stored in this array when the corresponding mdat atom was created.

### 7.2.4.18 Process Media Header Element

Standard XML means are used to obtain the single media header element (“*mhd”) 2632 subordinate to the “mdia” element 2604 as shown in FIG. 26A. The media header element 2632 may be an “nmhd” element (for the sdsm or odsm), an “smhd” element (for an audio stream), or a “vmhd” element (for a video stream).

If the media header element 2632 is an “nmhd” element, the procedure shown in FIG. 50 is used to create an atom with atom ID “nmhd” 936 in the output mp4 file. The current file position for the output mp4 file is assigned to the quantity “sizePos” at operation 5000. The value zero is written to the output mp4 file in place of the atom size value at operation 5010. The atom ID “nmhd” is written to the output mp4 file at operation 5020.

An “nmhd” element has attributes “version” and “flags”. The value of each of these attributes is assigned to a like-named quantity at operation 5030.

The values of the following quantities are written to the output mp4 file at operation 5040:

1. an 8-bit integer representing the value of the quantity “version”, and

2. a 24-bit integer representing the value of the quantity “flags”.

If the media header element 2632 is an “smhd” element, the procedure shown in FIG. 50 is used to create an atom with atom ID “smhd” 936 in the output mp4 file. The current file position for the output mp4 file is assigned to the quantity “sizePos” at operation 5000. The value zero is written to the output mp4 file in place of the atom size value at operation 5010. The atom ID “smhd” is written to the output mp4 file at operation 5020.

An “smhd” element has attributes “version”, “flags”, and “balance”. The value of each of these attributes is assigned to a like-named quantity at operation 5030.

The values of the following quantities are written to the output mp4 file at operation 5040:

1. an 8-bit integer representing the value of the quantity “version”,

2. a 24-bit integer representing the value of the quantity “flags”,

3. a 16-bit integer representing the value of the quantity “balance”, and

4. a 16-bit integer with the value zero.

If the media header element 2632 is a “vmhd” element, the procedure shown in FIG. 50 is used to create an atom with atom ID “vmhd” 936 in the output mp4 file. The current file position for the output mp4 file is assigned to the quantity “sizePos” at operation 5000. The value zero is written to the output mp4 file in place of the atom size value at operation 5010. The atom ID “vmhd” is written to the output mp4 file at operation 5020.

A “vmhd” element has attributes “version”, “flags”, “transferMode”, “opColorRed”, “opColorGreen”, and “opColorBlue”. The value of each of these attributes is assigned to a like-named quantity at operation 5030.

The values of the following quantities are written to the output mp4 file at operation 5040:

1. an 8-bit integer representing the value of the quantity “version”,

2. a 24-bit integer representing the value of the quantity “flags”,

3. a 16-bit integer representing the value of the quantity “transferMode”,

4. a 16-bit integer representing the value of the quantity “opColorRed”,

5. a 16-bit integer representing the value of the quantity “opColorGreen”, and

6. a 16-bit integer representing the value of the quantity “opColorBlue”.

A media header element 2632 has no subordinate elements at operation 5050. After the property values of the media header atom have been written, the value of the atom size for the media header atom 936 is updated as indicated in FIG. 50 (operations 5060 to 5095).

### 7.2.4.19 Process tref Element

Standard XML means are used to obtain the single “tref” element 2636 possibly subordinate to the “trak” element 2600 as shown in FIG. 26A. The procedure shown in FIG. 50 is used to create an atom with atom ID “tref” 940 in the output mp4 file. The current file position for the output mp4 file is assigned to the quantity “sizePos” at operation 5000. The value zero is written to the output mp4 file in place of the atom size value at operation 5010. The atom ID “tref” is written to the output mp4 file at operation 5020. The value of “sizePos” is assigned to the quantity “trefSizePos”.

A “tref” element has no attributes at operations 5030 and 5040.

Standard XML means are used to obtain each element subordinate to the “tref” element 2636. These may include an, “mpod” element 2640, as shown in FIG. 26A. Other types of elements including a “dpnd” element and/or a “sync” element may also occur as subordinate elements to a “tref” element 2636.

For each “mpod”, “dpnd”, or “sync” element 2640 subordinate to a “tref” element 2636, the procedure shown in FIG. 50 is used to create an atom with a like-valued atom ID 942 in the output mp4 file. The current file position for the output mp4 file is assigned to the quantity “sizePos” at operation 5000. The value zero is written to the output mp4 file in place of the atom size value at operation 5010. The atom ID “mpod”, “dpnd”, or “sync” is written to the output mp4 file at operation 5020.

Each “mpod”, “dpnd”, or “sync” element has one attribute named “trackID”. This attribute consists of a list of trackID values at operation 5030. Each trackID value in this list is written to the output mp4 file as a 32-bit integer at operation 5040. In the case of an “mpod” element, each trackID value is also assigned to an entry in the list “TrackIdForOdId”.

An “mpod”, “dpnd”, or “sync” element has no subordinate elements at operation 5050. After the trackID attribute of this element has been processed, the value of the atom size for the corresponding atom 942 in the mp4 file is updated as indicated in FIG. 50 (operations 5060 to 5095).

After completing the processing of all of the elements 2640 subordinate to the “tref” element 2036, the value of the quantity “trefSizePos” is assigned to “sizePos”, and the value of the atom size for the tref atom 940 is updated as indicated in FIG. 50 (operations 5060 to 5095).

### 7.2.4.20 Process edts Element

Standard XML means are used to obtain the single “edts” element 2644 possibly subordinate to the “trak” element 2600, as shown in FIG. 26A. The procedure shown in FIG. 50 is used to create an atom with atom ID “edts” 945 in the output mp4 file. The current file position for the output mp4 file is assigned to the quantity “sizePos” at operation 5000. The value zero is written to the output mp4 file in place of the atom size value at operation 5010. The atom ID “edts” is written to the output mp4 file at operation 5020. The value of “sizePos” is assigned to the quantity “edtsSizePos”.

An “edts” element 2644 has no attributes at operations 5030 and 5040.

Standard XML means are used to obtain the single “elst” element 2648 subordinate to the “edts” element 2644, as shown in FIG. 26A. The procedure shown in FIG. 50 is used to create an atom with atom ID “elst” 948 in the output mp4 file. The current file position for the output mp4 file is assigned to the quantity “sizePos” at operation 5000. The value zero is written to the output mp4 file in place of the atom size value at operation 5010. The atom ID “elst” is written to the output mp4 file at operation 5020.

An “elst” element has attributes “version” and “flags”. The value of each of these attributes is assigned to a like-named quantity at operation 5030.

The values of the following quantities are written to the output mp4 file at operation 5040:

1. an 8-bit integer representing the value of the quantity “version”, and

2. a 24-bit integer representing the value of the quantity “flags”.

Standard XML means are then used to obtain each element subordinate to the “elst” element 2648. The set of elements subordinate to the “elst” element 2648 is expected to consist of two “segment” elements. Each “segment” element has three attributes, “duration”, “startTime”, and “rate”.

The following operations are performed for each segment element subordinate to the “elst” element 2648:

1. The value of each of the attributes “duration”, “startTime”, and “rate” is assigned to a like-named quantity,

2. The value of the quantity “duration” is written to the output mp4 file as a 32-bit integer,

3. The value of the quantity “startTime” is written to the output mp4 file as a 32-bit integer, and

4. The floating point value of the quantity “rate” is multiplied by 256*256, converted to an integer, and the result is written to the mp4 file as a 32-bit integer.

After all “segment” elements subordinate to the “elst” element 2648 have been processed, the value of the atom size for the elst atom 948 is updated as indicated in FIG. 50 (operations 5060 to 5095).

The value of the quantity “edtsSizePos” is then assigned to “sizePos”, and the value of the atom size for the edts atom 945 is updated as indicated in FIG. 50 (operations 5060 to 5095).

### 7.2.5 Process Optional User Data Elements

The fifth step in the creation of the output mp4 file 2230 consists of processing any optional “user data” (udta) elements 2340 contained in the “moov” element 2320. Standard XML means are used to obtain any “udta” element(s) 2340 subordinate to the “moov” element 2320 of the mp4file document 2300 as shown in FIG. 23A. The following means are used to process each such “udta” element:

The procedure shown in FIG. 50 is used to create an atom 784 with atom ID “udta” in the output mp4 file. The current file position for the output mp4 file is assigned to the quantity “sizePos” at operation 5000. The value zero is written to the output mp4 file in place of the atom size value at operation 5010. The atom ID “udta” is written to the output mp4 file at operation 5020. The value of “sizePos” is assigned to the quantity “udtaSizePos”.

A “udta” element has no attributes at operations 5030 and 5040.

Each “udta” element may have subordinate elements such as a “cprt” element which may be used to imbed a copyright message in an mp4 file. Any unrecognized subordinate elements may be ignored.

If a “udta” element is found to have a subordinate “cprt” element, the procedure shown in FIG. 50 is used to create an atom with atom ID “cprt” in the output mp4 file. The current file position for the output mp4 file is assigned to the quantity “sizePos” at operation 5000. The value zero is written to the output mp4 file in place of the atom size value at operation 5010. The atom ID “cprt” is written to the output mp4 file at operation 5020.

A “cprt” element may possess attributes named “version”, “flags”, and “language”. The value of each of these attributes is assigned to a like-named quantity at operation 5030. A “cprt” element will also possess a subordinate “text node” containing a text string representing a message at operation 5040.

The values of the following quantities are written to the output mp4 file at operation 5040:

1. an 8-bit integer representing the value of the quantity “version”,

2. a 24-bit integer representing the value of the quantity “flags”,

3. a 16-bit integer representing the value of the quantity “language”, and

4. a sequence of characters representing the value of the subordinate text node, followed by a null byte.

After completing the attributes of a “cprt” element, the value of the atom size of the cprt atom is updated as indicated in FIG. 50 (operations 5060 to 5095).

After completing the processing of all of the mp4file elements subordinate to the “udta” element 2340, the value of the quantity “udtaSizePos” is assigned to “sizePos”, and the value of the atom size of the corresponding udta atom 784 is updated as indicated in FIG. 50 (operations 5060 to 5095).

### 7.2.6 Update odsm Buffer Size

The last step in the creation of the output mp4 file 2230 consists of updating the odsm buffer size.

The output mp4 file 2320 includes a trak atom 790 for each media stream. As shown in FIG. 9, each track atom 900 includes an ES_Descr object structure 990. Each ES_Descr object structure 990 and 1000 contains a DecoderConfigDescriptor object structure 1024 and 1032. As shown in FIG. 10, each DecoderConfigDescriptor object structure includes a property “bufferSizeDB”,1060. In most cases, the value of this property is determined by the size of the largest sample in the associated media data stream. In the case of the odsm 1900, each sample 1920 and 1940 may include EsIdRef structure(s) 2170 with references to ES_Descr structure(s) 1000, and the odsm sample buffer must have sufficient size to allow each imbedded EsIdRef 2160 structure to be replaced by the corresponding ES_Descr structure 1000. The number of bytes comprising an ES_Descr structure 1000 is generally larger than the corresponding EsIdRef structure 2160. Consequently, the minimum buffer size for the odsm must be increased to allow EsIdRef structures 2160 to be replaced by the corresponding ES_Descr structures 1000. This is accomplished by the means described below.

Before performing these operations, each trak atom 900 has been constructed as described above. The trak atom for the odsm contains a preliminary value for the bufferSizeDB property. Before writing this preliminary value to the output mp4 file, the value of the mp4 file position was assigned to the quantity “OdsmBufferSizePos”. In addition, as parts of the operations described above, the size of each odsm sample has been assigned to an entry in the list “OdsmSampleSize”, the size of the ES_Descr structure for each trak atom has been assigned to an entry in the list “EsDescrSizeForTrack”,the value of the “trackID” property for each trak atom has been assigned to an entry in the list “TrackIdForTrack”, and the value of the trackID associated with each object has been assigned to an entry in the list “TrackIdForOdId”.

After completing the preceding steps described above, the following means are used to revise the value of the property bufferSizeDB 1060 for the odsm:

1. Use standard XML means to obtain each “mdat” element 2310 in the mp4file document 2300.

2. Use standard XML means to obtain each “odsm” element 2420 subordinate to each “mdat” element 2310 and 2400.

3. Use standard XML means to obtain each “odsmChunk” element 2470 subordinate to each “odsm” element 2420 and 2460.

4. Use standard XML means to obtain each “odsmSample” element (2510) subordinate to each “odsmChunk” element 2470 and 2500.

5. Enumerate each “odsmSample” element 2510 with the quantity “ithOdsmSample”.

6. Use standard XML means to obtain each “ObjectDescrUpdate” odsm-command element 2530 and 2540 subordinate to each “odsmSample” element 2520 and 2510.

7. Use standard XML means to obtain each “ObjectDescriptor” 2550 element subordinate to each “ObjectDescrUpdate” element 2540.

8. Assign the value of the “ODID” attribute of the “ObjectDescriptor” element 2550 to the quantity “OdId”.

9. Assign the value of entry OdId-1 in the list “TrackIdForOdId” to the quantity “trackID”.

10. Use the list “TrackIdForTrack” to determine the “track” index for this value of “trackID”.

11. Assign the value of entry “track” in the list “EsDescrSizeForTrack” to the value of the quantity “EsDescrSize”.

12. Add the value of the quantity “EsDescrSize” to entry “IthOdsmSample” in the list “OdsmSampleSize”.

13. Determine the largest entry in the list “OdsmSampleSize” and assign the result to the quantity OdsmBufferSize.

14. Assign the current mp4 file position to the quantity “mp4FilePos”.

15. Change the current mp4 file position to the value specified by the quantity “OdsmBufferSizePos”.

16. Write three bytes representing the value of the quantity OdsmBufferSize as a 24-bit integer to the output mp4 file.

17. Restore the mp4 file position to the value specified by the quantity “mp4FilePos”.

The value of the quantity OdsmBufferSize may overestimate the value required for the odsm buffer size, but this is acceptable. These means complete the creation of the output mp4 file.

The foregoing description of the invention has been presented for purposes of illustration and description. It is not intended to be exhaustive or to limit the invention to the precise form disclosed, and other modifications and variations may be possible in light of the above teachings. For example, the precise definition of XMT-A files may change or evolve with time. Likewise, the precise definition of the MPEG-4 Intermedia Format may change or evolve with time. The invention described here is not limited to the particular definition specified in the document(s) cited above. Thus, the principles of this invention may also apply to other unrelated data structures. Other extended forms of the SFNode data structure are also defined in the MPEG-4 Systems specifications. Means of extending this invention as described in the following embodiment to cover such cases will be apparent to those skilled in the art. Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for converting an Extensible MPEG-4 Textual (XMT) document into a binary MPEG-4 (mp4) file, the XMT document having zero or more associated media data files, the method comprising:
generating an intermediate document representing the mp4 file; and
creating the mp4 file based on the intermediate document and the associated media data files.

2. The method of claim 1, wherein generating the intermediate document further comprises generating one or more additional intermediate documents representing specific portions of the mp4 file.

3. The method of claim 2, wherein generating the additional intermediate documents further comprises generating an mp4-bifs document representing a scene description stream.

4. The method of claim 3, wherein the mp4-bifs document is a distinct document separate from the intermediate document representing the mp4 file.

5. The method of claim 2, wherein generating the additional intermediate documents further comprises generating a document representing an object descriptor stream.

6. The method of claim 5, wherein the document representing the object descriptor stream is a distinct document separate from the intermediate document representing the mp4 file.

7. The method of claim 1, wherein creating the mp4 file comprises determining the number of bytes representing each temporal element of each associated media data file.

8. The method of claim 1, wherein creating the mp4 file comprises determining the temporal duration of each temporal element of each associated media data file.

9. A system for converting an Extensible MPEG-4 Textual (XMT) document into a binary MPEG-4 (mp4) file, the XMT document having zero or more associated media files, the system comprising:
a first converter configured to input the XMT document and to generate at least one intermediate document representing the structure of the mp4 file; and
a second converter configured to input the intermediate document and any associated media files, the second converter further configured to generate the mp4 file.

10. The system of claim 9, wherein the intermediate document includes additional intermediate documents representing specific portions of the mp4 file.

11. The system of claim 10, wherein the additional intermediate documents include an mp4-bifs document representing a scene description stream.

12. The system of claim 10, wherein the additional intermediate documents include a document representing an object descriptor stream.

13. The system of claim 12, wherein the document representing an object descriptor stream is contained within the intermediate document representing the mp4 file.

14. The system of claim 12, wherein the document representing an object descriptor stream is a distinct document separate from the intermediate document representing the mp4 file.

15. The system of claim 14, wherein the intermediate document representing the mp4 file references document representing an object descriptor stream.

16. A computer program product embodied in a tangible media comprising:
computer readable program codes coupled to the tangible media for converting an Extensible MPEG-4 Textual (XMT) document into a binary MPEG-4 (mp4) file, the XMT document having zero or more associated media data files, the computer readable program codes configured to cause the program to:
generate an intermediate document representing the mp4 file; and
create the mp4 file based on the intermediate document and the associated media data files.

17. The computer program product of claim 16, wherein the intermediate document is an Extensible Markup Language (XML) document.

18. The computer program product of claim 16, wherein the computer readable program code configured to generate the intermediate document further comprises computer readable program code configured to generate one or more additional intermediate documents representing specific portions of the mp4 file.

19. The computer program product of claim 18, wherein the additional intermediate documents are Extensible Markup Language (XML) documents.

20. The computer program product of claim 18, wherein the computer readable program code configured to generate one or more additional intermediate documents further comprises readable program code configured to generate an mp4-bifs document representing a scene description stream.

21. The computer program product of claim 20, wherein the mp4bifs document is contained within the intermediate document representing the mp4 file.

22. The computer program product of claim 20, wherein the mp4bifs document is a distinct document separate from the intermediate document representing the mp4 file.

23. The computer program product of claim 22, wherein the intermediate document representing the mp4 file references the mp4-bifs document.

24. The computer program product of claim 18, wherein the computer readable program code configured to generate one or more additional intermediate documents further comprises readable program code configured to generate a document representing an object descriptor stream.

25. The computer program product of claim 24, wherein the document representing the object descriptor stream is contained within the intermediate document representing the mp4 file.

26. The computer program product of claim 24, wherein the document representing the object descriptor stream is a distinct document separate from the intermediate document representing the mp4 file.

27. The computer program product of claim 26, wherein the intermediate document representing the mp4 file references the document representing the object descriptor stream.

28. The computer program product of claim 16, wherein the computer readable program code configured to create the mp4 file comprises computer readable program code configured to determine the number of bytes representing each temporal element of each associated media data file.

29. The computer program product of claim 16, wherein the computer readable program code configured to create the mp4 file comprises computer readable program code configured to determine the temporal duration of each temporal element of each associated media data file.

30. The computer program product of claim 16, wherein the associated media data files include one or more audio data files.

31. The computer program product of claim 16, wherein the associated media data files include one or more image data files.

32. The computer program product of claim 16, wherein the associated media data files include one or more video data files.
